(19) United States
(12) Patent Application Publication
(10) Pub. No.: US 2023/0339801 A1
(43) Pub. Date: Oct. 26, 2023

(54) Optical Glasses Containing Bismuth Oxide

(71) Applicant: CORNING INCORPORATED, Corning, NY (US)

(72) Inventors: Philippe Lehuede, Dammarie-les-Lys (FR); Antoine Marie Joseph Lepicard, Melun (FR); Alexander I Priven, Sejong-si (KR)

(21) Appl. No.: 18/119,895

(22) Filed: Mar. 10, 2023

Related U.S. Application Data
(60) Provisional application No. 63/323,645, filed on Mar. 25, 2022.

(51) Int. Cl. C03C 3/068

(52) U.S. Cl. CPC C03C 3/068

(57) ABSTRACT

Glass compositions include bismuth oxide (Bi₂O₃) in an amount of greater than or equal to 0.05 mol.% and less than or equal to 10 mol.%, one or more of boron oxide (B₂O₃), silica (SiO₂) and phosphorus oxide (P₂O₅), and one or more of niobia (Nb₂O₅) and titania (TiO₂) as essential components, and may optionally include lanthanum oxide (La₂O₃), tungsten oxide (WO₃), zirconia (ZrO₂), yttria (Y₂O₃), barium oxide (BaO) and other components. The glasses may be characterized by high refractive index at 587.56 nm at comparably low density at room temperature.

This Application claims the benefit of priority to U.S. Provisional Pat. Application Serial No. 63/323,645 filed on Mar. 25, 2022, the content of which is relied upon and incorporated herein by reference in its entirety.

### FIELD

The present disclosure generally relates to borate and silicoborate glasses having a high refractive index and low density.

### BACKGROUND

Glass is used in a variety of optical devices, examples of which include augmented reality devices, virtual reality devices, mixed reality devices, eye wear, etc. Desirable properties for this type of glass often include a high refractive index and a low density. Additional desirable properties may include high transmission in the visible and near-ultraviolet (near-UV) range of the electromagnetic spectrum and/or low optical dispersion. It can be challenging to find glasses having the desired combination of these properties and which can be formed from compositions having good glass-forming ability. For example, generally speaking, as the refractive index of a glass increases, the density also tends to increase. Species such as TiO₂ and Nb₂O₅ are often added to increase the refractive index of a glass without increasing the density of the glass. However, these materials often absorb blue and UV light, which can undesirably decrease the transmittance of light in this region of the spectrum by the glass. Often, attempts to increase the refractive index of a glass while maintaining a low density, and without decreasing transmittance in the blue and UV region of the spectrum, can result in a decrease in the glass-forming ability of the material. For example, crystallization and/or liquid-liquid phase separation can occur during cooling of the glass melt at cooling rates that are generally acceptable in the industry. Typically, the decrease in glass-forming ability appears as the amount of certain species, such as ZrO₂, Y₂O₃, Sc₂O₃, BeO, etc. increases.

Low density, high refractive index glasses often belong to one of two types of chemical systems, based on the glass formers used: (a) silicoborate or borosilicate glasses in which SiO₂ and/or B₂O₃ are used as the main glass formers and (b) phosphate glasses in which P₂O₅ is used as a main glass former. Glasses which rely on other oxides as main glass formers, such as GeO₂, TeO₂, Bi₂O₃, and V₂O₅, can be challenging to use due to cost, glass-forming ability, optical properties, and/or production requirements.

Phosphate glasses can be characterized by a high refractive index and low density, however, phosphate glasses can be challenging to produce due to volatilization of P₂O₅ from the melts and/or risks of platinum incompatibility. In addition, phosphate glasses are often highly colored and may require an extra bleaching step to provide a glass having the desired transmittance characteristic. Furthermore, phosphate glasses exhibiting a high refractive index also tend to have an increase in optical dispersion.

Silicoborate and borate glasses are typically easier to produce and can exhibit a high transmittance without a bleaching step. However, silicoborate and borosilicate glasses typically exhibit an increase in density at increasing refractive indices, compared to phosphate glasses.

In view of these considerations, there is a need for borate, silicoborate and phosphate glasses having a high refractive index, a low density, and a high transmittance to blue light.

### SUMMARY

According to an embodiment of the present disclosure, a glass comprises a plurality of components, the glass having a composition of the components comprising greater than or equal to 0.0 mol.% and less than or equal to 35.0 mol.% B₂O₃, greater than or equal to 0.0 mol.% and less than or equal to 35.0 mol.% P₂O₅, greater than or equal to 0.0 mol.% and less than or equal to 15.0 mol.% SiO₂, greater than or equal to 0.0 mol.% and less than or equal to 15.0 mol.% GeO₂, greater than or equal to 0.050 mol.% and less than or equal to 4.000 mol.% Bi₂O₃, greater than or equal to 0.0 at.% and less than or equal to 10.0 at.% F, a sum of B₂O₃ + SiO₂ + P₂O₅ greater than or equal to 5.0 mol.% and less than or equal to 35.0 mol.%, a sum of TiO₂ + Nb₂O₅ greater than or equal to 1.0 mol.% and less than or equal to 64.0 mol.% and a sum of R₂O + RO greater than or equal to 0.0 mol.% and less than or equal to 8.0 mol.%, where R₂O is a total sum of monovalent metal oxides, and RO is a total sum of divalent metal oxides.

According to another embodiment of the present disclosure, a glass comprises a plurality of components, the glass having a composition of the components comprising greater than or equal to 1.0 mol.% and less than or equal to 50.0 mol.% TiO₂, greater than or equal to 1.0 mol.% and less than or equal to 50.0 mol.% Nb₂O₅, greater than or equal to 0.1 mol.% and less than or equal to 10.0 mol.% Bi₂O₃, a sum of B₂O₃ + SiO₂ greater than or equal to 1.0 mol.% and less than or equal to 50.0 mol.% and may optionally contain one or more components selected from P₂O₅, La₂O₃, ZrO₂, CaO, Y₂O₃, ZnO, Gd₂O_{3,} Na₂O, WO₃, Al₂O₃, Li₂O, PbO, GeO₂, TeO₂, Er₂O₃, Yb₂O₃, K₂O and MgO, wherein the composition of the components satisfies the conditions: SiO₂ + B₂O₃ - P₂O₅ [mol.%] ≥ -8.0, and the glass satisfies the condition: Pₙ > 2.05, where Pₙ is a parameter predicting a refractive index at 587.56 nm, n_{d}, calculated from the glass composition in terms of mol.% of the components according to the Formula (I):

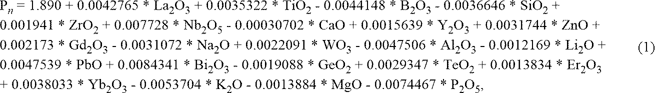

where an asterisk (*) means multiplication.

According to one more embodiment of the present disclosure, a glass comprises a plurality of components, the glass having a composition of the components comprising greater than or equal to 1.0 mol.% and less than or equal to 40.0 mol.% B₂O₃, greater than or equal to 0.5 mol.% and less than or equal to 45.0 mol.% TiO₂, greater than or equal to 0.0 mol.% and less than or equal to 40.0 mol.% SiO₂, greater than or equal to 0.0 mol.% and less than or equal to 40.0 mol.% P₂O₅, greater than or equal to 0.0 mol.% and less than or equal to 40.0 mol.% WO₃, greater than or equal to 0.0 mol.% and less than or equal to 40.0 mol.% Nb₂O₅, greater than or equal to 0.0 mol.% and less than or equal to 40.0 mol.% La₂O₃, greater than or equal to 0.0 mol.% and less than or equal to 15.0 mol.% TeO₂, greater than or equal to 0.0 mol.% and less than or equal to 15.0 mol.% GeO₂, greater than or equal to 0.050 mol.% and less than or equal to 8.000 mol.% Bi₂O₃, greater than or equal to 0.0 mol.% and less than or equal to 10.0 mol.% PbO, greater than or equal to 0.0 mol.% and less than or equal to 5.0 mol.% Ga₂O₃ and may optionally contain one or more components selected from ZrO₂, CaO, Y₂O₃, ZnO, Gd₂O₃, Na₂O, Al₂O₃, Li₂O, Er₂O₃, Yb₂O₃, K₂O, MgO, BaO and SrO, the glass satisfies the conditions: 4.2 ≤ P_{d} ≤ 6.0 and Pₙ - (1.62 + 0.08 * P_{d}) > 0.000, where Pₙ is a parameter predicting a refractive index at 587.56 nm, n_{d}, calculated from the glass composition in terms of mol.% of the components according to the Formula (I):

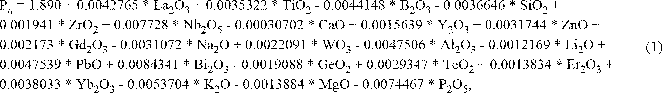

and P_{d} is a parameter predicting a density at room temperature, d_{RT} [g/cm³], calculated from the glass composition in terms of mol.% of the components according to the Formula (II):

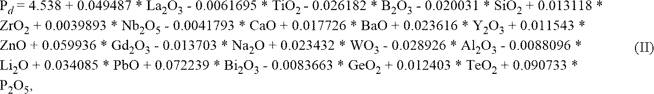

where an asterisk (*) means multiplication.

These and other aspects, objects, and features of the present disclosure will be understood and appreciated by those skilled in the art upon studying the following specification, claims, and appended drawings.

### BRIEF DESCRIPTION OF THE DRAWINGS

FIG. 1 is a plot illustrating the relationship between the refractive index n_{d} and the parameter Pₙ calculated by formula (I) for some Comparative Glasses and some Exemplary Glasses according to an embodiment of the present disclosure.

FIG. 2 is a plot illustrating the relationship between the density d_{RT} and the parameter P_{d} calculated by formula (II) for some Comparative Glasses and some Exemplary Glasses according to an embodiment of the present disclosure.

FIG. 3 is a plot of an exemplary cooling schedule according to a “15 min test” condition and a “2.5 min test” condition for some Exemplary Glasses according to an embodiment of the present disclosure.

FIG. 4 is an image of the samples of some Exemplary Glasses according to an embodiment of the present disclosure after melting and cooling at certain conditions.

FIG. 5 is a plot illustrating the relationship between the parameter that predicts density at room temperature P_{d} and the parameter that predicts refractive index at 587.56 nm Pₙ for some Comparative Glasses and some Exemplary Glasses according to an embodiment of the present disclosure.

FIG. 6 is a plot illustrating the relationship between the density at room temperature d_{RT} and the refractive index at 587.56 nm n_{d} for some Comparative Glasses and some Exemplary Glasses according to an embodiment of the present disclosure.

FIG. 7 is a plot of total transmittance of some Exemplary Glasses according to the present disclosure as a function of the wavelength.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including, without limitation, matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those skilled in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “component” refers to a material or compound included in a batch composition from which a glass is formed. Components include oxides, including but not limited to those expressed in Formulas (I), and (II), and the claims. Representative components include B₂O₃, P₂O₅, Al₂O₃, CuO, Cu₂O, RO, R₂O, SnO₂, MnO₂, REₘOₙ, SiO₂, Ta₂O₅, ZnO, WO₃, Nb₂O₅, TiO₂, ZrO₂, Bi₂O₃, TeO₂, etc. Other representative components include halogens (e.g. F, Br, Cl). Whenever a component is included as a term in a mathematical expression or formula, it is understood that the component refers to the amount of the component in units of mol.% in the batch composition of the glass. For example, the expression “B₂O₃ + P₂O₅” refers to the sum of the amount of B₂O₃ in units of mol.% and the amount of P₂O₅ in units of mol.% in the batch composition of the glass. A mathematical expression or formula is any expression or formula that includes a mathematical operator such as “+”, “-”, “*”, “/”, “min”, or “max”.

Unless otherwise specified, the amount or content of a component in a glass composition is expressed herein in units of mol.% (mole percent).

The term “formed from” can mean one or more of comprises, consists essentially of, or consists of. For example, a component that is formed from a particular material can comprise the particular material, consist essentially of the particular material, or consist of the particular material.

The terms “free” and “substantially free” are used interchangeably herein to refer to an amount and/or an absence of a particular component in a glass composition that is not intentionally added to the glass composition. It is understood that the glass composition may contain traces of a particular constituent component as a contaminant or a tramp in an amount of less than 0.10 mol.%.

As used herein, the term “tramp”, when used to describe a particular constituent component in a glass composition, refers to a constituent component that is not intentionally added to the glass composition and is present in an amount of less than 0.10 mol.%. Tramp components may be unintentionally added to the glass composition as an impurity in another constituent component and/or through migration of the tramp component into the composition during processing of the glass composition.

Unless otherwise specified, the term “glass” is used to refer to a glass made from a glass composition disclosed herein.

The symbol “*” means multiplication when used in any formula herein.

Temperature is expressed herein in units of °C (degrees Celsius).

Density is expressed herein in units of g/cm³.

Viscosity is expressed herein in units of P (Poise).

The term “glass former” is used herein to refer to a component that, being solely present in the glass composition (i.e., without other components, except for tramps), is able to form a glass when cooling the melt at a rate of not greater than about 300° C./min.

The term “modifier”, as used herein, refers to the oxides of monovalent or divalent metals, i.e., R₂O or RO, where “R” stands for a cation. Modifiers can be added to a glass composition to change the atomic structure of the melt and the resulting glass. In some embodiments, the modifier may change the coordination numbers of cations present in the glass formers (e.g., boron in B₂O₃), which may result in forming a more polymerized atomic network and, as a result, may provide better glass formation.

As used herein, the term “RO” refers to a total content of divalent metal oxides, the term “R₂O” refers to a total content of monovalent metal oxides, and the term “Alk₂O” refers to a total content of alkali metal oxides. The term R₂O encompasses alkali metal oxides (Alk₂O), in addition to other monovalent metal oxides, such as Ag₂O, Tl₂O, and Hg₂O, for example. As discussed below, in the present disclosure, a rare earth metal oxide is referred to herein by its normalized formula (RE₂O₃) in which the rare earth metal RE has the redox state “+3,” and thus rare earth metal oxides are not encompassed by the term RO.

As used herein, the term “rare earth metals” refers to the metals listed in the Lanthanide Series of the IUPAC Periodic Table, plus yttrium and scandium. As used herein, the term “rare earth metal oxides,” is used to refer to the oxides of rare earth metals in different redox states, such as “+3” for lanthanum in La₂O₃, “+4” for cerium in CeO₂, “+2” for europium in EuO, etc. In general, the redox states of rare earth metals in oxide glasses may vary and, in particular, the redox state may change during melting, based on the batch composition and/or the redox conditions in the furnace where the glass is melted and/or heat-treated (e.g., annealed). Unless otherwise specified, a rare earth metal oxide is referred to herein by its normalized formula in which the rare earth metal has the redox state “+3.” Accordingly, in the case in which a rare earth metal having a redox state other than “+3” is added to the glass composition batch, the glass compositions are recalculated by adding or removing some oxygen to maintain the stoichiometry. For example, when CeO₂ (with cerium in redox state “+4”) is used as a batch component, the resulting as-batched composition is recalculated assuming that two moles of CeO₂ is equivalent to one mole of Ce₂O₃, and the resulting as-batched composition is expressed in terms of Ce₂O₃. As used herein, the term “REₘOₙ” is used to refer to the total content of rare earth metal oxides in all redox states present, and the term “RE₂O₃” is used to refer to the total content of rare earth metal oxides in the “+3” redox state, also specified as “trivalent equivalent”.

Unless otherwise specified, all compositions are expressed in terms of as-batched mole percent (mol%). As will be understood by those having ordinary skill in the art, various melt constituents (e.g., fluorine, alkali metals, boron, etc.) may be subject to different levels of volatilization (e.g., as a function of vapor pressure, melt time and/or melt temperature) during melting of the constituents. As such, the term “about,” in relation to such constituents, is intended to encompass values within about 0.2 mol% when measuring final articles as compared to the as-batched compositions provided herein. With the forgoing in mind, substantial compositional equivalence between final articles and as-batched compositions is expected.

In the case when fluorine or other halogen (chlorine, bromine, and/or iodine) is added to or is present in an oxide glass, the molecular representation of the resulting glass composition may be expressed in different ways. In the present disclosure, the content of fluorine as a single term, when present, is expressed in terms of atomic percent (at.%), which is determined based on the fraction of fluorine in a total sum of all atoms in a glass composition multiplied by a factor of 100.

In the present disclosure, the following method of representation of fluorine-containing compositions and concentration ranges is used. The concentration limits for all oxides (e.g. SiO₂, B₂O₃, Na₂O, etc.) are presented under the assumption that the respective cations (such as, for example, silicon [Si₄⁺], boron [B₃⁺], sodium [Na⁺], etc.) are initially presented in the form of the corresponding oxides. When fluorine is present, for the purposes of calculating the concentration of components of the composition, some part of the oxygen in the oxide is equivalently replaced with fluorine (i.e. one atom of oxygen is replaced with two atoms of fluorine). The said fluorine is assumed to be present in the form of fluorides, such as silicon fluoride (SiF₄), sodium fluoride (NaF) or others; accordingly, the total sum of all oxides and fluorides is assumed to be 100 mole percent in all compositions.

The measured density values for the glasses reported herein were measured at room temperature in units of g/cm³ by Archimedes method in water with an error of 0.001 g/cm³. As used herein, density measurements at room temperature (specified as d_{RT}) are indicated as being measured at 20° C. or 25° C., and encompass measurements obtained at temperatures that may range from 20° C. to 25° C. It is understood that room temperature may vary between about 20° C. to about 25° C., however, for the purposes of the present disclosure, the variation in density within the temperature range of 20° C. to 25° C. is expected to be less than the error of 0.001 g/cm³, and thus is not expected to impact the room temperature density measurements reported herein.

As used herein, good glass forming ability refers to a resistance of the melt to devitrification as the material cools. Glass forming ability can be measured by determining the critical cooling rate of the melt. The terms “critical cooling rate” or “v_{cr}” are used herein to refer to the minimum cooling rate at which a melt of a given composition forms a glass free of crystals visible under an optical microscope under magnification of 500x. The critical cooling rate can be used to measure the glass-forming ability of a composition, i.e., the ability of the melt of a given glass composition to form glass when cooling. Generally speaking, the lower the critical cooling rate, the better the glass-forming ability.

The term “liquidus temperature” (T_{liq}) is used herein to refer to a temperature above which the glass composition is completely liquid with no crystallization of constituent components of the glass. The liquidus temperature values reported herein were obtained by measuring samples using either DSC or by isothermal hold of samples wrapped in platinum foil. For samples measured using DSC, powdered samples were heated at 10 K/min to 1250° C. The end of the endothermal event corresponding to the melting of crystals was taken as the liquidus temperature. For the second technique (isothermal hold), a glass block (about 1 cm³) was wrapped in platinum foil, to avoid volatilization, and placed in a furnace at a given temperature for 17 hours. The glass block was then observed under an optical microscope to check for crystals.

The refractive index values reported herein were measured at room temperature, unless otherwise specified. The refractive index values for a glass sample were measured using a Metricon Model 2010 prism coupler refractometer with an error of about ± 0.0002. Using the Metricon, the refractive index of a glass sample was measured at two or more wavelengths of about 406 nm, 473 nm, 532 nm, 633 nm, 828 nm, and 1064 nm. The measured dependence characterizes the dispersion and was then fitted with a Cauchy’s law equation or Sellmeier equation to allow for calculation of the refractive index of the sample at a given wavelength of interest between the measured wavelengths. The term “refractive index n_{d}” is used herein to refer to a refractive index calculated as described above at a wavelength of 587.56 nm, which corresponds to the helium d-line wavelength. The term “refractive index n_{c}” is used herein to refer to a refractive index calculated as described above at a wavelength of 656.3 nm. The term “refractive index n_{F}” is used herein to refer to a refractive index calculated as described above at a wavelength of 486.1 nm. The term “refractive index n_{g}” is used herein to refer to a refractive index calculated as described above at a wavelength of 435.8 nm.

As used herein, the terms “high refractive index” or “high index” refer to a refractive index value of a glass that is greater than or equal to at least 1.80, unless otherwise indicated. Where indicated, embodiments of the terms “high refractive index” or “high index” refer to a refractive index value of a glass that is greater than or equal to at least 1.85, greater than or equal to 1.90, or greater than or equal to 1.95, or greater than or equal to 2.00.

As used herein, unless otherwise specified, the term “internal transmittance” or τᵢₙₜ is used to refer to the transmittance through a glass sample that is corrected for Fresnel losses. The term “transmittance”, “total transmittance”, or τ is used to refer to transmittance values for which Fresnel losses are not accounted for. Transmittance of the glass samples were measured on 2 mm thick samples with a Carry 5000 Spectrometer at wavelengths of from 250 nm to 2500 nm, at a resolution of 1 nm, and using an integrating sphere. The internal transmittance values for 10 mm thick samples was calculated between 375 nm and 1175 nm using the measured refractive index and the measured raw transmittance. The wavelengths corresponding to specific values of transmittance, such as, for example, 5% or 70%, are represented as with corresponding subscripts, such as λ_{5%} and λ_{70%,} respectively.

The glass transition temperature (T_{g}) is measured by differential scanning calorimeter (DSC) at the heating rate of 10 K/min after cooling in air.

Glass composition may include boron oxide (B₂O₃). According to some embodiments of the present disclosure, boron oxide may play a role of a glass former. As a glass former, B₂O₃ may help to increase the liquidus viscosity and, therefore, protect a glass composition from crystallization. However, adding B₂O₃ to a glass composition may cause liquid-liquid phase separation, which may cause devitrification and/or reducing the transmittance of the resulting glass. Also, adding B₂O₃ to the high-index glasses reduces the refractive index. Accordingly, the amount of boron oxide in glasses of the present disclosure is limited, or glasses may be substantially free of B₂O₃. In embodiments, the glass composition may contain boron oxide (B₂O₃) in an amount from greater than or equal to 0.0 mol.% to less than or equal to 50.0 mol.% and all ranges and sub-ranges between the foregoing values. In some embodiments, the glass composition may contain B₂O₃ in an amount greater than or equal to 0.0 mol.%, greater than or equal to 1.0 mol.%, greater than or equal to 5.0 mol.%, greater than or equal to 6.0 mol.%, greater than or equal to 10.0 mol.%, greater than or equal to 14.0 mol.%, greater than or equal to 15.0 mol.%, greater than or equal to 16.0 mol.%, greater than or equal to 25.0 mol.%, greater than or equal to 35.0 mol.%, greater than or equal to 40.0 mol.%, or greater than or equal to 45.0 mol.%. In some other embodiments, the glass composition may contain B₂O₃ in an amount less than or equal to 50.0 mol.%, less than or equal to 45.0 mol.%, less than or equal to 40.0 mol.%, less than or equal to 35.0 mol.%, less than or equal to 30.0 mol.%, less than or equal to 25.0 mol.%, less than or equal to 24.0 mol.%, less than or equal to 20.0 mol.%, or less than or equal to 10.0 mol.%. In some more embodiments, the glass composition may contain B₂O₃ in an amount greater than or equal to 0.0 mol.% and less than or equal to 35.0 mol.%, greater than or equal to 1.0 mol.% and less than or equal to 40.0 mol.%, greater than or equal to 1.0 mol.% and less than or equal to 35.0 mol.%, greater than or equal to 6.0 mol.% and less than or equal to 40.0 mol.%, greater than or equal to 13.69 mol.% and less than or equal to 24.49 mol.%, greater than or equal to 15.0 mol.% and less than or equal to 30.0 mol.%, greater than or equal to 16.0 mol.% and less than or equal to 20.0 mol.%, greater than or equal to 0.0 mol.% and less than or equal to 50.0 mol.%, greater than or equal to 0.0 mol.% and less than or equal to 10.0 mol.%, greater than or equal to 1.0 mol.% and less than or equal to 10.0 mol.%, greater than or equal to 5.0 mol.% and less than or equal to 10.0 mol.%, greater than or equal to 10.0 mol.% and less than or equal to 20.0 mol.%, greater than or equal to 14.0 mol.% and less than or equal to 20.0 mol.%, greater than or equal to 15.0 mol.% and less than or equal to 20.0 mol.%.

Glass composition may include silica (SiO₂). Silica may play a role of an additional glass former. Silica, as well as B₂O₃, may help to increase the liquidus viscosity (viscosity at the liquidus temperature) and, therefore, protect a glass composition from crystallization. However, adding SiO₂ to a glass composition may cause liquid-liquid phase separation, which may cause devitrification and/or reducing the transmittance of the resulting glass. Also, SiO₂ is a low refractive index component and makes it difficult to achieve high index glasses. Accordingly, the content of SiO₂ in the embodiments of the present disclosure is limited, or glasses may be substantially free of SiO₂. In embodiments, the glass composition may contain silica (SiO₂) in an amount from greater than or equal to 0.0 mol.% to less than or equal to 50.0 mol.% and all ranges and sub-ranges between the foregoing values. In some embodiments, the glass composition may contain SiO₂ in an amount greater than or equal to 0.0 mol.%, greater than or equal to 1.0 mol.%, greater than or equal to 5.0 mol.%, greater than or equal to 10.0 mol.%, greater than or equal to 25.0 mol.%, greater than or equal to 35.0 mol.%, greater than or equal to 40.0 mol.%, or greater than or equal to 45.0 mol.%. In some other embodiments, the glass composition may contain SiO₂ in an amount less than or equal to 50.0 mol.%, less than or equal to 45.0 mol.%, less than or equal to 40.0 mol.%, less than or equal to 35.0 mol.%, less than or equal to 25.0 mol.%, less than or equal to 20.0 mol.%, less than or equal to 15.0 mol.%, less than or equal to 10.0 mol.%, less than or equal to 8.5 mol.%, or less than or equal to 5.0 mol.%. In some more embodiments, the glass composition may contain SiO₂ in an amount greater than or equal to 0.0 mol.% and less than or equal to 40.0 mol.%, greater than or equal to 0.0 mol.% and less than or equal to 15.0 mol.%, greater than or equal to 0.0 mol.% and less than or equal to 8.5 mol.%, greater than or equal to 0.03 mol.% and less than or equal to 4.77 mol.%, greater than or equal to 1.0 mol.% and less than or equal to 5.0 mol.%, greater than or equal to 10.0 mol.% and less than or equal to 20.0 mol.%, greater than or equal to 0.0 mol.% and less than or equal to 50.0 mol.%, greater than or equal to 0.0 mol.% and less than or equal to 5.0 mol.%, greater than or equal to 5.0 mol.% and less than or equal to 50.0 mol.%, greater than or equal to 5.0 mol.% and less than or equal to 8.5 mol.%, greater than or equal to 10.0 mol.% and less than or equal to 15.0 mol.%, greater than or equal to 25.0 mol.% and less than or equal to 35.0 mol.%.

Glass composition may include phosphorus oxide (P₂O₅). The glass compositions in the embodiments described herein may comprise phosphorus oxide (P₂O₅) as an additional glass former. Greater amounts of P₂O₅ cause greater increase the melt viscosity values at a given temperature, which inhibits crystallization from the melt when cooling and, therefore, improves the glass-forming ability of the melt (i.e. lowers the critical cooling rates of the melt). However, P₂O₅ significantly decreases the refractive index. Also, in some compositions P₂O₅ may stimulate liquid-liquid phase separation, which may cause crystallization of glass forming melts when cooling and/or loss of transmittance. Additionally, P₂O₅ can increase the liquidus temperature due to the low solubility of refractory phosphate phases, such as rare earth phosphates and zirconia phosphate. Accordingly, the content of P₂O₅ in high-index glasses is limited, or glasses may be free of P₂O₅. In embodiments, the glass composition may contain phosphorus oxide (P₂O₅) in an amount from greater than or equal to 0.0 mol.% to less than or equal to 40.0 mol.% and all ranges and sub-ranges between the foregoing values. In some embodiments, the glass composition may contain P₂O₅ in an amount greater than or equal to 0.0 mol.%, greater than or equal to 5.0 mol.%, greater than or equal to 20.0 mol.%, greater than or equal to 25.0 mol.%, greater than or equal to 30.0 mol.%, or greater than or equal to 35.0 mol.%. In some other embodiments, the glass composition may contain P₂O₅ in an amount less than or equal to 40.0 mol.%, less than or equal to 35.0 mol.%, less than or equal to 30.0 mol.%, less than or equal to 25.0 mol.%, less than or equal to 20.0 mol.%, or less than or equal to 5.0 mol.%. In some more embodiments, the glass composition may contain P₂O₅ in an amount greater than or equal to 0.0 mol.% and less than or equal to 40.0 mol.%, greater than or equal to 0.0 mol.% and less than or equal to 35.0 mol.%, greater than or equal to 0.0 mol.% and less than or equal to 25.0 mol.%, greater than or equal to 0.0 mol.% and less than or equal to 5.0 mol.%, greater than or equal to 5.0 mol.% and less than or equal to 40.0 mol.%, greater than or equal to 5.0 mol.% and less than or equal to 20.0 mol.%, greater than or equal to 20.0 mol.% and less than or equal to 40.0 mol.%, greater than or equal to 20.0 mol.% and less than or equal to 25.0 mol.%, greater than or equal to 25.0 mol.% and less than or equal to 40.0 mol.%, greater than or equal to 25.0 mol.% and less than or equal to 30.0 mol.%, greater than or equal to 30.0 mol.% and less than or equal to 40.0 mol.%, greater than or equal to 30.0 mol.% and less than or equal to 35.0 mol.%.

Glass composition may include germania (GeO₂). Germania (GeO₂) provides excellent ratio between the refractive index and density and does not reduce transmittance. However, germania is expensive, and thus it may make a glass composition not economical. Accordingly, the content of germania should be limited, or glass compositions may be free of GeO₂, or glasses may be substantially free of GeO₂. In embodiments, the glass composition may contain germania (GeO₂) in an amount from greater than or equal to 0.0 mol.% to less than or equal to 15.0 mol.% and all ranges and sub-ranges between the foregoing values. In some embodiments, the glass composition may contain GeO₂ in an amount greater than or equal to 0.0 mol.%, greater than or equal to 5.0 mol.%, greater than or equal to 9.0 mol.%, greater than or equal to 10.0 mol.%, greater than or equal to 11.0 mol.%, or greater than or equal to 13.0 mol.%. In some other embodiments, the glass composition may contain GeO₂ in an amount less than or equal to 15.0 mol.%, less than or equal to 13.0 mol.%, less than or equal to 11.0 mol.%, less than or equal to 10.0 mol.%, less than or equal to 9.0 mol.%, less than or equal to 6.0 mol.%, less than or equal to 5.0 mol.%, or less than or equal to 0.5 mol.%. In some more embodiments, the glass composition may contain GeO₂ in an amount greater than or equal to 0.0 mol.% and less than or equal to 15.0 mol.%, greater than or equal to 0.0 mol.% and less than or equal to 6.0 mol.%, greater than or equal to 0.0 mol.% and less than or equal to 5.0 mol.%, greater than or equal to 0.0 mol.% and less than or equal to 0.5 mol.%, greater than or equal to 5.0 mol.% and less than or equal to 15.0 mol.%, greater than or equal to 9.0 mol.% and less than or equal to 15.0 mol.%, greater than or equal to 9.0 mol.% and less than or equal to 10.0 mol.%, greater than or equal to 11.0 mol.% and less than or equal to 15.0 mol.%, greater than or equal to 11.0 mol.% and less than or equal to 13.0 mol.%.

Glass composition may include monovalent metal oxides (R₂O). Monovalent metal oxides, such as alkali metal oxides (Li₂O, Na₂O, K₂O, Rb₂O and Cs₂O) or others (for example, Ag₂O or Tl₂O) may help to better accommodate high-index components, such as TiO₂, Nb₂O₅ or WO₃, in the glass structure at a given density.

In some embodiments, the glass composition may contain monovalent metal oxides R₂O in an amount greater than or equal to 0.0 mol.%, or greater than or equal to 5.0 mol.%. In some other embodiments, the glass composition may contain monovalent metal oxides R₂O in an amount less than or equal to 8.0 mol.% or less than or equal to 5.0 mol.%. In some more embodiments, the glass composition may contain R₂O in an amount greater than or equal to 0.0 mol.% and less than or equal to 8.0 mol.%, or greater than or equal to 0.0 mol.% and less than or equal to 5.0 mol.%.

Glass composition may include sodium oxide (Na₂O). Sodium oxide, as well as potassium oxide (K₂O), may work as a modifier, increasing the solubility of high-index components, such as TiO₂, Nb₂O₅, ZrO₂, WO₃, La₂O₃ and others, therefore, increasing the refractive index of glass. However, when added in large amounts, Na₂O may make it difficult to reach high refractive indexes. Accordingly, in some embodiments of the present disclosure the content of Na₂O is limited, or a glass composition may be free of Na₂O. In embodiments, the glass composition may contain sodium oxide (Na₂O) in an amount from greater than or equal to 0.0 mol.% to less than or equal to 10.0 mol.% and all ranges and sub-ranges between the foregoing values. In some embodiments, the glass composition may contain Na₂O in an amount greater than or equal to 0.0 mol.%, or greater than or equal to 5.0 mol.%. In some other embodiments, the glass composition may contain Na₂O in an amount less than or equal to 10.0 mol.%, less than or equal to 6.0 mol.%, or less than or equal to 5.0 mol.%. In some more embodiments, the glass composition may contain Na₂O in an amount greater than or equal to 0.0 mol.% and less than or equal to 6.0 mol.%, greater than or equal to 0.03 mol.% and less than or equal to 5.64 mol.%, greater than or equal to 0.0 mol.% and less than or equal to 10.0 mol.%, greater than or equal to 0.0 mol.% and less than or equal to 5.0 mol.%, greater than or equal to 5.0 mol.% and less than or equal to 10.0 mol.%, greater than or equal to 5.0 mol.% and less than or equal to 6.0 mol.%.

Glass composition may include potassium oxide (K₂O). In embodiments, the glass composition may contain potassium oxide (K₂O) in an amount from greater than or equal to 0.0 mol.% to less than or equal to 10.0 mol.% and all ranges and sub-ranges between the foregoing values. In some embodiments, the glass composition may contain K₂O in an amount greater than or equal to 0.0 mol.%, or greater than or equal to 5.0 mol.%. In some other embodiments, the glass composition may contain K₂O in an amount less than or equal to 10.0 mol.%, less than or equal to 6.0 mol.%, or less than or equal to 5.0 mol.%. In some more embodiments, the glass composition may contain K₂O in an amount greater than or equal to 0.0 mol.% and less than or equal to 6.0 mol.%, greater than or equal to 0.0 mol.% and less than or equal to 10.0 mol.%, greater than or equal to 0.0 mol.% and less than or equal to 5.0 mol.%, greater than or equal to 5.0 mol.% and less than or equal to 10.0 mol.%, greater than or equal to 5.0 mol.% and less than or equal to 6.0 mol.%.

Glass composition may include lithium oxide (Li₂O). Lithium oxide provides the highest ratio of refractive index to density of glasses among the monovalent metal oxides. Also, in some embodiments, Li₂O may help to increase the solubility of Nb₂O₅ and TiO₂, which increases the refractive index at a given density. In addition, lithium oxide may hasten the process of bleaching the glasses. However, addition of Li₂O, even in small concentrations, may decrease the glass-forming ability of glasses by causing crystallization or liquid-liquid phase separation of glass-forming melts when cooling. Therefore, the amount of Li₂O in glasses of the present disclosure is limited. In some embodiments, the glasses may be substantially free of Li₂O. In embodiments, the glass composition may contain lithium oxide (Li₂O) in an amount from greater than or equal to 0.0 mol.% to less than or equal to 5.0 mol.% and all ranges and sub-ranges between the foregoing values. In some other embodiments, the glass composition may contain Li₂O in an amount less than or equal to 5.0 mol.%, less than or equal to 2.5 mol.%, less than or equal to 1.5 mol.%, or less than or equal to 1.09 mol.%. In some more embodiments, the glass composition may contain Li₂O in an amount greater than or equal to 0.0 mol.% and less than or equal to 1.5 mol.%, greater than or equal to 0.19 mol.% and less than or equal to 1.09 mol.%, greater than or equal to 0.0 mol.% and less than or equal to 5.0 mol.%, greater than or equal to 0.0 mol.% and less than or equal to 1.09 mol.%.

Glass composition may include divalent metal oxides (RO). Divalent metal oxides, such as alkaline earth metal oxides (BeO, MgO, CaO, SrO and BaO), zinc oxide (ZnO), cadmium oxide (CdO), lead oxide (PbO) and others, when present in a glass, provide higher refractive indexes than most monovalent oxides. Some divalent metal oxides, such as, for example, CaO, SrO and ZnO, also provide comparably low density, therefore, increasing the ratio of the refractive index to density and, accordingly, improving the performance of optical glasses in certain applications. In addition, divalent metal oxides may help to increase the solubility of high-index components, such as TiO₂, Nb₂O₅ and WO₃, which leads to a further increase in the refractive index at a given density. However, when added at high amounts, divalent metal oxides may cause crystallization of refractory minerals from the melts or liquid-liquid phase separation, which may reduce the glass-forming ability of glasses. Accordingly, the amount of divalent metal oxides in glass compositions of the present disclosure is limited.

In some embodiments, the glass composition may contain divalent metal oxides RO in an amount greater than or equal to 0.0 mol.%, or greater than or equal to 5.0 mol.%. In some other embodiments, the glass composition may contain divalent metal oxides RO in an amount less than or equal to 8.0 mol.% or less than or equal to 5.0 mol.%. In some more embodiments, the glass composition may contain RO in an amount greater than or equal to 0.0 mol.% and less than or equal to 8.0 mol.%, or greater than or equal to 0.0 mol.% and less than or equal to 5.0 mol.%.

Glass composition may include barium oxide (BaO). Barium oxide may increase the solubility of high-index components, such as TiO₂ and Nb₂O₅, which leads to an increase in the refractive index at a given density. However, barium is a heavy element and, when added in a high amount, may increase the density of the glass. Also, in high concentration, it may cause crystallization of minerals such as barium titanate (BaTiO₃), barium niobate (BaNb₂O₆) and others. Accordingly, the amount of BaO in glasses of is limited, or glasses may be substantially free of BaO. In embodiments, the glass composition may contain barium oxide (BaO) in an amount from greater than or equal to 0.0 mol.% to less than or equal to 20.0 mol.% and all ranges and sub-ranges between the foregoing values. In some embodiments, the glass composition may contain BaO in an amount greater than or equal to 0.0 mol.%, greater than or equal to 0.1 mol.%, or greater than or equal to 10.0 mol.%. In some other embodiments, the glass composition may contain BaO in an amount less than or equal to 20.0 mol.%, less than or equal to 10.0 mol.%, less than or equal to 5.5 mol.%, less than or equal to 3.0 mol.%, or less than or equal to 0.8 mol.%. In some more embodiments, the glass composition may contain BaO in an amount greater than or equal to 0.0 mol.% and less than or equal to 20.0 mol.%, greater than or equal to 0.0 mol.% and less than or equal to 5.5 mol.%, greater than or equal to 0.0 mol.% and less than or equal to 3.0 mol.%, greater than or equal to 0.08 mol.% and less than or equal to 0.75 mol.%, greater than or equal to 0.0 mol.% and less than or equal to 0.8 mol.%, greater than or equal to 0.1 mol.% and less than or equal to 20.0 mol.%, greater than or equal to 0.1 mol.% and less than or equal to 0.8 mol.%.

Glass composition may include lead oxide (PbO). Adding lead oxide to a glass composition may increase the refractive index without causing crystallization or phase separation of the glass forming melt and not compromising the visible transmittance. However, adding PbO may adversely increase the density of glass. Also, PbO raises environmental concerns. Accordingly, in some embodiments the content of PbO in glass composition is limited, or, preferably, a glass composition can be substantially free of PbO. In embodiments, the glass composition may contain lead oxide (PbO) in an amount from greater than or equal to 0.0 mol.% to less than or equal to 10.0 mol.% and all ranges and sub-ranges between the foregoing values. In some embodiments, the glass composition may contain PbO in an amount greater than or equal to 0.0 mol.%, greater than or equal to 5.0 mol.%, greater than or equal to 7.0 mol.%, greater than or equal to 8.0 mol.%, or greater than or equal to 9.0 mol.%. In some other embodiments, the glass composition may contain PbO in an amount less than or equal to 10.0 mol.%, less than or equal to 9.0 mol.%, less than or equal to 8.0 mol.%, less than or equal to 7.0 mol.%, less than or equal to 5.0 mol.%, less than or equal to 2.0 mol.%, or less than or equal to 0.5 mol.%. In some more embodiments, the glass composition may contain PbO in an amount greater than or equal to 0.0 mol.% and less than or equal to 10.0 mol.%, greater than or equal to 0.0 mol.% and less than or equal to 2.0 mol.%, greater than or equal to 0.0 mol.% and less than or equal to 0.5 mol.%, greater than or equal to 5.0 mol.% and less than or equal to 10.0 mol.%, greater than or equal to 5.0 mol.% and less than or equal to 7.0 mol.%, greater than or equal to 7.0 mol.% and less than or equal to 10.0 mol.%, greater than or equal to 7.0 mol.% and less than or equal to 8.0 mol.%, greater than or equal to 8.0 mol.% and less than or equal to 10.0 mol.%, greater than or equal to 8.0 mol.% and less than or equal to 9.0 mol.%.

Glass composition may include zirconia (ZrO₂). Zirconia can increase the refractive index while maintaining low density. ZrO₂ can also increase the viscosity of the melt, which may help to inhibit crystallization from the melt. ZrO₂ does not introduce coloring in the glass in the visible and near-UV ranges, which may help to maintain a high transmittance of the glass. However, high concentrations of zirconia may cause crystallization of refractory minerals, such as zirconia (ZrO₂), zircon (ZrSiO₄), calcium zirconate (CaZrO₃) and others, which may decrease the glass-forming ability of the melt. In embodiments, the glass composition may contain zirconia (ZrO₂) in an amount from greater than or equal to 0.0 mol.% to less than or equal to 10.0 mol.% and all ranges and sub-ranges between the foregoing values. In some embodiments, the glass composition may contain ZrO₂ in an amount greater than or equal to 0.0 mol.%, greater than or equal to 1.0 mol.%, greater than or equal to 5.0 mol.%, greater than or equal to 6.1 mol.%, greater than or equal to 6.5 mol.%, or greater than or equal to 6.8 mol.%. In some other embodiments, the glass composition may contain ZrO₂ in an amount less than or equal to 10.0 mol.%, less than or equal to 10.0 mol.%, less than or equal to 9.0 mol.%, less than or equal to 8.0 mol.%, less than or equal to 7.8 mol.%, or less than or equal to 5.0 mol.%. In some more embodiments, the glass composition may contain ZrO₂ in an amount greater than or equal to 0.0 mol.% and less than or equal to 10.0 mol.%, greater than or equal to 1.0 mol.% and less than or equal to 9.0 mol.%, greater than or equal to 6.1 mol.% and less than or equal to 12.0 mol.%, greater than or equal to 6.5 mol.% and less than or equal to 8.0 mol.%, greater than or equal to 6.8 mol.% and less than or equal to 7.79 mol.%, greater than or equal to 0.0 mol.% and less than or equal to 12.0 mol.%, greater than or equal to 0.0 mol.% and less than or equal to 5.0 mol.%, greater than or equal to 1.0 mol.% and less than or equal to 12.0 mol.%, greater than or equal to 1.0 mol.% and less than or equal to 5.0 mol.%, greater than or equal to 5.0 mol.% and less than or equal to 12.0 mol.%, greater than or equal to 5.0 mol.% and less than or equal to 7.8 mol.%, greater than or equal to 6.1 mol.% and less than or equal to 7.8 mol.%, greater than or equal to 6.5 mol.% and less than or equal to 12.0 mol.%, greater than or equal to 6.5 mol.% and less than or equal to 7.8 mol.%.

Glass composition may include gallia (Ga₂O₃). Gallium oxide plays a role similar to Al₂O₃, increasing the viscosity, but with a lesser effect on liquidus temperature, which may lead to an increase in the liquidus viscosity, thus improving the glass-forming ability of glasses. However, gallia is expensive. Accordingly, the amount of Ga₂O₃ in glasses of the present disclosure is limited, or glasses may be substantially free of Ga₂O₃. In embodiments, the glass composition may contain gallia (Ga₂O₃) in an amount from greater than or equal to 0.0 mol.% to less than or equal to 10.0 mol.% and all ranges and sub-ranges between the foregoing values. In some embodiments, the glass composition may contain Ga₂O₃ in an amount greater than or equal to 0.0 mol.%, greater than or equal to 5.0 mol.%, greater than or equal to 7.0 mol.%, greater than or equal to 8.0 mol.%, or greater than or equal to 9.0 mol.%. In some other embodiments, the glass composition may contain Ga₂O₃ in an amount less than or equal to 10.0 mol.%, less than or equal to 9.0 mol.%, less than or equal to 8.0 mol.%, less than or equal to 7.0 mol.%, or less than or equal to 5.0 mol.%. In some more embodiments, the glass composition may contain Ga₂O₃ in an amount greater than or equal to 0.0 mol.% and less than or equal to 5.0 mol.%, greater than or equal to 0.0 mol.% and less than or equal to 10.0 mol.%, greater than or equal to 5.0 mol.% and less than or equal to 10.0 mol.%, greater than or equal to 5.0 mol.% and less than or equal to 7.0 mol.%, greater than or equal to 7.0 mol.% and less than or equal to 10.0 mol.%, greater than or equal to 7.0 mol.% and less than or equal to 8.0 mol.%, greater than or equal to 8.0 mol.% and less than or equal to 10.0 mol.%, greater than or equal to 8.0 mol.% and less than or equal to 9.0 mol.%.

Glass composition may include yttria (Y₂O₃). Yttria behaves like lanthanum oxide, but may provide a given refractive index at a lower density, while still not providing undesirable coloring. However, adding Y₂O₃ in high amounts to the glass compositions may adversely cause crystallization of the glass melts when cooling. Accordingly, in some embodiments of the present disclosure, the content of Y₂O₃ may be limited. In embodiments, the glass composition may contain yttria (Y₂O₃) in an amount from greater than or equal to 0.0 mol.% to less than or equal to 10.0 mol.% and all ranges and sub-ranges between the foregoing values. In some embodiments, the glass composition may contain Y₂O₃ in an amount greater than or equal to 0.0 mol.%, greater than or equal to 1.0 mol.%, or greater than or equal to 5.0 mol.%. In some other embodiments, the glass composition may contain Y₂O₃ in an amount less than or equal to 10.0 mol.%, less than or equal to 6.0 mol.%, or less than or equal to 5.0 mol.%. In some more embodiments, the glass composition may contain Y₂O₃ in an amount greater than or equal to 0.0 mol.% and less than or equal to 6.0 mol.%, greater than or equal to 0.8 mol.% and less than or equal to 5.04 mol.%, greater than or equal to 1.0 mol.% and less than or equal to 6.0 mol.%, greater than or equal to 0.0 mol.% and less than or equal to 10.0 mol.%, greater than or equal to 0.0 mol.% and less than or equal to 5.0 mol.%, greater than or equal to 1.0 mol.% and less than or equal to 10.0 mol.%, greater than or equal to 1.0 mol.% and less than or equal to 5.0 mol.%, greater than or equal to 5.0 mol.% and less than or equal to 10.0 mol.%, greater than or equal to 5.0 mol.% and less than or equal to 6.0 mol.%.

Glass composition may include tellurium oxide (TeO₂). Tellurium oxide behaves like bismuth oxide, but is very expensive. Accordingly, the content of tellurium oxide should be limited, or glass compositions may be free of TeO₂. In embodiments, the glass composition may contain tellurium oxide (TeO₂) in an amount from greater than or equal to 0.0 mol.% to less than or equal to 15.0 mol.% and all ranges and sub-ranges between the foregoing values. In some embodiments, the glass composition may contain TeO₂ in an amount greater than or equal to 0.0 mol.%, greater than or equal to 0.2 mol.%, greater than or equal to 5.0 mol.%, greater than or equal to 9.0 mol.%, greater than or equal to 10.0 mol.%, greater than or equal to 11.0 mol.%, or greater than or equal to 13.0 mol.%. In some other embodiments, the glass composition may contain TeO₂ in an amount less than or equal to 15.0 mol.%, less than or equal to 13.0 mol.%, less than or equal to 11.0 mol.%, less than or equal to 10.0 mol.%, less than or equal to 9.0 mol.%, less than or equal to 5.0 mol.%, less than or equal to 2.0 mol.%, less than or equal to 1.0 mol.%, or less than or equal to 0.6 mol.%. In some more embodiments, the glass composition may contain TeO₂ in an amount greater than or equal to 0.0 mol.% and less than or equal to 15.0 mol.%, greater than or equal to 0.0 mol.% and less than or equal to 5.0 mol.%, greater than or equal to 0.0 mol.% and less than or equal to 2.0 mol.%, greater than or equal to 0.0 mol.% and less than or equal to 1.0 mol.%, greater than or equal to 0.23 mol.% and less than or equal to 0.59 mol.%, greater than or equal to 0.2 mol.% and less than or equal to 0.6 mol.%, greater than or equal to 5.0 mol.% and less than or equal to 15.0 mol.%, greater than or equal to 5.0 mol.% and less than or equal to 9.0 mol.%, greater than or equal to 9.0 mol.% and less than or equal to 10.0 mol.%, greater than or equal to 10.0 mol.% and less than or equal to 11.0 mol.%.

Glass composition may include bismuth oxide (Bi₂O₃). Bi₂O₃ provides very high refractive index, but leads to an increase in density. It may also decrease the viscosity of melts at high temperatures, which may cause crystallization of the melt when cooling. Accordingly, the content of bismuth oxide should be limited. When melting exemplary glasses, it was empirically found that when bismuth oxide was added in small concentrations, some glass compositions of the present disclosure became easier to vitrify, which means that the glasses free of bulk crystals could be formed after melting at lower temperatures, or cooling with lower rate, or both. The ability to melt a glass composition at a lower temperature may help to reduce undesirable coloring and reduce the time of bleaching if the bleaching step is required for a given glass composition. On the other hand, when the concentration of Bi₂O₃ in a glass composition is low, undesirable loss of blue transmittance may also be reduced comparing to higher concentrations of Bi₂O₃. Accordingly, it was empirically found that in the composition range of the present disclosure, the addition of small amounts of Bi₂O₃ provides an optimal combination of glass-forming ability and blue transmittance than in the cases when bismuth oxide is not added or added in higher concentrations. In embodiments, the glass composition may contain bismuth oxide (Bi₂O₃₎ in an amount from greater than or equal to 0.0 mol.% to less than or equal to 10.0 mol.% and all ranges and sub-ranges between the foregoing values. In some embodiments, the glass composition may contain Bi₂O₃ in an amount greater than or equal to 0.0 mol.%, greater than or equal to 0.05 mol.%, greater than or equal to 0.1 mol.%, greater than or equal to 5.0 mol.%, greater than or equal to 7.0 mol.%, greater than or equal to 8.0 mol.%, or greater than or equal to 9.0 mol.%. In some other embodiments, the glass composition may contain Bi₂O₃ in an amount less than or equal to 10.0 mol.%, less than or equal to 9.0 mol.%, less than or equal to 8.0 mol.%, less than or equal to 7.0 mol.%, less than or equal to 5.0 mol.%, less than or equal to 4.0 mol.%, less than or equal to 1.5 mol.%, or less than or equal to 0.9 mol.%. In some more embodiments, the glass composition may contain Bi₂O₃ in an amount greater than or equal to 0.05 mol.% and less than or equal to 8.0 mol.%, greater than or equal to 0.05 mol.% and less than or equal to 4.0 mol.%, greater than or equal to 0.05 mol.% and less than or equal to 1.5 mol.%, greater than or equal to 0.05 mol.% and less than or equal to 0.9 mol.%, greater than or equal to 0.1 mol.% and less than or equal to 10.0 mol.%, greater than or equal to 0.38 mol.% and less than or equal to 5.16 mol.%, greater than or equal to 0.0 mol.% and less than or equal to 10.0 mol.%, greater than or equal to 0.0 mol.% and less than or equal to 0.9 mol.%, greater than or equal to 0.1 mol.% and less than or equal to 0.9 mol.%.

Glass composition may include tungsten oxide (WO₃). WO₃ provides high refractive index without significantly increasing density or causing undesirable coloring. Also, the addition of WO₃ to glass composition may decrease the liquidus temperature, which allows melting at lower temperatures, that, in turn, may increase the transmittance of such glasses. Also, addition of WO₃ may decrease the glass transition temperature T_{g}, which allows glass formation at lower temperatures. At high concentrations of WO₃, the liquidus temperature tends to increase, and the viscosity at the liquidus temperature drops, making it difficult to avoid crystallization of melts when cooling. Accordingly, the content of WO₃ should be limited, or glass compositions may be free of WO₃. In embodiments, the glass composition may contain tungsten oxide (WO₃) in an amount from greater than or equal to 0.0 mol.% to less than or equal to 40.0 mol.% and all ranges and sub-ranges between the foregoing values. In some embodiments, the glass composition may contain WO₃ in an amount greater than or equal to 0.0 mol.%, greater than or equal to 5.0 mol.%, greater than or equal to 16.0 mol.%, greater than or equal to 20.0 mol.%, greater than or equal to 25.0 mol.%, greater than or equal to 30.0 mol.%, or greater than or equal to 35.0 mol.%. In some other embodiments, the glass composition may contain WO₃ in an amount less than or equal to 40.0 mol.%, less than or equal to 35.0 mol.%, less than or equal to 30.0 mol.%, less than or equal to 25.0 mol.%, less than or equal to 20.0 mol.%, less than or equal to 19.0 mol.%, less than or equal to 5.0 mol.%, or less than or equal to 3.0 mol.%. In some more embodiments, the glass composition may contain WO₃ in an amount greater than or equal to 0.0 mol.% and less than or equal to 40.0 mol.%, greater than or equal to 0.0 mol.% and less than or equal to 25.0 mol.%, greater than or equal to 0.0 mol.% and less than or equal to 3.0 mol.%, greater than or equal to 15.87 mol.% and less than or equal to 19.05 mol.%, greater than or equal to 5.0 mol.% and less than or equal to 19.0 mol.%, greater than or equal to 16.0 mol.% and less than or equal to 19.0 mol.%, greater than or equal to 20.0 mol.% and less than or equal to 25.0 mol.%, greater than or equal to 25.0 mol.% and less than or equal to 40.0 mol.%, greater than or equal to 25.0 mol.% and less than or equal to 30.0 mol.%.

Glass composition may include lanthanum oxide (La₂O₃). Lanthanum oxide is a high-index component that has little effect on transmittance in the visible range. Also, addition of La₂O₃ may inhibit phase separation. However, La₂O₃ provides higher density relative to other high-index components, such as, for example, TiO₂, Nb₂O₅ or WO₃. Also, when added in high amounts, it may cause crystallization of refractory species, like lanthanum disilicate (La₂Si₂O₇), lanthanum zirconate (La₂ZrO₅) and others, and, accordingly, reduce glass forming ability. For this reason, the content of La₂O₃ in the glasses of the present disclosure should be limited. In embodiments, the glass composition may contain lanthanum oxide (La₂O₃) in an amount from greater than or equal to 0.0 mol.% to less than or equal to 40.0 mol.% and all ranges and sub-ranges between the foregoing values. In some embodiments, the glass composition may contain La₂O₃ in an amount greater than or equal to 0.0 mol.%, greater than or equal to 5.0 mol.%, greater than or equal to 15.0 mol.%, greater than or equal to 16.5 mol.%, greater than or equal to 20.0 mol.%, greater than or equal to 25.0 mol.%, greater than or equal to 30.0 mol.%, or greater than or equal to 35.0 mol.%. In some other embodiments, the glass composition may contain La₂O₃ in an amount less than or equal to 40.0 mol.%, less than or equal to 35.0 mol.%, less than or equal to 30.0 mol.%, less than or equal to 27.0 mol.%, less than or equal to 26.5 mol.%, less than or equal to 25.0 mol.%, less than or equal to 23.7 mol.%, less than or equal to 20.0 mol.%, or less than or equal to 5.0 mol.%. In some more embodiments, the glass composition may contain La₂O₃ in an amount greater than or equal to 0.0 mol.% and less than or equal to 40.0 mol.%, greater than or equal to 0.0 mol.% and less than or equal to 30.0 mol.%, greater than or equal to 0.0 mol.% and less than or equal to 26.5 mol.%, greater than or equal to 15.0 mol.% and less than or equal to 27.0 mol.%, greater than or equal to 16.5 mol.% and less than or equal to 23.73 mol.%, greater than or equal to 20.0 mol.% and less than or equal to 30.0 mol.%, greater than or equal to 5.0 mol.% and less than or equal to 20.0 mol.%, greater than or equal to 16.5 mol.% and less than or equal to 40.0 mol.%, greater than or equal to 16.5 mol.% and less than or equal to 20.0 mol.%.

Glass composition may include titania (TiO₂). The levels of TiO₂ and/or Nb₂O₅ that are typically used in glasses to increase refractive index tend to decrease the transmittance in the near-UV region and shift the UV cut-off to higher wavelengths. Accordingly, the amount of TiO₂ is limited. In embodiments, the glass composition may contain titania (TiO₂) in an amount from greater than or equal to 0.0 mol.% to less than or equal to 64.0 mol.% and all ranges and sub-ranges between the foregoing values. In some embodiments, the glass composition may contain TiO₂ in an amount greater than or equal to 0.0 mol.%, greater than or equal to 0.5 mol.%, greater than or equal to 1.0 mol.%, greater than or equal to 5.0 mol.%, greater than or equal to 10.0 mol.%, greater than or equal to 12.0 mol.%, greater than or equal to 20.0 mol.%, greater than or equal to 22.0 mol.%, greater than or equal to 25.0 mol.%, greater than or equal to 49.0 mol.%, greater than or equal to 50.0 mol.%, greater than or equal to 54.0 mol.%, or greater than or equal to 59.0 mol.%. In some other embodiments, the glass composition may contain TiO₂ in an amount less than or equal to 64.0 mol.%, less than or equal to 59.0 mol.%, less than or equal to 54.0 mol.%, less than or equal to 50.0 mol.%, less than or equal to 49.0 mol.%, less than or equal to 45.0 mol.%, less than or equal to 35.0 mol.%, less than or equal to 30.0 mol.%, less than or equal to 25.0 mol.%, or less than or equal to 10.0 mol.%. In some more embodiments, the glass composition may contain TiO₂ in an amount greater than or equal to 0.5 mol.% and less than or equal to 45.0 mol.%, greater than or equal to 1.0 mol.% and less than or equal to 50.0 mol.%, greater than or equal to 1.0 mol.% and less than or equal to 35.0 mol.%, greater than or equal to 5.0 mol.% and less than or equal to 30.0 mol.%, greater than or equal to 12.05 mol.% and less than or equal to 30.35 mol.%, greater than or equal to 20.0 mol.% and less than or equal to 35.0 mol.%, greater than or equal to 22.0 mol.% and less than or equal to 25.0 mol.%, greater than or equal to 0.0 mol.% and less than or equal to 64.0 mol.%, greater than or equal to 0.0 mol.% and less than or equal to 10.0 mol.%, greater than or equal to 0.5 mol.% and less than or equal to 64.0 mol.%, greater than or equal to 5.0 mol.% and less than or equal to 10.0 mol.%, greater than or equal to 10.0 mol.% and less than or equal to 25.0 mol.%, greater than or equal to 12.0 mol.% and less than or equal to 25.0 mol.%, greater than or equal to 20.0 mol.% and less than or equal to 64.0 mol.%, greater than or equal to 20.0 mol.% and less than or equal to 25.0 mol.%, greater than or equal to 22.0 mol.% and less than or equal to 64.0 mol.%.

Glass composition may include niobia (Nb₂O₅). Niobia can be used to increase the refractive index of glass while maintaining a low density. However, niobia can introduce a yellow coloring to the glass that cannot be bleached in the same manner as titania, which can result in a loss of transmittance, particularly in the blue and UV range. Niobia may cause crystallization and/or phase separation of the melt. In some embodiments, the glasses may be substantially free of Nb₂O₅. In embodiments, the glass composition may contain niobia (Nb₂O₅) in an amount from greater than or equal to 0.0 mol.% to less than or equal to 64.0 mol.% and all ranges and sub-ranges between the foregoing values. In some embodiments, the glass composition may contain Nb₂O₅ in an amount greater than or equal to 0.0 mol.%, greater than or equal to 1.0 mol.%, greater than or equal to 5.0 mol.%, greater than or equal to 7.0 mol.%, greater than or equal to 7.4 mol.%, greater than or equal to 10.0 mol.%, greater than or equal to 25.0 mol.%, greater than or equal to 49.0 mol.%, greater than or equal to 50.0 mol.%, greater than or equal to 54.0 mol.%, or greater than or equal to 59.0 mol.%. In some other embodiments, the glass composition may contain Nb₂O₅ in an amount less than or equal to 64.0 mol.%, less than or equal to 59.0 mol.%, less than or equal to 54.0 mol.%, less than or equal to 50.0 mol.%, less than or equal to 49.0 mol.%, less than or equal to 40.0 mol.%, less than or equal to 30.0 mol.%, less than or equal to 25.0 mol.%, less than or equal to 20.0 mol.%, less than or equal to 16.9 mol.%, less than or equal to 10.0 mol.%, less than or equal to 9.0 mol.%, or less than or equal to 6.7 mol.%. In some more embodiments, the glass composition may contain Nb₂O₅ in an amount greater than or equal to 0.0 mol.% and less than or equal to 40.0 mol.%, greater than or equal to 0.0 mol.% and less than or equal to 20.0 mol.%, greater than or equal to 1.0 mol.% and less than or equal to 50.0 mol.%, greater than or equal to 1.0 mol.% and less than or equal to 9.0 mol.%, greater than or equal to 5.0 mol.% and less than or equal to 6.7 mol.%, greater than or equal to 7.0 mol.% and less than or equal to 30.0 mol.%, greater than or equal to 7.44 mol.% and less than or equal to 16.88 mol.%, greater than or equal to 0.0 mol.% and less than or equal to 64.0 mol.%, greater than or equal to 0.0 mol.% and less than or equal to 6.7 mol.%, greater than or equal to 1.0 mol.% and less than or equal to 6.7 mol.%, greater than or equal to 5.0 mol.% and less than or equal to 64.0 mol.%, greater than or equal to 7.4 mol.% and less than or equal to 9.0 mol.%, greater than or equal to 10.0 mol.% and less than or equal to 16.9 mol.%, greater than or equal to 25.0 mol.% and less than or equal to 64.0 mol.%.

Glass composition may include fluorine (F). Adding fluorine to a glass composition is known to provide lower optical dispersion, which may improve the image quality. Also, fluorine can in some cases decrease the liquidus temperature, preventing a glass article from crystallization when cooling the melt. However, fluorine may raise ecological concerns. For that reason, the content of fluorine is limited, or glasses are free of fluorine. In embodiments, the glass composition may contain fluorine (F) in an amount from greater than or equal to 0.0 at.% to less than or equal to 10.0 at.% and all ranges and sub-ranges between the foregoing values. In some embodiments, the glass composition may contain F in an amount greater than or equal to 0.0 at.%, greater than or equal to 5.0 at.%, greater than or equal to 7.0 at.%, greater than or equal to 8.0 at.%, or greater than or equal to 9.0 at.%. In some other embodiments, the glass composition may contain F in an amount less than or equal to 10.0 at.%, less than or equal to 9.0 at.%, less than or equal to 8.0 at.%, less than or equal to 7.0 at.%, less than or equal to 5.0 at.%, less than or equal to 1.0 at.%, or less than or equal to 0.1 at.%. In some more embodiments, the glass composition may contain F in an amount greater than or equal to 0.0 at.% and less than or equal to 10.0 at.%, greater than or equal to 0.0 at.% and less than or equal to 1.0 at.%, greater than or equal to 0.0 at.% and less than or equal to 0.1 at.%, greater than or equal to 5.0 at.% and less than or equal to 10.0 at.%, greater than or equal to 5.0 at.% and less than or equal to 7.0 at.%, greater than or equal to 7.0 at.% and less than or equal to 10.0 at.%, greater than or equal to 7.0 at.% and less than or equal to 8.0 at.%, greater than or equal to 8.0 at.% and less than or equal to 10.0 at.%, greater than or equal to 8.0 at.% and less than or equal to 9.0 at.%.

In some embodiments, the glass composition may have a sum of B₂O₃+SiO₂ greater than or equal to 0.0 mol.%, greater than or equal to 1.0 mol.%, greater than or equal to 21.0 mol.%, or greater than or equal to 25.0 mol.%. In some other embodiments, the glass composition may have a sum of B₂O₃+SiO₂ less than or equal to 50.0 mol.%, less than or equal to 27.0 mol.%, or less than or equal to 25.0 mol.%. In some more embodiments, the glass composition may have a sum of B₂O₃+SiO₂ greater than or equal to 1.0 mol.% and less than or equal to 50.0 mol.%, greater than or equal to 0.0 mol.% and less than or equal to 50.0 mol.%, greater than or equal to 0.0 mol.% and less than or equal to 27.0 mol.%, or greater than or equal to 0.0 mol.% and less than or equal to 25.0 mol.%, greater than or equal to 1.0 mol.% and less than or equal to 27.0 mol.%, or greater than or equal to 1.0 mol.% and less than or equal to 25.0 mol.%, greater than or equal to 21.0 mol.% and less than or equal to 50.0 mol.%, greater than or equal to 21.0 mol.% and less than or equal to 27.0 mol.%, or greater than or equal to 21.0 mol.% and less than or equal to 25.0 mol.%.

In some embodiments, the glass composition may have a sum of B₂O₃+SiO₂+P₂O₅ greater than or equal to 0.0 mol.%, greater than or equal to 5.0 mol.%, greater than or equal to 20.0 mol.%, or greater than or equal to 22.0 mol.%. In some other embodiments, the glass composition may have a sum of B₂O₃+SiO₂+P₂O₅ less than or equal to 35.0 mol.%, less than or equal to 27.0 mol.%, or less than or equal to 20.0 mol.%. In some more embodiments, the glass composition may have a sum of B₂O₃+SiO₂+P₂O₅ greater than or equal to 5.0 mol.% and less than or equal to 35.0 mol.%, greater than or equal to 0.0 mol.% and less than or equal to 35.0 mol.%, greater than or equal to 0.0 mol.% and less than or equal to 27.0 mol.%, or greater than or equal to 0.0 mol.% and less than or equal to 20.0 mol.%, greater than or equal to 5.0 mol.% and less than or equal to 27.0 mol.%, or greater than or equal to 5.0 mol.% and less than or equal to 20.0 mol.%, greater than or equal to 20.0 mol.% and less than or equal to 35.0 mol.%, or greater than or equal to 20.0 mol.% and less than or equal to 27.0 mol.%.

In some other embodiments, the glass composition may have a sum of Gd₂O₃+Yb₂O₃ less than or equal to 2.0 mol.% or less than or equal to 1.0 mol.%. In some more embodiments, the glass composition may have a sum of Gd₂O₃+Yb₂O₃ greater than or equal to 0.0 mol.% and less than or equal to 2.0 mol.%, or greater than or equal to 0.0 mol.% and less than or equal to 1.0 mol.%.

In some embodiments, the glass composition may have a sum of La₂O₃ +TiO₂ +B₂O₃ +SiO₂ +ZrO₂ +Nb₂O₅ +BaO +Y₂O₃ +CaO +Ga₂O₃ +Gd₂O₃ +ZnO +WO₃ +CeO₂ +SrO +Na₂O +Ta₂O₅ +Al₂O₃ greater than or equal to 99.0 mol.%, or greater than or equal to 99.5 mol.%. In some more embodiments, the glass composition may have a sum of La₂O₃ +TiO₂ +B₂O₃ +SiO₂ +ZrO₂ +Nb₂O₅ +BaO +Y₂O₃ +CaO +Ga₂O₃ +Gd₂O₃ +ZnO +WO₃ +CeO₂ +SrO +Na₂O +Ta₂O₅ +Al₂O₃ greater than or equal to 99.0 mol.% and less than or equal to 100 mol.%.

In some embodiments, the glass composition may have a sum of La₂O₃ +TiO₂ +B₂O₃ +SiO₂ +ZrO₂ +Nb₂O₅ +Bi₂O₃ greater than or equal to 97.0 mol.%, greater than or equal to 98.0 mol.%, or greater than or equal to 99.0 mol.%. In some more embodiments, the glass composition may have a sum of La₂O₃ +TiO₂ +B₂O₃ +SiO₂ +ZrO₂ +Nb₂O₅ +Bi₂O₃ greater than or equal to 97.0 mol.% and less than or equal to 100 mol.%.

In some embodiments, the glass composition may have a sum of La₂O₃ +Y₂O₃ +Gd₂O₃ +TiO₂ +B₂O₃ +SiO₂ +ZrO₂ +Nb₂O₅ +Bi₂O₃ +Li₂O +CaO +SrO +BaO greater than or equal to 99.0 mol.%, or greater than or equal to 99.5 mol.%. In some more embodiments, the glass composition may have a sum of La₂O₃ +Y₂O₃ +Gd₂O₃ +TiO₂ +B₂O₃ +SiO₂ +ZrO₂ +Nb₂O₅ +Bi₂O₃ +Li₂O +CaO +SrO +BaO greater than or equal to 99.0 mol.% and less than or equal to 100 mol.%.

In some embodiments, the glass composition may have a sum of La₂O₃ +Y₂O₃ +Gd₂O₃ +TiO₂ +B₂O₃ +SiO₂ +ZrO₂ +Nb₂O₅ +CaO +BaO greater than or equal to 99.0 mol.%, or greater than or equal to 99.5 mol.%. In some more embodiments, the glass composition may have a sum of La₂O₃ +Y₂O₃ +Gd₂O₃ +TiO₂ +B₂O₃ +SiO₂ +ZrO₂ +Nb₂O₅ +CaO +BaO greater than or equal to 99.0 mol.% and less than or equal to 100 mol.%.

In some embodiments, the glass composition may have a sum of R₂O+RO greater than or equal to 0.0 mol.%, or greater than or equal to 10.0 mol.%. In some other embodiments, the glass composition may have a sum of R₂O+RO less than or equal to 12.0 mol.%, less than or equal to 10.0 mol.%, less than or equal to 8.0 mol.%, less than or equal to 6.0 mol.%, less than or equal to 1.3 mol.%, or less than or equal to 1.0 mol.%. In some more embodiments, the glass composition may have a sum of R₂O+RO greater than or equal to 0.0 mol.% and less than or equal to 12.0 mol.%, greater than or equal to 0.0 mol.% and less than or equal to 8.0 mol.%, greater than or equal to 0.0 mol.% and less than or equal to 6.0 mol.%, greater than or equal to 0.0 mol.% and less than or equal to 1.0 mol.%, greater than or equal to 0.0 mol.% and less than or equal to 1.3 mol.%.

In some embodiments, the glass composition may have a sum of SiO₂+B₂O₃ greater than or equal to 0.0 mol.%, or greater than or equal to 10.0 mol.%.

In some embodiments, the glass composition may have a sum of TiO₂+Nb₂O₅ greater than or equal to 0.0 mol.%, greater than or equal to 1.0 mol.%, greater than or equal to 25.0 mol.%, greater than or equal to 27.0 mol.%, or greater than or equal to 50.0 mol.%. In some other embodiments, the glass composition may have a sum of TiO₂+Nb₂O₅ less than or equal to 64.0 mol.%, less than or equal to 50.0 mol.%, less than or equal to 38.0 mol.%, or less than or equal to 25.0 mol.%. In some more embodiments, the glass composition may have a sum of TiO₂+Nb₂O₅ greater than or equal to 1.0 mol.% and less than or equal to 64.0 mol.%, greater than or equal to 0.0 mol.% and less than or equal to 64.0 mol.%, greater than or equal to 0.0 mol.% and less than or equal to 50.0 mol.%, greater than or equal to 0.0 mol.% and less than or equal to 38.0 mol.%, or greater than or equal to 0.0 mol.% and less than or equal to 25.0 mol.%, greater than or equal to 1.0 mol.% and less than or equal to 50.0 mol.%, greater than or equal to 1.0 mol.% and less than or equal to 38.0 mol.%, or greater than or equal to 1.0 mol.% and less than or equal to 25.0 mol.%, greater than or equal to 25.0 mol.% and less than or equal to 64.0 mol.%, greater than or equal to 25.0 mol.% and less than or equal to 50.0 mol.%, or greater than or equal to 25.0 mol.% and less than or equal to 38.0 mol.%, greater than or equal to 27.0 mol.% and less than or equal to 64.0 mol.%, greater than or equal to 27.0 mol.% and less than or equal to 50.0 mol.%, or greater than or equal to 27.0 mol.% and less than or equal to 38.0 mol.%.

In some embodiments, the glass composition may have a sum of TiO₂+Nb₂O₅+La₂O₃ greater than or equal to 0.0 mol.%, or greater than or equal to 50.0 mol.%. In some other embodiments, the glass composition may have a sum of TiO₂+Nb₂O₅+La₂O₃ less than or equal to 70.0 mol.% or less than or equal to 50.0 mol.%. In some more embodiments, the glass composition may have a sum of TiO₂+Nb₂O₅+La₂O₃ greater than or equal to 0.0 mol.% and less than or equal to 70.0 mol.%, or greater than or equal to 0.0 mol.% and less than or equal to 50.0 mol.%.

In some other embodiments, the glass composition may have a sum of WO₃+Bi₂O₃ less than or equal to 3.0 mol.%, less than or equal to 2.0 mol.%, or less than or equal to 1.0 mol.%. In some more embodiments, the glass composition may have a sum of WO₃+Bi₂O₃ greater than or equal to 0.05 mol.% and less than or equal to 3.0 mol.%, greater than or equal to 0.0 mol.% and less than or equal to 3.0 mol.%, greater than or equal to 0.0 mol.% and less than or equal to 2.0 mol.%, or greater than or equal to 0.0 mol.% and less than or equal to 1.0 mol.%.

In some embodiments, the glass composition may have a sum of ZrO₂+HfO₂ greater than or equal to 0.0 mol.%, or greater than or equal to 1.0 mol.%.

In some embodiments, glass composition may have limitations for SiO₂+B₂O₃-P₂O₅. The difference SiO₂₊B₂O₃-P₂O₅, expressed in terms of mol.%, distinguishes borate and silicoborate glasses, having positive values of this difference, from phosphate glasses where the difference is negative. For borophosphate or silicoborophosphate glasses, the difference SiO₂+B₂O₃-P₂O₅ can have zero, small positive or small negative values. In some embodiments, the glass may have a difference SiO₂+B₂O₃-P₂O₅ greater than or equal to -8.0 mol.%, greater than or equal to 5.0 mol.%, greater than or equal to 10.0 mol.%, or greater than or equal to 21.0 mol.%. In some other embodiments, the glass may have a difference SiO₂+B₂O₃-P₂O₅ less than or equal to 27.0 mol.% or less than or equal to 10.0 mol.%. In some more embodiments, the glass may have a difference SiO₂+B₂O₃-P₂O₅ greater than or equal to -8.0 mol.% and less than or equal to 27.0 mol.%, or greater than or equal to -8.0 mol.% and less than or equal to 10.0 mol.%, greater than or equal to 5.0 mol.% and less than or equal to 27.0 mol.%.

In some embodiments, glass composition may have limitations for a ratio SiO₂/(SiO₂+B₂O₃). It was empirically found that SiO₂ and B₂O₃, when being presented together in a glass composition, may improve the glass forming ability of a melt and protect it from the liquid-liquid phase separation. Higher values of the ratio SiO₂/(SiO₂+B₂O₃) may help to improve the chemical durability, whereas lower values of this ratio may improve the solubility of the high index components. In some embodiments, the glass may have a ratio SiO₂/(SiO₂+B₂O₃)mol.% greater than or equal to 0.0, or greater than or equal to 0.2. In some other embodiments, the glass may have a ratio SiO₂/(SiO₂+B₂O₃)mol.% less than or equal to 0.4 or less than or equal to 0.2. In some more embodiments, the glass may have a ratio SiO₂/(SiO₂+B₂O₃)mol.% greater than or equal to 0.0 and less than or equal to 0.4, or greater than or equal to 0.0 and less than or equal to 0.2.

In some embodiments, the glass may have a refractive index at 587.56 nm n_{d} from greater than or equal to 1.95 to less than or equal to 2.17 and all ranges and sub-ranges between the foregoing values. In some embodiments, the glass may have a refractive index at 587.56 nm n_{d} greater than or equal to 1.95, greater than or equal to 2.00, greater than or equal to 2.01, greater than or equal to 2.05, greater than or equal to 2.07, greater than or equal to 2.11, greater than or equal to 2.13, or greater than or equal to 2.15. In some other embodiments, the glass may have a refractive index at 587.56 nm n_{d} less than or equal to 2.17, less than or equal to 2.15, less than or equal to 2.13, less than or equal to 2.12, less than or equal to 2.11, less than or equal to 2.05, or less than or equal to 2.00. In some more embodiments, the glass may have a refractive index at 587.56 nm n_{d} greater than or equal to 2.01 and less than or equal to 2.15, greater than or equal to 1.95 and less than or equal to 2.17, greater than or equal to 2.00 and less than or equal to 2.17, greater than or equal to 2.00 and less than or equal to 2.05, greater than or equal to 2.01 and less than or equal to 2.05, greater than or equal to 2.05 and less than or equal to 2.11, greater than or equal to 2.07 and less than or equal to 2.11.

In some embodiments, the glass may have a density at room temperature d_{RT} from greater than or equal to 4.00 g/cm³ to less than or equal to 6.10 g/cm³ and all ranges and sub-ranges between the foregoing values. In some embodiments, the glass may have a density at room temperature d_{RT} greater than or equal to 4.00 g/cm³, greater than or equal to 4.20 g/cm³, greater than or equal to 4.50 g/cm³, greater than or equal to 5.00 g/cm³, greater than or equal to 5.10 g/cm³, greater than or equal to 5.50 g/cm³, greater than or equal to 5.70 g/cm³, greater than or equal to 5.90 g/cm³, or greater than or equal to 6.00 g/cm³. In some other embodiments, the glass may have a density at room temperature d_{RT} less than or equal to 6.10 g/cm³, less than or equal to 6.00 g/cm³, less than or equal to 5.90 g/cm³, less than or equal to 5.70 g/cm³, less than or equal to 5.60 g/cm³, less than or equal to 5.50 g/cm³, less than or equal to 5.00 g/cm³, or less than or equal to 4.50 g/cm³. In some more embodiments, the glass may have a density at room temperature d_{RT} greater than or equal to 4.20 g/cm³ and less than or equal to 6.00 g/cm³, greater than or equal to 4.50 g/cm³ and less than or equal to 5.50 g/cm³, greater than or equal to 4.00 g/cm³ and less than or equal to 6.10 g/cm³, greater than or equal to 4.00 g/cm³ and less than or equal to 4.50 g/cm³, greater than or equal to 4.20 g/cm³ and less than or equal to 6.10 g/cm³, greater than or equal to 4.20 g/cm³ and less than or equal to 4.50 g/cm³, greater than or equal to 5.00 g/cm³ and less than or equal to 5.50 g/cm³, greater than or equal to 5.10 g/cm³ and less than or equal to 5.50 g/cm³, greater than or equal to 5.50 g/cm³ and less than or equal to 5.60 g/cm³.

In some embodiments, the glass may have a liquidus temperature T_{liq} less than or equal to 1260° C.

In some embodiments, the glass may have the transmittance at a wavelength of 460 nm TX₄₆₀ₙₘ, % greater than or equal to 70.

In some embodiments, the glass may have a quantity n_{d} - (1.62 + 0.08 * d_{RT}) greater than or equal to 0.000.

In some embodiments, the glass may have a quantity n_{d} - (1.65 + 0.08 * d_{RT}) greater than or equal to 0.000.

Refractive index n_{d} and density d_{RT} are properties of glass that can be predicted from the glass composition. A linear regression analysis of the Exemplary Glasses of the present disclosure in the EXAMPLES section below and other glass compositions reported in the literature was performed to determine equations that can predict the composition dependences of the refractive index n_{d} and the density d_{RT}.

The training dataset of glass compositions satisfying the compositional limitations specified in Table 1 below and having measured values of the properties of interest (n_{d} and d_{RT}), about 100 glass compositions for each property (n_{d} and d_{RT}), were randomly selected from literature data presented in the publicly available SciGlass Information System database and from the Exemplary Glasses from the embodiments presented herein. The linear regression analysis on the above-specified dataset, excluding outliers, was used to determine the formulas (I) and (II). presented in Table 2 below for predictive parameters Pₙ and P_{d} that predict n_{d} and d_{RT}, respectively. Another subset of glass compositions satisfying the compositional limitations of Table 1 was used as a validation set to evaluate the ability to interpolate within the compositional limitations of Table 1 and was used to establish the standard deviations specified in Table 2 for the predictive parameters Pₙ and P_{d}. An external dataset of prior art glass compositions, also randomly selected from the SciGlass Information System database, was used to evaluate the ability to predict the properties (n_{d} and d_{RT}) outside of the compositional limits of Table 1 with reasonable accuracy. Multiple iterations of this process were performed in order to determine the best formula for predicting each property (n_{d} and d_{RT}). Formulas (I) and (II) in Table 2 are the result of the analysis.

The data for the Comparative Glass compositions used in the linear regression modeling, including the training dataset, validation dataset and external dataset were obtained from the publicly available SciGlass Information System database. Formulas (I) and (II) below were obtained from the linear regression analysis:

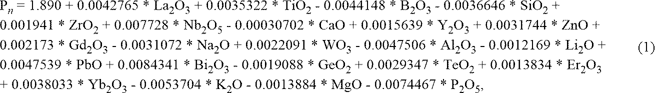

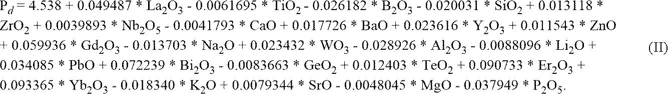

In Formulas (I) and (II) and Tables 1 and 2, Pₙ is a predictive parameter that predicts the refractive index at 587.56 nm, n_{d}, calculated from the components of the glass composition expressed in mol.%, and P_{d} is a predictive parameter that predicts the density at room temperature d_{RT}, calculated from the components of the glass composition expressed in mol.%.

In Formulas (I) and (II), each component of the glass composition is listed in terms of its chemical formula, where the chemical formula refers to the concentration of the component expressed in mol.%. For example, for purposes of Formulas (I) and (II), La₂O₃ refers to the concentration of La₂O₃, expressed in mol.%, in the glass composition. It is understood that not all components listed in Formulas (I) and (II) are necessarily present in a particular glass composition and that Formulas (I) and (II) are equally valid for glass compositions that contain less than all of the components listed in the formulas. It is further understood that Formulas (I) and (II) are also valid for glass compositions within the scope and claims of the present disclosure that contain components in addition to the components listed in the formulas. If a component listed in Formulas (I) and (II) is absent in a particular glass composition, the concentration of the component in the glass composition is 0 mol.% and the contribution of the component to the value calculated from the formulas is zero. In Tables 1 and 3, R₂O is a total sum of monovalent metal oxides and RO is a total sum of divalent metal oxides.

TABLE 1

Composition Space Used for Modeling

| Property | n_{d} | | d_{RT}, g/cm³ | |
|---|---|---|---|---|
| Component limits | Min, mol.% | Max, mol.% | Min, mol.% | Max, mol.% |
| B₂O₃ | 0 | 30 | 0 | 30 |
| La₂O₃ | 0 | 25 | 0 | 25 |
| TiO₂ | 0.5 | 30 | 0.5 | 30 |
| WO₃ | 0 | 30 | 0 | 30 |
| Nb₂O₅ | 0 | 20 | 0 | 20 |
| ZrO₂ | 0 | 10 | 0 | 10 |
| Y₂O₃ | 0 | 10 | 0 | 10 |
| SiO₂ | 0 | 15 | 0 | 15 |
| Bi₂O₃ | 0 | 10 | 0 | 10 |
| P₂O₅ | 0 | 30 | 0 | 30 |
| TiO₂ + Nb₂O₅ + WO₃ + La₂O₃ | 30 | Not limited | 30 | Not limited |
| R₂O + RO | 0 | 20 | 0 | 20 |
| Other species | 0 | Not limited | 0 | Not limited |

TABLE 2

Property prediction models

| Property | Abbreviation | Unit | Predicting Parameter | Regression Formula | Composition Unit | Standard Deviation |
|---|---|---|---|---|---|---|
| Refractive index at 587.56 nm | n_{d} | | Pₙ | Formula (I) | Mol.% | 0.027 |
| Density at room temperature | d_{RT} | g/cm³ | P_{d} | Formula (II) | Mol.% | 0.11 |

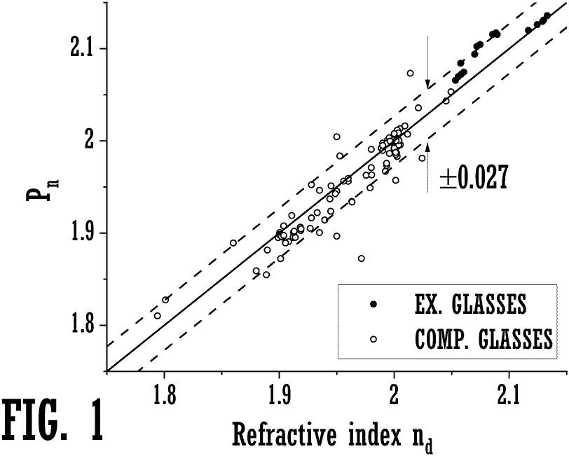

FIG. 1 is a plot of the parameter Pₙ calculated by Formula (I) as a function of measured refractive index n_{d} for some Comparative Glasses (“Comp. Glasses”) taken from the literature and some Exemplary Glasses (“Ex. Glasses”). As illustrated by the data in FIG. 1, the compositional dependence of the parameter Pₙ had a standard deviation within a range of ± 0.027 unit of the measured n_{d} for the majority of glasses, which corresponds to the standard error specified in Table 2.

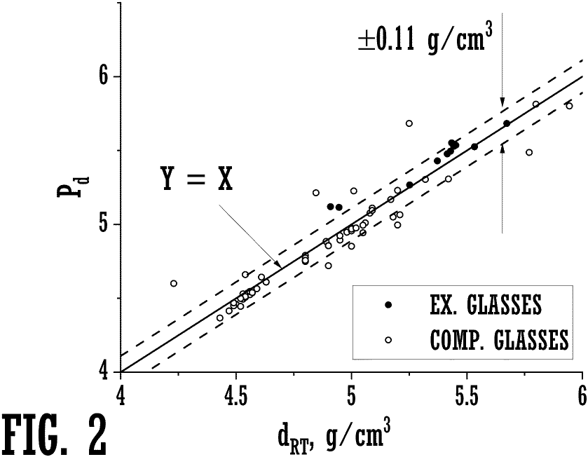

FIG. 2 is a plot of the parameter P_{d} calculated by Formula (II) as a function of measured density d_{RT} for some Literature Glasses (“Comp. Glasses”) and some Exemplary Glasses (“Ex. Glasses”). As illustrated by the data in FIG. 2, the compositional dependence of the parameter P_{d} had a standard deviation within a range of ± 0.11 unit of the measured d_{RT} for the majority of glasses, which corresponds to the standard deviation specified in Table 2.

Table 3 identifies the combination of components and their respective amounts according to some embodiments of the present disclosure. The Exemplary Glasses A in Table 3 may include additional components according to any aspects of the present disclosure as described herein.

TABLE 3

Exemplary Glasses A

| | |
|---|---|
| Component | Amount (mol.%) |
| B₂O₃ | 0.0 to 35.0 mol.% |
| P₂O₅ | 0.0 to 35.0 mol.% |
| SiO₂ | 0.0 to 15.0 mol.% |
| GeO₂ | 0.0 to 15.0 mol.% |
| Bi₂O₃ | 0.05 to 4.0 mol.% |
| Sum of (B₂O₃+SiO₂+P₂O₅) | 5.0 to 35.0 mol.% |
| Sum of (TiO₂+Nb₂O₅) | 1.0 to 64.0 mol.% |
| Sum of (R₂O+RO) | 0.0 to 8.0 mol.% |

Exemplary Glasses A according to embodiments of the present disclosure may optionally fluorine (F) in an amount 0.0 to 10.0 at.%.

Table 4 identifies the combination of components and their respective amounts according to some embodiments of the present disclosure. The Exemplary Glasses B in Table 4 may include additional components according to any aspects of the present disclosure as described herein.

TABLE 4

Exemplary Glasses B

| | |
|---|---|
| Component | Amount (mol.%) |
| TiO₂ | 1.0 to 50.0 mol.% |
| Nb₂O₅ | 1.0 to 50.0 mol.% |
| Bi₂O₃ | 0.1 to 10.0 mol.% |
| Sum of (B₂O₃+SiO₂) | 1.0 to 50.0 mol.% |

Exemplary Glasses B according to embodiments of the present disclosure may satisfy the following condition:

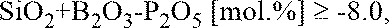

where chemical formulas refer to the amounts of components in glass, expressed in mol.%.

According to some embodiments of the present disclosure, Exemplary Glasses B may also have a refractive index at 587.56 nm n_{d} of greater than or equal to 2.05.

Table 5 identifies the combination of components and their respective amounts according to some embodiments of the present disclosure. The Exemplary Glasses C in Table 5 may include additional components according to any aspects of the present disclosure as described herein.

TABLE 5

Exemplary Glasses C

| | |
|---|---|
| Component | Amount (mol.%) |
| B₂O₃ | 1.0 to 40.0 mol.% |
| TiO₂ | 0.5 to 45.0 mol.% |
| SiO₂ | 0.0 to 40.0 mol.% |
| P₂O₅ | 0.0 to 40.0 mol.% |
| WO₃ | 0.0 to 40.0 mol.% |
| Nb₂O₅ | 0.0 to 40.0 mol.% |
| La₂O₃ | 0.0 to 40.0 mol.% |
| TeO₂ | 0.0 to 15.0 mol.% |
| GeO₂ | 0.0 to 15.0 mol.% |
| Bi₂O₃ | 0.05 to 8.0 mol.% |
| PbO | 0.0 to 10.0 mol.% |
| Ga₂O₃ | 0.0 to 5.0 mol.% |

Exemplary Glasses C according to embodiments of the present disclosure may have a density at room temperature d_{RT} [g/cm³] from 4.2 to 6.

According to some embodiments of the present disclosure, Exemplary Glasses C may also satisfy the following formula:

$${\text{n}}_{\text{d}} \text{-} \left(1.62 + 0.08 \text{*} {\text{d}}_{\text{RT}}\right) > 0.000 ,$$

where n_{d} is a refractive index at 587.56 nm, and d_{RT} is a density at room temperature.

According to some embodiments of the present disclosure, Exemplary Glasses C may also satisfy the following formula:

$${\text{n}}_{\text{d}} \text{-} \left(1.65 + 0.08 \text{*} {\text{d}}_{\text{RT}}\right) > 0.000 ,$$

where n_{d} is a refractive index at 587.56 nm, and d_{RT} is a density at room temperature.

### EXAMPLES

The following examples describe various features and advantages provided by the disclosure, and are in no way intended to limit the invention and appended claims.

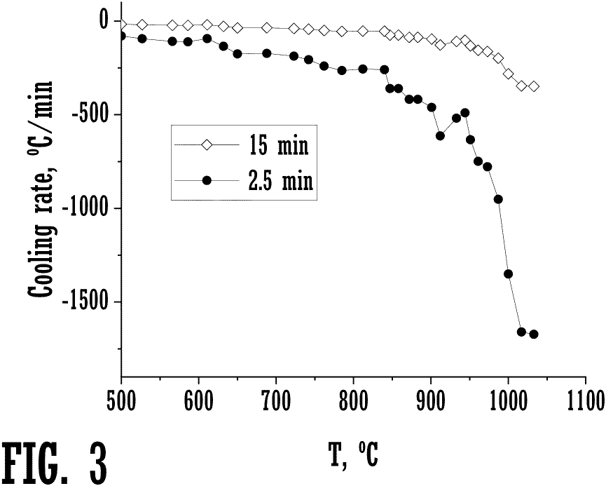

To prepare the glass samples for some exemplary glasses of the present disclosure, about 15 grams of each sample (content of intended components in the as-batched compositions was more than 99.99 wt %) was melted from batch raw materials at a temperature of about 1300° C. in platinum or platinum-rhodium crucibles (Pt:Rh=80:20) for 1 hour. One of two controlled cooling conditions were applied. In the first condition (referred to as “15 min test” or “15 min devit test”), the cooling conditions were controlled so that it took about 15 min for the samples to cool from 1100° C. to 500° C. in air inside a furnace. In the second condition (referred to as “2.5 min test” or “2.5 min devit test”), the cooling conditions were controlled so that it took about 2.5 min for the samples to cool from 1100° C. to 500° C. in air inside a furnace. Temperature readings were obtained by direct reading of the furnace temperature or using an IR camera reading with calibration scaling. The first condition (15 min test) approximately corresponds to a cooling rate of up to 300° C./min at a temperature of 1000° C. and the second test approximately corresponds to a cooling rate of up to 600° C./min at 1000° C. The temperature of 1000° C. corresponds approximately to the temperature at which the cooling rate was expected to approach a maximum. When the temperature is lower, the cooling rate also decreases significantly. Typical schedules of the first and second cooling regimes are shown in FIG. 3. For these samples, observations referred to as “15-min devit test” and “2.5-min devit test”, are specified in Table 6 below; the observation “1” is used to denote that a glass composition passed the indicated devit test, where a composition is deemed to have passed the indicated devit test if a melt of the composition forms a glass free of crystals visible under an optical microscope under magnification from 100x to 500x. The observation “0” is used to denote that a glass composition failed the indicated devit test.

To prepare other glass samples for exemplary glasses of the present disclosure, unless otherwise specified, a one kilogram batch of the components was prepared in a pure platinum crucible. The crucible was placed in a furnace set at a temperature of 1250° C., the temperature in the furnace was then raised to 1300° C. and held at 1300° C. for 2 hours. The furnace temperature was then reduced to 1250° C. and the glass was allowed to equilibrate at this temperature for an hour before being poured on a steel table and annealed at about Tg for an hour.

Some sample melts were also melted in a “one liter” platinum crucible heated by the Joule effect. In this process, approximately 5000 g of raw materials (components as batched) was used. The crucible was filled with the batch components in 1.5 hours at temperatures between 1150° C. and 1250° C. Once filled, a hold at temperature between 1200° C. and 1350° C. was done for 0.5 to one hour. During this step, the glass melt was continuously stirred (20-60 rpm). The hold was then extended for 0.5 to one hour with the stirrer off. A conditioning step was then done at temperatures between 1050° C. and 1300° C. and the melt was allowed to equilibrate for 0.5 to one hour while stirring at a rate of 20-60 rpm. The glass was then delivered through a tube and cast on a cooled graphite table to form the glass. The glass was formed into a bar 5 -25 mm thick, 30-60 mm wide, and 40-90 cm long. The bars were inspected under an optical microscope to check for crystallization and were all crystal free. The glass quality observed under the optical microscope was good with the bars being free of striae and bubbles. The glass was placed at about Tg in a lehr oven for 1 hour for a rough annealing. The bars were then annealed in a static furnace for one hour at about Tg and the temperature was then lowered at 1° C./min.

Some of exemplary glasses were bleached after melting to improve the transmittance. The bleaching process was performed at a temperature between 500° C. and Tₓ, the crystallization onset temperature. When the bleaching temperature is less than about 500° C., the rate of bleaching is slow and the time required for bleaching is too long to be practical. When the bleaching temperature exceeds Tₓ, the glass may crystallize when heat treating. The higher the bleaching temperature, the faster the bleaching process, but lower transmittance is typically observed when bleaching at fast rates. Accordingly, the temperature and time of bleaching was selected to come to an acceptable transmittance within a reasonable time, such as less than or equal to 24 hours, or less than or equal to 48 hours, or less than or equal to 96 hours, or like. Before bleaching, the glasses were heated from room temperature to the bleaching temperature at a rate from 3 to 5° C./min. After bleaching, the glasses were cooled from the bleaching temperature to the room temperature at a rate from 1 to 3° C./min.

No chemical analysis of the tested samples was performed because chemical analysis was performed for similar samples prepared in independent meltings by XRF (X-ray fluorescence - for all oxides, except for B₂O₃ and Li₂O), by ICP-OES (inductively coupled plasma optical emission spectroscopy - for B₂O₃) and by FES (flame emission spectroscopy - for Li₂O). These analyses gave deviations from the batched compositions within ±2.0 mass %.

Some Exemplary Glasses were exposed to Nanostrip 2X cleaning solution. Dried glass samples were submerged in 600 ml of Nanostrip 2X solution (Capitol Scientific, 85% H₂SO₄ and <1% H₂O₂) for 50 min at 70° C. while stirring at 400 rpm. The ratio of surface area to volume of the glass samples used in this test was 0.08 cm⁻¹. After 50 minutes, the samples were quenched in deionized water, rinsed in 18 MΩ water, and then dried by high-pure nitrogen gas and placed in a desiccator overnight. Weight loss normalized to surface area (mg/cm²) and weight loss percentage (wt%) were calculated.

Tables 6 and 7 list Exemplary Glasses and Additional Exemplary Glasses in accordance with the present disclosure. Table 8 lists Comparative Glasses.

TABLE 6

Exemplary Glass Compositions

| | | | | | | | | | |
|---|---|---|---|---|---|---|---|---|---|
| Exemplary Glass | | 1 | 2 | 3 | 4 | 5 | 6 | 7 | 8 |
| Composition - mol.% | | | | | | | | | |
| B₂O₃ | mol.% | 22.05 | 24.04 | 23.65 | 21.95 | 22.34 | 21.31 | 21.23 | 21.58 |
| TiO₂ | mol.% | 29.16 | 29.21 | 27.94 | 30.29 | 29.94 | 31.14 | 30.43 | 30.15 |
| Nb₂O₅ | mol.% | 8.45 | 8.43 | 9.20 | 7.74 | 7.95 | 7.22 | 7.44 | 7.60 |
| La₂O₃ | mol.% | 23.10 | 21.83 | 22.86 | 23.50 | 23.42 | 23.72 | 23.72 | 23.67 |
| WO₃ | mol.% | 0 | 2.28 | 0 | 0 | 0 | 0 | 0 | 0 |
| SiO₂ | mol.% | 4.21 | 1.47 | 2.99 | 4.29 | 3.99 | 4.77 | 4.82 | 4.57 |
| Bi₂O₃ | mol.% | 0.76 | 0.73 | 1.50 | 0.57 | 0.76 | 0.23 | 0.38 | 0.54 |
| ZrO₂ | mol.% | 6.81 | 6.80 | 6.80 | 6.80 | 6.80 | 6.80 | 6.80 | 6.80 |
| Na₂O | mol.% | 0.0263 | 0.0263 | 0.0268 | 0.026 | 0.0261 | 0.0257 | 0.026 | 0.0261 |
| Y₂O₃ | mol.% | 5.43 | 5.19 | 5.04 | 4.83 | 4.76 | 4.78 | 5.14 | 5.04 |
| Ta₂O₅ | mol.% | 0.0074 | 0.0074 | 0.0075 | 0.0073 | 0.0073 | 0.0072 | 0.0073 | 0.0073 |

Composition constraints

| B₂O₃ + SiO₂ + P₂O₅ | mol.% | 26.26 | 25.51 | 26.64 | 26.24 | 26.33 | 26.08 | 26.05 | 26.15 |
|---|---|---|---|---|---|---|---|---|---|
| TiO₂ + Nb₂O₅ | mol.% | 37.62 | 37.64 | 37.14 | 38.03 | 37.89 | 38.36 | 37.87 | 37.75 |
| R₂O + RO | mol.% | 0.02632 | 0.02634 | 0.02683 | 0.02601 | 0.02614 | 0.02571 | 0.02595 | 0.02607 |
| B₂O₃ + SiOz | mol.% | 26.26 | 25.51 | 26.64 | 26.24 | 26.33 | 26.08 | 26.05 | 26.15 |
| SiO₂ + B₂O₃ - P₂O₅ | mol.% | 26.26 | 25.51 | 26.64 | 26.24 | 26.33 | 26.08 | 26.05 | 26.15 |
| Measured properties | | | | | | | | | |
| T_{liq} | °C | 1284 | 1285 | 1275 | | | | 1272 | 1268 |
| 15-min devit test (0/1) | | | | | 1 | 1 | 1 | 1 | 1 |
| 2.5-min devit test (0/1) | | | | | | | | 1 | |
| Predicted and calculated properties | | | | | | | | | |
| Pₙ [for n_{d}] | | 2.0723 | 2.0726 | 2.0758 | 2.0701 | 2.0711 | 2.0682 | 2.0694 | 2.070 |
| P_{d} [for d_{RT}] | g/cm³ | 5.1451 | 5.1303 | 5.1705 | 5.1283 | 5.1354 | 5.1134 | 5.1393 | 5.1445 |
| Pₙ - (1.62 + 0.08 * P_{d}) | | 0.0407 | 0.0421 | 0.0421 | 0.0399 | 0.0402 | 0.0391 | 0.0383 | 0.0385 |
| Pₙ - (1.65 + 0.08 * P_{d}) | | 0.0107 | 0.0121 | 0.0121 | 0.0099 | 0.0102 | 0.0091 | 0.0083 | 0.0085 |

TABLE 6 Continued

| Exemplary Glass | | 9 | 10 | 11 | 12 | 13 | 14 | 15 | 16 |
|---|---|---|---|---|---|---|---|---|---|
| Composition — mol.% | | | | | | | | | |
| B₂O₃ | mol.% | 20.89 | 21.24 | 21.06 | 20.75 | 21.05 | 13.67 | 24.44 | 24.40 |
| TiO₂ | mol.% | 30.42 | 30.42 | 30.43 | 30.43 | 30.43 | 31.84 | 12.14 | 12.11 |
| Nb₂O₅ | mol.% | 7.44 | 7.44 | 7.44 | 7.44 | 7.44 | 6.80 | 15.52 | 15.83 |
| La₂O₃ | mol.% | 23.72 | 23.73 | 23.73 | 23.73 | 23.73 | 24.03 | 14.41 | 14.14 |
| WO₃ | mol.% | 0 | 0 | 0 | 0 | 0 | 0 | 16.23 | 15.87 |
| SiOz | mol.% | 4.68 | 4.82 | 4.73 | 4.62 | 4.72 | 13.41 | 0.0336 | 0.0337 |
| Bi₂O₃ | mol.% | 0.20 | 0.12 | 0.11 | 0.11 | 0.28 | 2.47 | 7.73 | 8.18 |
| ZrO₂ | mol.% | 6.80 | 6.80 | 6.80 | 6.81 | 6.81 | 7.79 | 8.21 | 8.14 |
| Na₂O | mol.% | 0.0258 | 0.0258 | 0.0258 | 0.0257 | 0.0259 | 0 | 0 | 0 |
| K₂O | mol.% | 0 | 0.27 | 0.17 | 0 | 0 | 0 | 0 | 0 |
| Y₂O₃ | mol.% | 5.13 | 5.13 | 5.13 | 5.13 | 5.13 | 0 | 1.28 | 1.28 |
| Li₂O | mol.% | 0.70 | 0 | 0.37 | 0.96 | 0.38 | 0 | 0 | 0 |
| Ta₂O₅ | mol.% | 0.0072 | 0.0072 | 0.0072 | 0.0072 | 0.0073 | 0 | 0.0137 | 0.0138 |
| Composition constraints | | | | | | | | | |
| B₂O₃ + SiO₂ + P₂O₅ | mol.% | 25.57 | 26.06 | 25.79 | 25.36 | 25.77 | 27.08 | 24.47 | 24.44 |
| TiO₂ + Nb₂O₅ | mol.% | 37.85 | 37.86 | 37.86 | 37.87 | 37.87 | 38.64 | 27.66 | 27.93 |
| R₂O + RO | mol.% | 0.7212 | 0.2974 | 0.5694 | 0.9860 | 0.4015 | 0 | 0 | 0 |
| B₂O₃ + SiO ₂ | mol.% | 25.57 | 26.06 | 25.79 | 25.36 | 25.77 | 27.08 | 24.47 | 24.44 |
| SiO₂ + B₂O₃ - P₂O₅ | mol.% | 25.57 | 26.06 | 25.79 | 25.36 | 25.77 | 27.08 | 24.47 | 24.44 |
| Measured properties | | | | | | | | | |
| n_{d} | | | 2.0533 | | | | 2.0579 | | 2.1291 |
| d_{RT} | g/cm3 | | 4.946 | 4.909 | | | | | |
| T_{g} | °C | | 719 | 714 | | | 717 | | 601 |
| Tₓ | °C | | 827 | 814 | | | 824 | | 713 |
| T_{liq} | °C | 1283 | 1274 | 1278 | | | 1240 | 1123 | |
| 15-min devit test (0/1) | | | 1 | 1 | | | | 1 | 1 |
| 2.5-min devit test (0/1) | | 1 | 1 | 1 | | 1 | | | |
| Predicted and calculated properties | | | | | | | | | |
| Pₙ [for n_{d}] | | 2.0689 | 2.0657 | 2.0668 | 2.0688 | 2.0693 | 2.0842 | 2.1254 | 2.1295 |
| P_{d} [for d_{RT}] | g/cm³ | 5.1311 | 5.115 | 5.1195 | 5.128 | 5.1353 | 5.212 | 5.6739 | 5.6867 |
| Pₙ - (1.62 + 0.08 * P_{d}) | | 0.0384 | 0.0365 | 0.0373 | 0.0386 | 0.0385 | 0.0473 | 0.0515 | 0.0546 |
| Pₙ - (1.65 + 0.08 * P_{d}) | | 0.0084 | 0.0065 | 0.0073 | 0.0086 | 0.0085 | 0.0173 | 0.0215 | 0.0246 |

TABLE 6 Continued

| Exemplary Glass | | 17 | 18 | 19 | 20 | 21 | 22 | 23 | 24 |
|---|---|---|---|---|---|---|---|---|---|
| Composition — mol.% | | | | | | | | | |
| B₂O₃ | mol. % | 24.34 | 24.39 | 23.97 | 24.29 | 23.59 | 26.38 | 28.58 | 25.98 |
| TiO₂ | mol. % | 12.05 | 12.13 | 12.14 | 12.09 | 12.10 | 13.09 | 12.00 | 13.06 |
| Nb₂O₅ | mol. % | 16.15 | 15.44 | 15.43 | 15.69 | 15.68 | 13.94 | 15.55 | 12.52 |
| La₂O₃ | mol. % | 13.88 | 14.28 | 14.15 | 13.91 | 13.68 | 15.49 | 15.80 | 16.50 |
| WO₃ | mol. % | 15.51 | 16.23 | 16.23 | 15.87 | 15.88 | 17.07 | 14.91 | 19.05 |
| SiO ₂ | mol. % | 0.0339 | 0.0336 | 0.0336 | 0.0338 | 0.0339 | 0.032 | 0.0319 | 0.0316 |
| Bi₂O₃ | mol. % | 8.65 | 7.92 | 7.91 | 8.52 | 8.51 | 5.16 | 5.12 | 3.68 |
| ZrO₂ | mol. % | 8.09 | 8.29 | 8.30 | 8.30 | 8.29 | 7.27 | 7.00 | 7.48 |
| Y₂O₃ | mol. % | 1.29 | 1.28 | 1.28 | 1.29 | 1.28 | 1.55 | 1.00 | 1.68 |
| TeO₂ | mol. % | 0 | 0 | 0.54 | 0 | 0.96 | 0 | 0 | 0 |
| Ta₂O₅ | mol. % | 0.0138 | 0.0137 | 0.0137 | 0.0138 | 0.0138 | 0.0131 | 0.013 | 0.0129 |
| Composition constrinats | | | | | | | | | |
| B₂O₃ + SiO₂ + P₂O₅ | mol. % | 24.37 | 24.43 | 24.01 | 24.33 | 23.62 | 26.42 | 28.61 | 26.01 |
| TiO₂ + Nb₂O₅ | mol. % | 28.20 | 27.57 | 27.57 | 27.77 | 27.78 | 27.02 | 27.55 | 25.58 |
| B₂O₃ + SiO ₂ | mol. % | 24.37 | 24.43 | 24.01 | 24.33 | 23.62 | 26.42 | 28.61 | 26.01 |
| SiO₂ + B₂O₃ - ₂O₅ | mol. % | 24.37 | 24.43 | 24.01 | 24.33 | 23.62 | 26.42 | 28.61 | 26.01 |
| Measured properties | | | | | | | | | |
| n_{d} | | | 2.1244 | | 2.1299 | 2.133 | | | |
| T_{liq} | °C | 1111 | | | | | | | |
| 15-min devit test (0/1) | | 1 | 1 | 1 | 1 | 1 | 1 | 1 | 1 |
| Predicted and calculated properties | | | | | | | | | |
| Pₙ [for n_{d}] | | 2.134 | 2.1261 | 2.129 | 2.131 | 2.1359 | 2.0914 | 2.0851 | 2.0789 |
| P_{d} [for d_{RT}] | g/cm³ | 5.7015 | 5.6831 | 5.6941 | 5.7041 | 5.7219 | 5.4931 | 5.3934 | 5.4931 |
| Pₙ - (1.62 + 0.08 * P_{d}) | | 0.0579 | 0.0515 | 0.0534 | 0.0547 | 0.0581 | 0.0319 | 0.0336 | 0.0195 |
| Pₙ - (1.65 + 0.08 * P_{d}) | | 0.0279 | 0.0215 | 0.0234 | 0.0247 | 0.0281 | 0.0019 | 0.0036 | -0.0105 |

TABLE 6 Continued

| Exemplary Glass | | 25 | 26 | 27 | 28 | 29 | 30 | 31 | 32 |
|---|---|---|---|---|---|---|---|---|---|
| Composition - mol.% | | | | | | | | | |
| B₂O₃ | mol. % | 28.00 | 29.85 | 25.56 | 27.65 | 21.90 | 22.19 | 21.91 | 21.68 |
| TiO₂ | mol. % | 12.01 | 11.12 | 13.04 | 11.97 | 13.85 | 13.78 | 13.84 | 13.89 |
| Nb₂O₅ | mol. % | 13.86 | 15.40 | 11.06 | 12.48 | 16.88 | 16.09 | 16.83 | 17.47 |
| La₂O₃ | mol. % | 16.92 | 17.02 | 17.53 | 17.92 | 17.94 | 18.59 | 17.98 | 17.45 |
| WO₃ | mol. % | 17.30 | 15.23 | 21.11 | 19.21 | 18.34 | 18.99 | 18.38 | 17.85 |
| BaO | mol. % | 0 | 0 | 0 | 0 | 0.50 | 0.26 | 0.37 | 0.50 |
| SiO₂ | mol. % | 0.0314 | 0.0314 | 0.0312 | 0.031 | 0.0312 | 0.0318 | 0.0316 | 0.0314 |
| Bi₂O₃ | mol. % | 3.44 | 3.64 | 2.16 | 1.98 | 0.71 | 1.21 | 1.30 | 1.24 |
| ZrO₂ | mol. % | 7.25 | 7.00 | 7.69 | 7.45 | 7.03 | 7.00 | 7.03 | 7.05 |
| Y₂O₃ | mol. % | 1.18 | 0.71 | 1.81 | 1.30 | 0.80 | 0.80 | 0.80 | 0.80 |
| Li₂O | mol. % | 0 | 0 | 0 | 0 | 1.51 | 0.77 | 1.14 | 1.52 |
| CaO | mol. % | 0 | 0 | 0 | 0 | 0.50 | 0.27 | 0.37 | 0.50 |
| Ta₂O₅ | mol. % | 0.0128 | 0.0128 | 0.0085 | 0.0127 | 0.017 | 0.013 | 0.0172 | 0.0171 |
| Composition constraints | | | | | | | | | |
| B₂O₃ + SiO₂ + P₂O₅ | mol. % | 28.03 | 29.88 | 25.60 | 27.68 | 21.93 | 22.23 | 21.94 | 21.72 |
| TiO₂ + Nb₂O₅ | mol. % | 25.87 | 26.52 | 24.10 | 24.45 | 30.73 | 29.87 | 30.67 | 31.36 |
| R₂O + RO | mol. % | 0 | 0 | 0 | 0 | 2.509 | 1.299 | 1.889 | 2.525 |
| B₂O₃ + SiO₂ | mol. % | 28.03 | 29.88 | 25.60 | 27.68 | 21.93 | 22.23 | 21.94 | 21.72 |
| SiO₂ + B₂O₃ - P₂O₅ | mol. % | 28.03 | 29.88 | 25.60 | 27.68 | 21.93 | 22.23 | 21.94 | 21.72 |

Measured properties

| | | | | | | | | | |
|---|---|---|---|---|---|---|---|---|---|
| d_{RT} | g/cm³ | | | | | | 5.429 | | 5.372 |
| 15-min devit test (0/1) | | 1 | 1 | 1 | 1 | 1 | 1 | 1 | 1 |

Predicited and calculater properties

| | | | | | | | | | |
|---|---|---|---|---|---|---|---|---|---|
| Pₙ [for n_{d}] | | 2.0713 | 2.0681 | 2.0661 | 2.0588 | 2.1087 | 2.1104 | 2.1139 | 2.1156 |
| P_{d} [for d_{RT}] | g/cm³ | 5.3998 | 5.3187 | 5.4932 | 5.3978 | 5.4191 | 5.4954 | 5.4656 | 5.4293 |
| Pₙ - (1.62 + 0.08 * P_{d}) | | 0.0193 | 0.0226 | 0.0066 | 0.0070 | 0.0552 | 0.0508 | 0.0567 | 0.0613 |
| Pₙ - (1.65 + 0.08 * P_{d}) | | -0.0107 | -0.0074 | -0.0234 | -0.0230 | 0.0252 | 0.0208 | 0.0267 | 0.0313 |

TABLE 6 Continued

| Exemplary Glass | | 33 | 34 | 35 | 36 | 37 | 38 | 39 | 40 |
|---|---|---|---|---|---|---|---|---|---|
| Composition - mol.% | | | | | | | | | |
| B₂O₃ | mol. % | 22.20 | 21.92 | 21.73 | 22.19 | 21.53 | 22.19 | 22.11 | 21.72 |
| TiO₂ | mol. % | 13.79 | 13.84 | 13.89 | 14.22 | 14.20 | 14.86 | 14.54 | 14.56 |
| Nb₂O₅ | mol. % | 16.09 | 16.83 | 17.41 | 15.87 | 15.89 | 15.56 | 15.89 | 15.72 |
| La₂O₃ | mol. % | 18.59 | 17.96 | 17.51 | 18.59 | 18.59 | 18.60 | 18.48 | 18.53 |
| WO₃ | mol. % | 18.99 | 18.36 | 17.91 | 18.99 | 18.99 | 18.99 | 18.81 | 18.92 |
| BaO | mol. % | 0.15 | 0.28 | 0.37 | 0.11 | 0.11 | 0.0376 | 0.0379 | 0.0754 |
| SiO₂ | mol. % | 0.0321 | 0.032 | 0.0318 | 0.0321 | 0.0321 | 0.032 | 0.0322 | 0.0321 |
| Bi₂O₃ | mol. % | 1.75 | 1.81 | 1.82 | 1.75 | 1.75 | 1.75 | 2.13 | 1.75 |
| ZrO₂ | mol. % | 7.00 | 7.03 | 7.05 | 7.00 | 7.53 | 7.00 | 6.99 | 7.22 |
| Y₂O₃ | mol. % | 0.80 | 0.80 | 0.80 | 0.80 | 0.80 | 0.80 | 0.80 | 0.86 |
| Li₂O | mol. % | 0.45 | 0.84 | 1.09 | 0.32 | 0.45 | 0.13 | 0.13 | 0.19 |
| TeO₂ | mol. % | 0 | 0 | 0 | 0 | 0 | 0 | 0 | 0.34 |
| CaO | mol. % | 0.14 | 0.27 | 0.38 | 0.10 | 0.10 | 0.0343 | 0.0345 | 0.0687 |
| Ta₂O₅ | mol. % | 0.0131 | 0.0174 | 0.0173 | 0.0131 | 0.0131 | 0.013 | 0.0131 | 0.0131 |
| Composition constraints | | | | | | | | | |
| B₂O₃ + SiO₂ + P₂O₅ | mol. % | 22.23 | 21.95 | 21.76 | 22.22 | 21.56 | 22.22 | 22.14 | 21.75 |
| TiO₂ + Nb₂O₅ | mol. % | 29.89 | 30.68 | 31.30 | 30.10 | 30.09 | 30.43 | 30.43 | 30.28 |
| R₂O + RO | mol. % | 0.7406 | 1.384 | 1.838 | 0.5383 | 0.6682 | 0.2004 | 0.2020 | 0.3374 |
| B₂O₃ + SiO ₂ | mol. % | 22.23 | 21.95 | 21.76 | 22.22 | 21.56 | 22.22 | 22.14 | 21.75 |
| SiO₂ + B₂O₃ - P₂O₅ | mol. % | 22.23 | 21.95 | 21.76 | 22.22 | 21.56 | 22.22 | 22.14 | 21.75 |

Measured properties

| | | | | | | | | |
|---|---|---|---|---|---|---|---|---|
| n_{d} | | 2.0896 | | | 2.0856 | | | |
| d_{RT} | g/cm3 | 5.452 | | 5.415 | 5.443 | 5.443 | 5.434 | |
| 15-min devit test (0/1) | | 1 | 1 | 1 | | 1 | 1 | 1 |

Predicted and calculated properties

| | | | | | | | | | |
|---|---|---|---|---|---|---|---|---|---|
| Pₙ [for n_{d}] | | 2.1154 | 2.1186 | 2.1208 | 2.1155 | 2.1193 | 2.1156 | 2.1196 | 2.1188 |
| P_{d} [for d_{RT}] | g/cm³ | 5.5353 | 5.5029 | 5.4765 | 5.5328 | 5.5566 | 5.5287 | 5.5512 | 5.5468 |
| Pₙ - (1.62 + 0.08 * P_{d}) | | 0.0526 | 0.0583 | 0.0627 | 0.0529 | 0.0548 | 0.0533 | 0.0555 | 0.0550 |
| Pₙ - (1.65 + 0.08 * P_{d}) | | 0.0226 | 0.0283 | 0.0327 | 0.0229 | 0.0248 | 0.0233 | 0.0255 | 0.0250 |

TABLE 6 Continued

| Exemplary Glass | | 41 | 42 | 43 | 44 | 45 | 46 | 47 | 48 |
|---|---|---|---|---|---|---|---|---|---|
| Composition - mol.% | | | | | | | | | |
| B₂O₃ | mol. % | 21.35 | 21.11 | 13.67 | 22.50 | 22.14 | 24.49 | 21.48 | 32.98 |
| TiO₂ | mol. % | 14.55 | 14.55 | 29.83 | 13.79 | 13.78 | 12.20 | 13.47 | 9.00 |
| Nb₂O₅ | mol. % | 15.72 | 15.72 | 6.80 | 15.69 | 16.09 | 15.11 | 16.69 | 14.99 |
| La₂O₃ | mol. % | 18.48 | 18.59 | 24.02 | 18.70 | 18.64 | 14.76 | 18.56 | 19.99 |
| WO₃ | mol. % | 18.88 | 18.99 | 0 | 19.49 | 18.99 | 16.69 | 18.68 | 13.29 |
| BaO | mol. % | 0.0755 | 0.21 | 0 | 0.75 | 0.50 | 0 | 0.22 | 0 |
| SiO₂ | mol. % | 0.0321 | 0.0321 | 13.41 | 0.0314 | 0.0313 | 0.0333 | 0.0327 | 0.0312 |
| Bi₂O₃ | mol. % | 1.75 | 1.75 | 4.47 | 0.50 | 0.50 | 7.13 | 2.30 | 2.71 |
| ZrO₂ | mol. % | 7.40 | 7.01 | 7.79 | 6.99 | 6.99 | 8.30 | 7.26 | 6.99 |
| Y₂O₃ | mol. % | 0.90 | 0.80 | 0 | 0.80 | 0.80 | 1.27 | 0.80 | 0 |
| Li₂O | mol. % | 0.19 | 0.26 | 0 | 0 | 1.01 | 0 | 0 | 0 |
| TeO₂ | mol. % | 0.59 | 0.75 | 0 | 0 | 0 | 0 | 0.30 | 0 |
| CaO | mol. % | 0.0688 | 0.21 | 0 | 0.74 | 0.50 | 0 | 0.21 | 0 |
| Ta₂O₅ | mol. % | 0.0131 | 0.0131 | 0 | 0.0128 | 0.017 | 0.0136 | 0.0178 | 0.0127 |
| Composition constraints | | | | | | | | | |
| B₂O₃ + SiO₂ + P₂O₅ | mol. % | 21.38 | 21.14 | 27.08 | 22.53 | 22.17 | 24.53 | 21.52 | 33.01 |
| TiO₂ + Nb₂O₅ | mol. % | 30.27 | 30.27 | 36.63 | 29.48 | 29.87 | 27.31 | 30.15 | 24.00 |
| R₂O + RO | mol. % | 0.3378 | 0.6793 | 0 | 1.493 | 2.014 | 0 | 0.4276 | 0 |
| B₂O₃ + SiO ₂ | mol. % | 21.38 | 21.14 | 27.08 | 22.53 | 22.17 | 24.53 | 21.52 | 33.01 |
| SiO₂ + B₂O₃ - P₂O₅ | mol. % | 21.38 | 21.14 | 27.08 | 22.53 | 22.17 | 24.53 | 21.52 | 33.01 |
| Measured properties | | | | | | | | | |
| n_{d} | | | | 2.070 | 2.0718 | 2.0747 | 2.1167 | | |
| d_{RT} | g/cm³ | | | | | | | | 5.252 |
| T_{g} | °C | | | 710 | | | | | |
| Tₓ | °C | | | 811 | | | | | |
| T_{liq} | °C | | | 1240 | | | | | |
| TX₄₆₀_{nm,} % | | | | | 71.400 | 71.450 | | | |
| 15-min devit test (0/1) | | 1 | 1 | | | | 1 | 1 | 1 |
| Predicted and calculated properties | | | | | | | | | |
| Pₙ [for n_{d}] | | 2.1212 | 2.1225 | 2.094 | 2.1024 | 2.1045 | 2.1199 | 2.1277 | 2.0432 |
| P_{d} [for d_{RT}] | g/cm³ | 5.5592 | 5.570 | 5.3687 | 5.4648 | 5.4493 | 5.6567 | 5.6009 | 5.2663 |
| Pₙ - (1.62 + 0.08 * P_{d}) | | 0.0565 | 0.0569 | 0.0445 | 0.0452 | 0.0486 | 0.0473 | 0.0596 | 0.0019 |
| Pₙ - (1.65 + 0.08 * P_{d}) | | 0.0265 | 0.0269 | 0.0145 | 0.0152 | 0.0186 | 0.0173 | 0.0296 | -0.0281 |

TABLE 6 Continued

| Exemplary Glass | | 49 | 50 | 51 | 52 | 53 | 54 | 55 | 56 |
|---|---|---|---|---|---|---|---|---|---|
| Composition - mol.% | | | | | | | | | |
| B₂O₃ | mol.% | 29.24 | 13.69 | 13.69 | 13.68 | 13.67 | 13.68 | 31.18 | 22.18 |
| TiO₂ | mol.% | 11.16 | 27.83 | 25.84 | 31.35 | 30.86 | 30.35 | 10.23 | 14.55 |
| Nb₂O₅ | mol.% | 13.68 | 6.79 | 6.79 | 6.79 | 6.79 | 6.79 | 15.22 | 15.71 |
| La₂O₃ | mol.% | 18.13 | 24.02 | 24.03 | 24.02 | 24.03 | 24.02 | 18.26 | 18.59 |
| WO₃ | mol.% | 17.63 | 0 | 0 | 0 | 0 | 0 | 15.55 | 18.98 |
| BaO | mol.% | 0 | 0 | 0 | 0 | 0 | 0 | 0 | 0.0378 |
| SiO₂ | mol.% | 0.0309 | 13.41 | 13.39 | 13.41 | 13.39 | 13.39 | 0.0309 | 0.0321 |
| Bi₂O₃ | mol.% | 1.97 | 6.47 | 8.47 | 0.50 | 1.00 | 1.50 | 2.11 | 1.94 |
| ZrO₂ | mol.% | 7.25 | 7.79 | 7.79 | 7.79 | 7.79 | 7.79 | 6.99 | 7.00 |
| Y₂O₃ | mol.% | 0.90 | 0 | 0 | 2.47 | 2.47 | 2.47 | 0.41 | 0.80 |
| Li₂O | mol.% | 0 | 0 | 0 | 0 | 0 | 0 | 0 | 0.13 |
| Ca O | mol.% | 0 | 0 | 0 | 0 | 0 | 0 | 0 | 0.0344 |
| Ta₂O₅ | mol.% | 0.0126 | 0 | 0 | 0 | 0 | 0 | 0.0126 | 0.0131 |
| Composition constraints | | | | | | | | | |
| B₂O₃ + SiO₂ + P₂O₅ | mol.% | 29.28 | 27.10 | 27.08 | 27.09 | 27.07 | 27.07 | 31.21 | 22.21 |
| TiO₂ + Nb₂O₅ | mol.% | 24.84 | 34.62 | 32.63 | 38.14 | 37.65 | 37.14 | 25.45 | 30.26 |
| R₂O + RO | mol.% | 0 | 0 | 0 | 0 | 0 | 0 | 0 | 0.2014 |
| B₂₀; + SiO₂ | mol.% | 29.28 | 27.10 | 27.08 | 27.09 | 27.07 | 27.07 | 31.21 | 22.21 |
| SiO₂ + B₂O₃ - P₂O₅ | mol.% | 29.28 | 27.10 | 27.08 | 27.09 | 27.07 | 27.07 | 31.21 | 22.21 |
| Measured properties | | | | | | | | | |
| n_{d} | | | | | 2.0557 | 2.0583 | 2.0605 | | 2.0885 |
| d_{RT} | g/cm3 | | 5.533 | 5.673 | | | | | |
| T_{g} | °C | | 696 | 684 | 740 | | 739 | | |
| Tₓ | °C | | 802 | 783 | | | | | |
| 15-min devit test (0/1) | | 1 | | | | | | 1 | 1 |

Predicted and calculated properties

| | | | | | | | | | |
|---|---|---|---|---|---|---|---|---|---|
| Pₙ [for n_{d}] | | 2.0544 | 2.1036 | 2.1136 | 2.0696 | 2.0722 | 2.0746 | 2.0505 | 2.1172 |
| P_{d} [for d_{RT}] | g/cm3 | 5.326 | 5.5247 | 5.6825 | 5.1301 | 5.1702 | 5.2092 | 5.2408 | 5.5441 |
| Pₙ - (1.62 + 0.08 * P_{d}) | | 0.0084 | 0.0416 | 0.0390 | 0.0392 | 0.0386 | 0.0378 | 0.0112 | 0.0536 |
| Pₙ - (1.65 + 0.08 * P_{d}) | | -0.0216 | 0.0116 | 0.0090 | 0.0092 | 0.0086 | 0.0078 | -0.0188 | 0.0236 |

TABLE 6 Continued

| Exemplary Glass | | 57 | 58 | 59 | 60 | 61 | 62 | 63 | 64 |
|---|---|---|---|---|---|---|---|---|---|
| Compositon - mol.% | | | | | | | | | |
| B₂O₃ | mol.% | 21.87 | 21.77 | 21.63 | 21.50 | 21.46 | 6.86 | 6.55 | 6.27 |
| TiO₂ | mol.% | 14.57 | 14.17 | 14.58 | 14.21 | 13.87 | 4.73 | 7.36 | 9.94 |
| Nb₂O₅ | mol.% | 15.74 | 16.08 | 15.76 | 16.07 | 16.34 | 30.27 | 29.27 | 28.28 |
| La₂O₃ | mol.% | 18.57 | 18.57 | 18.54 | 18.54 | 18.54 | 0 | 0 | 0 |
| WO₃ | mol.% | 18.94 | 18.85 | 18.89 | 18.81 | 18.74 | 0 | 0 | 0 |
| P₂O₅ | mol.% | 0 | 0 | 0 | 0 | 0 | 16.37 | 17.89 | 19.40 |
| BaO | mol.% | 0 | 0.11 | 0 | 0.10 | 0.20 | 18.53 | 19.07 | 19.61 |
| SiO₂ | mol.% | 0.0323 | 0.0324 | 0.0323 | 0.0324 | 0.0325 | 0 | 0 | 0 |
| Bi₂O₃ | mol.% | 2.10 | 2.10 | 2.10 | 2.10 | 2.10 | 4.73 | 4.81 | 4.89 |
| ZrO₂ | mol.% | 7.15 | 7.17 | 7.25 | 7.28 | 7.30 | 0 | 0 | 0 |
| GeO₂ | mol.% | 0 | 0 | 0 | 0 | 0 | 6.22 | 4.33 | 2.46 |
| Na₂O | mol.% | 0 | 0 | 0 | 0 | 0 | 6.21 | 5.92 | 5.64 |
| K₂O | mol.% | 0 | 0 | 0 | 0 | 0 | 5.94 | 4.67 | 3.41 |
| Y₂O₃ | mol.% | 0.80 | 0.80 | 0.80 | 0.80 | 0.80 | 0 | 0 | 0 |
| TeO₂ | mol.% | 0.23 | 0.23 | 0.40 | 0.43 | 0.39 | 0 | 0 | 0 |
| CaO | mol.% | 0 | 0.10 | 0 | 0.10 | 0.21 | 0 | 0 | 0 |
| SrO | mol.% | 0 | 0 | 0 | 0 | 0 | 0.12 | 0.10 | 0.0856 |
| Ta₂O₅ | mol.% | 0.0132 | 0.0132 | 0.0132 | 0.0132 | 0.0132 | 0.0283 | 0.0282 | 0.0281 |
| Composition constraints | | | | | | | | | |
| B₂O₃ + SiO₂ + P₂O₅ | mol.% | 21.90 | 21.80 | 21.67 | 21.53 | 21.49 | 23.23 | 24.44 | 25.66 |
| TiO₂ + Nb₂O₅ | mol.% | 30.31 | 30.25 | 30.34 | 30.28 | 30.21 | 35.00 | 36.63 | 38.22 |
| R₂O + RO | mol.% | 0 | 0.2182 | 0 | 0.2057 | 0.4122 | 30.79 | 29.77 | 28.74 |
| B₂O₃ + SiO₂ | mol.% | 21.90 | 21.80 | 21.67 | 21.53 | 21.49 | 6.860 | 6.549 | 6.265 |
| SiO₂ + B₂O₃ - P₂O₅ | mol.% | 21.90 | 21.80 | 21.67 | 21.53 | 21.49 | -9.509 | -11.34 | -13.13 |
| Measured properties | | | | | | | | | |
| 15-min devit test (0/1) | | 1 | 1 | 1 | 1 | 1 | | | |
| 2.5-min devit test (0/1) | | | | | | | 1 | 1 | 1 |
| Predicted and calculated properties | | | | | | | | | |
| Pₙ [for n_{d}] | | 2.1212 | 2.1227 | 2.1229 | 2.1246 | 2.1253 | 1.9652 | 1.9688 | 1.9723 |
| P_{d} [for d_{RT}] | g/cm3 | 5.5673 | 5.5739 | 5.5749 | 5.5824 | 5.5856 | 4.2534 | 4.2422 | 4.2305 |
| Pₙ - (1.62 + 0.08 * P_{d}) | | 0.0558 | 0.0568 | 0.0569 | 0.0580 | 0.0585 | 0.0050 | 0.0095 | 0.0138 |
| Pₙ - (1.65 + 0.08 * P_{d}) | | 0.0258 | 0.0268 | 0.0269 | 0.0280 | 0.0285 | -0.0250 | -0.0205 | -0.0162 |

TABLE 6 Continued

| Exemplary Glass | | 65 | 66 | 67 | 68 | 69 |
|---|---|---|---|---|---|---|
| Composition — mol.% | | | | | | |
| B₂O₃ | mol.% | 5.83 | 20.16 | 20.13 | 19.83 | 19.95 |
| TiO₂ | mol.% | 13.37 | 12.29 | 13.42 | 12.76 | 12.80 |
| Nb₂O₅ | mol.% | 27.01 | 17.35 | 17.13 | 17.53 | 17.50 |
| La₂O₃ | mol.% | 0 | 20.10 | 19.82 | 20.15 | 20.05 |
| WO₃ | mol.% | 0 | 20.77 | 20.78 | 21.68 | 21.64 |
| P₂O₅ | mol.% | 21.41 | 0 | 0 | 0 | 0 |
| BaO | mol.% | 20.34 | 0.32 | 0.22 | 0.16 | 0.20 |
| SiO₂ | mol.% | 0 | 0.0327 | 0.0324 | 0 | 0 |
| Bi₂O₃ | mol.% | 5.00 | 0.36 | 0.33 | 0.19 | 0.35 |
| ZrO₂ | mol.% | 0 | 8.28 | 7.92 | 7.50 | 7.35 |
| Na₂O | mol.% | 5.21 | 0 | 0 | 0 | 0 |
| K₂O | mol.% | 1.74 | 0 | 0 | 0 | 0 |
| CaO | mol.% | 0 | 0.32 | 0.21 | 0.19 | 0.15 |
| SrO | mol.% | 0.0681 | 0 | 0 | 0 | 0 |
| Ta₂O₅ | mol.% | 0.024 | 0.0178 | 0.0176 | 0 | 0 |
| Composition constraints | | | | | | |
| B₂O₃ + SiO₂ + P₂O₅ | mol.% | 27.24 | 20.19 | 20.16 | 19.83 | 19.95 |
| TiO₂ + Nb₂O₅ | mol.% | 40.38 | 29.64 | 30.54 | 30.30 | 30.30 |
| R₂O + RO | mol.% | 27.36 | 0.6351 | 0.4246 | 0.3536 | 0.3503 |
| B₂O₃ + SiO₂ | mol.% | 5.830 | 20.19 | 20.16 | 19.83 | 19.95 |
| SiO₂ + B₂O₃ - P₂O₅ | mol.% | -15.58 | 20.19 | 20.16 | 19.83 | 19.95 |
| Measued properties | | | | | | |
| 15-min devit test (0/1) | | | 1 | 1 | 1 | 1 |
| 2.5-min devit test (0/1) | | 1 | | | | |
| Predicted and calculated properties | | | | | | |
| Pₙ [for n_{d}] | | 1.9775 | 2.1292 | 2.1296 | 2.1332 | 2.1331 |
| P_{d} [for d_{RT}] | g/cm³ | 4.2173 | 5.6235 | 5.5948 | 5.6291 | 5.6306 |
| Pₙ - (1.62 + 0.08 * P_{d}) | | 0.0201 | 0.0593 | 0.0620 | 0.0628 | 0.0627 |
| Pₙ - (1.65 + 0.08 * P_{d}) | | -0.0099 | 0.0293 | 0.0320 | 0.0328 | 0.0327 |

Table 7 below lists the glass compositions and properties for the Glasses A1-A20.

TABLE 7

Compositions and Properties of Additional Exemplary Glasses

| Comparative Examples | | A1 | A2 | A3 | A4 | A5 | A6 | A7 | A8 |
|---|---|---|---|---|---|---|---|---|---|
| Composition - mol.% | | | | | | | | | |
| SiO₂ | mol.% | 4.83 | 4.82 | 4.82 | 4.81 | 4.82 | 4.82 | 4.82 | 4.82 |
| La₂O₃ | mol.% | 23.72 | 23.72 | 23.72 | 23.73 | 23.72 | 23.73 | 23.73 | 23.72 |
| TiO₂ | mol.% | 30.41 | 30.44 | 30.43 | 30.44 | 30.43 | 30.42 | 30.42 | 30.43 |
| Nb₂O₅ | mol.% | 7.44 | 7.44 | 7.44 | 7.44 | 7.44 | 7.44 | 7.44 | 7.44 |
| B₂O₃ | mol.% | 21.25 | 21.24 | 21.25 | 21.25 | 21.23 | 21.24 | 21.24 | 21.24 |
| Y₂O₃ | mol.% | 5.13 | 5.13 | 5.13 | 5.13 | 5.14 | 5.13 | 5.13 | 5.13 |
| ZrO₂ | mol.% | 6.80 | 6.80 | 6.80 | 6.80 | 6.80 | 6.80 | 6.80 | 6.80 |
| K₂O | mol.% | 0.39 | 0.27 | 0.19 | 0.10 | 0 | 0.38 | 0.27 | 0.18 |
| Ta₂O₅ | mol.% | 0.0072 | 0.0072 | 0.0072 | 0.0073 | 0.0073 | 0.0069 | 0.0072 | 0.0069 |
| Na₂O | mol.% | 0.0257 | 0.0258 | 0.0258 | 0.0259 | 0.026 | 0.0129 | 0.0258 | 0.0129 |
| Bi₂O₃ | mol.% | 0 | 0.11 | 0.19 | 0.28 | 0.38 | 0 | 0.12 | 0.20 |
| KCl | mol.% | 0 | 0 | 0 | 0 | 0 | 0.009 | 0 | 0.009 |
| MgO | mol.% | 0 | 0 | 0 | 0 | 0 | 0.004 | 0 | 0.004 |
| Al₂O₃ | mol.% | 0 | 0 | 0 | 0 | 0 | 0.0031 | 0 | 0.0031 |
| Fe₂O₃ | mol.% | 0 | 0 | 0 | 0 | 0 | 0.001 | 0 | 0.001 |
| Composition constraints | | | | | | | | | |
| B₂O₃ + SiO₂ + P₂O₅ | mol.% | 26.08 | 26.06 | 26.07 | 26.06 | 26.05 | 26.06 | 26.06 | 26.06 |
| TiO₂ + Nb₂O₅ | mol.% | 37.85 | 37.88 | 37.87 | 37.87 | 37.87 | 37.86 | 37.86 | 37.88 |
| R₂O + RO | mol.% | 0.4149 | 0.2973 | 0.2128 | 0.1281 | 0.02595 | 0.4012 | 0.2974 | 0.2021 |
| B₂O₃ + SiO₂ | mol.% | 26.08 | 26.06 | 26.07 | 26.06 | 26.05 | 26.06 | 26.06 | 26.06 |
| SiO₂ + B₂O₃ - P₂O₅ | mol.% | 26.08 | 26.06 | 26.07 | 26.06 | 26.05 | 26.06 | 26.06 | 26.06 |
| Predicted and calculated properties | | | | | | | | | |
| Pₙ [for n_{d}] | | 2.064 | 2.066 | 2.067 | 2.068 | 2.069 | 2.064 | 2.066 | 2.067 |
| P_{d} [for d_{RT}] | g/cm³ | 5.104 | 5.114 | 5.121 | 5.130 | 5.139 | 5.105 | 5.115 | 5.122 |
| n_{d} - (1.62 + 0.08 * d_{RT}) | | 0.0356 | 0.0365 | 0.0370 | 0.0376 | 0.0383 | 0.0357 | 0.0365 | 0.0371 |
| n_{d} - (1.65 + 0.08 * d_{RT}) | | 0.0056 | 0.0065 | 0.0070 | 0.0076 | 0.0083 | 0.0057 | 0.0065 | 0.0071 |

TABLE 7 Continued

| Comparative Examples | | A9 | A10 | A11 | A12 | A13 | A14 | A15 | A16 |
|---|---|---|---|---|---|---|---|---|---|
| Composition — mol.% | | | | | | | | | |
| SiO₂ | mol.% | 4.82 | 4.82 | 5.43 | 5.09 | 4.82 | 4.57 | 4.22 | 0 |
| La₂O₃ | mol.% | 23.72 | 23.72 | 23.86 | 23.78 | 23.72 | 23.67 | 23.60 | 20.50 |
| TiO₂ | mol.% | 30.43 | 30.43 | 31.07 | 30.70 | 30.43 | 30.15 | 29.79 | 12.00 |
| Nb₂O₅ | mol.% | 7.44 | 7.44 | 7.06 | 7.28 | 7.44 | 7.60 | 7.81 | 18.00 |
| B₂O₃ | mol.% | 21.24 | 21.23 | 20.41 | 20.89 | 21.23 | 21.58 | 22.05 | 19.50 |
| Y₂O₃ | mol.% | 5.13 | 5.14 | 5.34 | 5.22 | 5.14 | 5.04 | 4.93 | 0 |
| ZrO₂ | mol.% | 6.80 | 6.80 | 6.80 | 6.80 | 6.80 | 6.81 | 6.80 | 7.00 |
| K₂O | mol.% | 0.10 | 0 | 0 | 0 | 0 | 0 | 0 | 0 |
| Ta₂O₅ | mol.% | 0.0069 | 0.0073 | 0.0072 | 0.0072 | 0.0073 | 0.0073 | 0.0074 | 0 |
| Na₂O | mol.% | 0.0129 | 0.026 | 0.0257 | 0.0258 | 0.026 | 0.0261 | 0.0262 | 0 |
| Bi₂O₃ | mol.% | 0.28 | 0.38 | 0 | 0.22 | 0.38 | 0.54 | 0.76 | 0 |
| KCl | mol.% | 0.0091 | 0 | 0 | 0 | 0 | 0 | 0 | 0 |
| MgO | mol.% | 0.004 | 0 | 0 | 0 | 0 | 0 | 0 | 0 |
| Al₂O₃ | mol.% | 0.0031 | 0 | 0 | 0 | 0 | 0 | 0 | 0 |
| Fe₂O₃ | mol.% | 0.001 | 0 | 0 | 0 | 0 | 0 | 0 | 0 |
| WO₃ | mol.% | 0 | 0 | 0 | 0 | 0 | 0 | 0 | 22.70 |
| CaO | mol.% | 0 | 0 | 0 | 0 | 0 | 0 | 0 | 0.30 |
| Composition constraints | | | | | | | | | |
| B₂O₃ + SiO₂ + P₂O₅ | mol.% | 26.06 | 26.05 | 25.84 | 25.98 | 26.05 | 26.15 | 26.27 | 19.50 |
| TiO₂ + Nb₂O₅ | mol.% | 37.87 | 37.87 | 38.12 | 37.98 | 37.87 | 37.75 | 37.60 | 30.00 |
| R₂O + RO | mol.% | 0.1225 | 0.02595 | 0.02570 | 0.02584 | 0.02595 | 0.02607 | 0.02621 | 0.3000 |
| B₂O₃ + SiO₂ | mol.% | 26.06 | 26.05 | 25.84 | 25.98 | 26.05 | 26.15 | 26.27 | 19.50 |
| SiO₂ + B₂O₃ - P₂O₅ | mol.% | 26.06 | 26.05 | 25.84 | 25.98 | 26.05 | 26.15 | 26.27 | 19.50 |
| Predicted and calculated properties | | | | | | | | | |
| Pₙ [for n_{d}] | | 2.068 | 2.069 | 2.068 | 2.069 | 2.069 | 2.070 | 2.071 | 2.137 |
| P_{d} [for d_{RT}] | g/cm³ | 5.129 | 5.139 | 5.127 | 5.133 | 5.139 | 5.144 | 5.152 | 5.662 |
| n_{d} - (1.62 + 0.08 * d_{RT}) | | 0.0376 | 0.0383 | 0.0376 | 0.0380 | 0.0383 | 0.0385 | 0.0388 | 0.0637 |
| n_{d} - (1.65 + 0.08 * d_{RT}) | | 0.0076 | 0.0083 | 0.0076 | 0.0080 | 0.0083 | 0.0085 | 0.0088 | 0.0337 |

TABLE 7 Continued

| Comparative Examples | | A17 | A18 | A19 | A20 |
|---|---|---|---|---|---|
| Composition — mol.% | | | | | |
| La₂O₃ | mol.% | 20.24 | 20.05 | 19.86 | 19.60 |
| TiO₂ | mol.% | 12.46 | 12.80 | 13.14 | 13.60 |
| Nb₂O₅ | mol.% | 17.71 | 17.50 | 17.28 | 17.00 |
| B₂O₃ | mol.% | 19.76 | 19.95 | 20.14 | 20.40 |
| ZrO₂ | mol.% | 7.20 | 7.35 | 7.50 | 7.70 |
| Bi₂O₃ | mol.% | 0.20 | 0.35 | 0.50 | 0.70 |
| WO₃ | mol.% | 22.09 | 21.64 | 21.20 | 20.60 |
| CaO | mol.% | 0.21 | 0.15 | 0.0855 | 0 |
| BaO | mol.% | 0.12 | 0.20 | 0.29 | 0.40 |

Composition constraints

| B₂O₃ + SiO₂ + P₂O₅ | mol.% | 19.76 | 19.95 | 20.14 | 20.40 |
|---|---|---|---|---|---|
| TiO₂ + Nb₂O₅ | mol.% | 30.17 | 30.30 | 30.42 | 30.60 |
| R₂O + RO | mol.% | 0.3290 | 0.3503 | 0.3715 | 0.3999 |
| B₂O₃ + SiO₂ | mol.% | 19.76 | 19.95 | 20.14 | 20.40 |
| SiO₂ + B₂O₃ - P₂O₅ | mol.% | 19.76 | 19.95 | 20.14 | 20.40 |
| Predicted and calculated properties | | | | | |
| Pₙ [for n_{d}] | | 2.135 | 2.133 | 2.132 | 2.130 |
| P_{d} [for d_{RT}] | g/cm³ | 5.644 | 5.631 | 5.618 | 5.599 |
| n_{d} - (1.62 + 0.08 * d_{RT}) | | 0.0631 | 0.0627 | 0.0622 | 0.0616 |
| n_{d} - (1.65 + 0.08 * d_{RT}) | | 0.0331 | 0.0327 | 0.0322 | 0.0316 |

Table 8 below lists the glass compositions and properties for Comparative Glasses C1-C11.

TABLE 8

Compositions and Properties of Comparative Example Glasses

| Comparative Examples | | C1 | C2 | C3 | C4 | C5 | C6 | C7 | C8 |
|---|---|---|---|---|---|---|---|---|---|
| Reference | | [5] | [3] | [5] | [1] | [4] | [2] | [6] | [5] |
| Composition - mol.% | | | | | | | | | |
| BaO | mol.% | 16.61 | 0 | 21.34 | 21.34 | 2.20 | 0 | 1.00 | 18.88 |
| TiO₂ | mol.% | 30.55 | 16.98 | 37.00 | 37.00 | 21.08 | 16.97 | 6.90 | 16.09 |
| La₂O₃ | mol.% | 6.84 | 19.97 | 3.89 | 3.89 | 22.74 | 21.67 | 0 | 8.53 |
| SiO₂ | mol.% | 26.49 | 3.57 | 22.49 | 22.49 | 18.22 | 8.92 | 0 | 36.62 |
| B₂O₃ | mol.% | 7.77 | 28.46 | 3.03 | 3.03 | 10.88 | 28.51 | 3.00 | 8.32 |
| Na₂O | mol.% | 6.85 | 0 | 1.70 | 1.70 | 0 | 0 | 10.89 | 3.74 |
| Nb₂O₅ | mol.% | 1.40 | 4.43 | 1.59 | 1.59 | 5.77 | 7.19 | 17.90 | 3.92 |
| ZrO₂ | mol.% | 2.58 | 6.99 | 5.14 | 5.14 | 8.88 | 7.13 | 0 | 1.88 |
| Bi₂O₃ | mol.% | 0.0911 | 4.68 | 0.18 | 0.18 | 0.54 | 6.01 | 7.90 | 0.20 |
| Y₂O₃ | mol.% | 0.14 | 0 | 0.0467 | 0.0467 | 7.23 | 0 | 0 | 0 |
| ZnO | mol.% | 0.39 | 0 | 0.13 | 0.13 | 0 | 0 | 0 | 0 |
| Gd₂O₃ | mol.% | 0.0293 | 0 | 0 | 0 | 0 | 0 | 0 | 0.22 |
| WO₃ | mol.% | 0.0458 | 14.76 | 0.0911 | 0.0911 | 0 | 3.44 | 7.80 | 0.0999 |
| Sb₂O₃ | mol.% | 0.0364 | 0 | 0.0362 | 0.0362 | 0 | 0 | 0 | 0.12 |
| CaO | mol.% | 0.19 | 0.0316 | 0.38 | 0.38 | 0 | 0.031 | 0 | 0.41 |
| CeO₂ | mol.% | 0 | 0.12 | 0 | 0 | 0 | 0.13 | 0 | 0 |
| Ta₂O₅ | mol.% | 0 | 0.004 | 0 | 0 | 2.29 | 0.0079 | 0 | 0.0262 |
| K₂O | mol.% | 0 | 0 | 0.67 | 0.67 | 0 | 0 | 2.00 | 0 |
| MgO | mol.% | 0 | 0 | 1.05 | 1.05 | 0 | 0 | 0 | 0 |
| Yb₂O₃ | mol.% | 0 | 0 | 0.0804 | 0.0804 | 0 | 0 | 0 | 0 |
| Li₂O | mol.% | 0 | 0 | 1.06 | 1.06 | 0 | 0 | 17.81 | 0.39 |
| SrO | mol.% | 0 | 0 | 0.10 | 0.10 | 0 | 0 | 0 | 0.56 |
| As₂O₃ | mol.% | 0 | 0 | 0 | 0 | 0.17 | 0 | 0 | 0 |
| P₂O₅ | mol.% | 0 | 0 | 0 | 0 | 0 | 0 | 24.80 | 0 |
| n_{d} | | 1.892 | | 1.871 | 1.871 | 2.011 | | 1.9005 | 1.8999 |
| d_{RT} | g/cm³ | 4.250 | | 4.210 | 4.210 | 5.050 | | 4.200 | 4.260 |
| T_{g} | °C | 701.00 | | 688.00 | 688.00 | | | 466.00 | 702.00 |
| T_{liq} | °C | 1180.0 | | 11720 | 1172.0 | | | 890.00 | 1190.0 |
| Pₙ [for n_{d}] | | 1.892 | 2.017 | 1.954 | 1.954 | 2.025 | 2.012 | 1.872 | 1.837 |
| P_{d} [for d_{RT}] | g/cm³ | 4.210 | 5.399 | 4.399 | 4.399 | 5.272 | 5.218 | 3.975 | 4.263 |

TABLE 8 Continued

| Comparaitive Examples | | C9 | C10 | C11 |
|---|---|---|---|---|
| Reference | | [1] | [6] | [6] |
| Composition- mol.% | | | | |
| BaO | mol.% | 18.88 | 1.01 | 1.00 |
| TiO₂ | mol.% | 16.09 | 7.00 | 6.90 |
| La₂O₃ | mol.% | 8.53 | 0 | 0 |
| SiO₂ | mol.% | 36.62 | 0 | 0 |
| B₂O₃ | mol.% | 8.32 | 2.00 | 2.90 |
| Na₂O | mol.% | 3.74 | 10.49 | 10.80 |
| Nb₂O₅ | mol.% | 3.92 | 18.00 | 16.80 |
| ZrO₂ | mol.% | 1.88 | 0 | 0 |
| Bi₂O₃ | mol.% | 0.20 | 8.00 | 7.90 |
| Gd₂O₃ | mol.% | 0.22 | 0 | 0 |
| WO₃ | mol.% | 0.099 | 8.00 | 9.50 |
| Sb₂O₃ | mol.% | 0.12 | 0 | 0 |
| CaO | mol.% | 0.41 | 0 | 0 |
| Ta₂O₅ | mol.% | 0.0262 | 0 | 0 |
| K₂O | mol.% | 0 | 2.00 | 2.00 |
| Li₂O | mol.% | 0.39 | 18.01 | 17.70 |
| SrO | mol.% | 0.56 | 0 | 0 |
| P₂O₅ | mol.% | 0 | 25.49 | 24.50 |
| Measured properties | | | | |
| n_{d} | | 1.8999 | 1.9021 | 1.8991 |
| d_{RT} | g/cm³ | 4.260 | 4.220 | 4.240 |
| T_{g} | °C | 702.00 | 470.00 | 464.00 |
| T_{liq} | °C | 1190.0 | 890.00 | 880.00 |
| Predicted and calculated properties | | | | |
| Pₙ [for n_{d}] | | 1.837 | 1.875 | 1.871 |
| P_{d} [for d_{RT}] | g/cm³ | 4.263 | 3.991 | 4.027 |

The reference key for each of the Comparative Glasses listed in Table 8 is as follows: [1] CN111285601A; [2] US20220073410A1; [3] U.S. Pat. Application Serial No. 17/683,527 (filed Mar. 1, 2022); [4] US4584279A; [5] WO2020114255A1; [6] JP2006111499A.

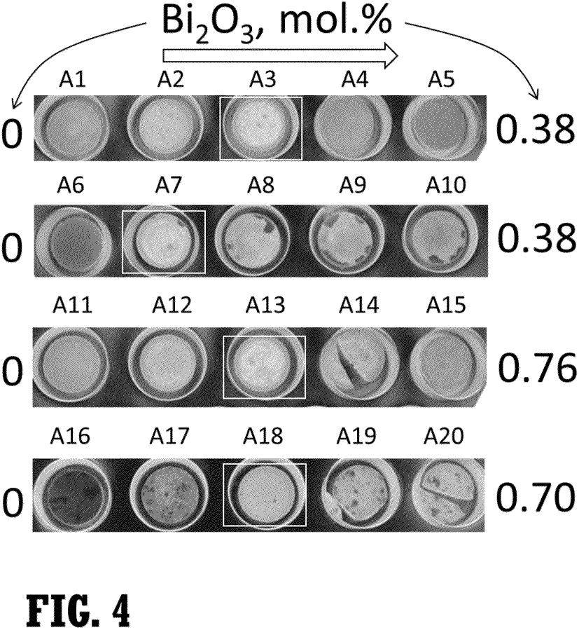

For the compositions A1 to A20 (Table 7), the melting time employed was insufficient to achieve complete homogenization at the melting temperature employed. The appearance of the samples after melting at the time and temperature employed, however, is indicative of the of homogenization and ease of melting. The higher the transmittance of the sample, the greater the fraction of vitreous phase in the sample. A higher vitreous phase fraction indicates more complete melting and better homogeneity. In the images depicted in FIG. 4, a white appearance corresponds to higher transmittance and signifies a greater ease of melting. Dark regions correspond to poorly melted and more inhomogeneous portions of the glass sample.

FIG. 4 presents three series of gradually varying compositions: A1 to A5, A6 to A10, A11 to A15, and A16 to A20. In each series, the content of Bi₂O₃ was gradually increased from 0 (at the left side of the series of images) to a maximum value (at the right side of the series of images). The maximum value varies from 0.38 to 0.76 mol.% Bi₂O₃. Exact compositions of all glasses are presented in Table 7.

In each series, the sample with highest transmittance (sample with lightest appearance) is highlighted. The highlighted samples correspond to the Additional Exemplary Glasses A3 (0.19 mol.% Bi₂O₃), A7 (0.12 mol.% Bi₂O₃), A13 (0.38 mol.% Bi₂O₃) and A18 (0.35 mol.% Bi₂O₃) in Table 7. All of these samples have an intermediate concentration of Bi₂O₃ within its series. The results depicted in FIG. 4 indicate that meltability and homogeneity are improved upon controlled addition of Bi₂O₃ to the melt. If the content of Bi₂O₃ is too high or too low, uniformity in melting and homogeneity is difficult to achieve. The results indicate that even small amounts of Bi₂O₃ (e.g. from about 0.1 mol.% to 0.4 mol.%) unexpectedly improve the meltability of the glass composition.

As follows from the FIG. 4, the specific content of Bi₂O₃ that most improves meltability depends on the base glass composition to which Bi₂O₃ is added. In other words, the specific amount of Bi₂O₃ that optimizes the meltability of glasses may vary within the different composition spaces of the present disclosure.

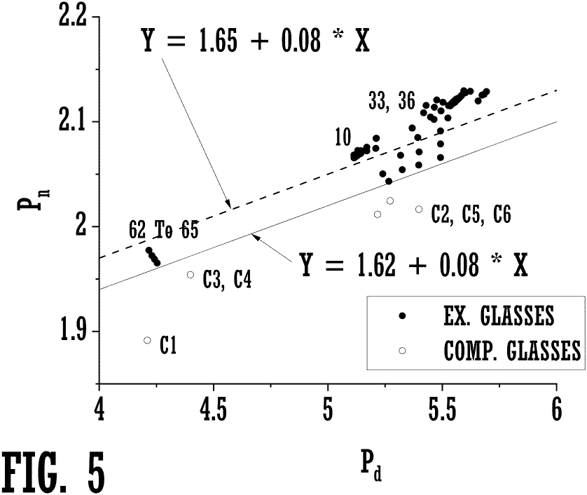

FIG. 5 is a plot showing the relationship between the parameter that predicts density at room temperature P_{d} and the parameter that predicts refractive index at 587.56 nm Pₙ for some of the Exemplary Glasses and some of the Comparative Glasses. The Exemplary Glasses (filled circles) are the Examples 1 to 11, 13 to 15, 18, 19, 22 to 50 and 52 to 67 from Table 6. The Comparative Glasses (open circles) are the Examples C1 to C6 from Table 8. The parameter P_{d} that predicts density at room temperature was determined according to Formula (II). The parameter Pₙ that predicts refractive index at 587.56 nm was determined according to Formula (I). All of the Exemplary Glasses and Comparative Glasses shown in FIG. 5 have the features specified in Table 9.

TABLE 9

Limitations for glass compositions shown in FIG. 5

| Component | Unit | Min | Max |
|---|---|---|---|
| B₂O₃ | mol.% | 1 | 40 |
| TiO₂ | mol.% | 0.5 | 45 |
| SiO₂ | mol.% | 0 | 40 |
| P₂O₅ | mol.% | 0 | 40 |
| WO₃ | mol.% | 0 | 40 |
| Nb₂O₅ | mol.% | 0 | 40 |
| La₂O₃ | mol.% | 0 | 40 |
| TeO₂ | mol.% | 0 | 15 |
| GeO₂ | mol.% | 0 | 15 |
| Bi₂O₃ | mol.% | 0.05 | 8 |
| PbO | mol.% | 0 | 10 |
| Ga₂O₃ | mol.% | 0 | 5 |
| P_{d} | g/cm³ | 4.2 | 6 |

The Comparative Glasses of FIG. 5 were selected as having the highest value of the parameter Pₙ over the range of values of the parameter P_{d} shown in FIG. 5 among the known glasses that have the features specified in Table 9.

The line corresponding to the formula y = 1.62 + 0.08 * x shown in FIG. 5 provides a visual representation of the differences between the Comparative Glasses having the features specified in Table 9 and the Exemplary Glasses 1 to 11, 13 to 15, 18, 19, 22 to 50 and 52 to 67. As can be seen in FIG. 5, the mentioned Exemplary Glasses (filled circles) and none of the Comparative Glasses (open circles) represented in FIG. 5 fall above the line y = 1.62 + 0.08 * x, where y corresponds to the parameter that predicts refractive index at 587.56 nm Pₙ and x corresponds to the parameter that predicts density at room temperature P_{d}. In other words, some of the Exemplary Glasses and none of the Comparative Glasses represented in FIG. 5 satisfy the following formula (III)(a):

$${\text{P}}_{\text{n}} \text{-} \left(1.62 + 0.08 \text{*} {\text{P}}_{\text{d}}\right) > 0.00 \qquad \text{(III)(a)}$$

As can also be seen in FIG. 5, some of Exemplary Glasses and none of the Comparative Glasses represented in FIG. 5 fall above the line y = 1.65 + 0.08 * x, where y corresponds to the parameter that predicts refractive index at 587.56 nm Pₙ and x corresponds to the parameter that predicts density at room temperature P_{d}. In other words, some of the Exemplary Glasses and none of the Comparative Glasses represented in FIG. 5 satisfy the following formula (III)(b):

$${\text{P}}_{\text{n}} \text{-} \left(1.65 + 0.08 \text{*} {\text{P}}_{\text{d}}\right) > 0.00 \qquad \text{(III)(b)}$$

The Exemplary Examples represented in FIG. 5 are, by prediction, superior in terms of the combination of d_{RT} and n_{d} to the best known Comparative Glasses that have the features specified in Table 9.

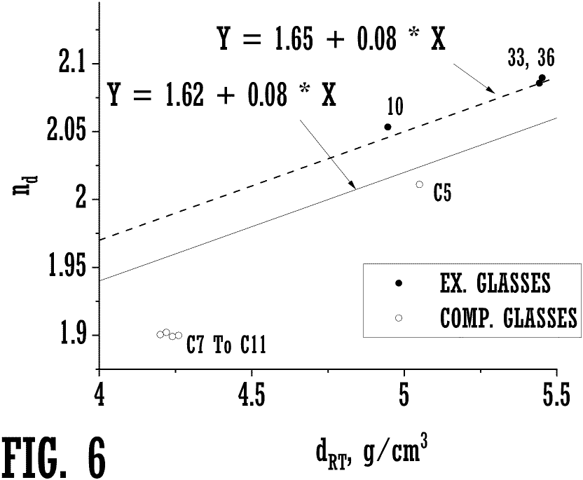

FIG. 6 is a plot showing the relationship between the density at room temperature d_{RT} and the refractive index at 587.56 nm n_{d} for some of the Exemplary Glasses and some of the Comparative Glasses. The Exemplary Glasses (filled circles) are the Examples 10, 33 and 36 from Table 6. The Comparative Glasses (open circles) are the Examples C5 and C7 to C11 from Table 8. All of the Exemplary Glasses and Comparative Glasses shown in FIG. 6 have the features specified in Table 10.

TABLE 10

Limitations for glass compositions shown in FIG. 6

| Component | Unit | Min | Max |
|---|---|---|---|
| B₂O₃ | mol.% | 1 | 40 |
| TiO₂ | mol.% | 0.5 | 45 |
| SiO₂ | mol.% | 0 | 40 |
| P₂O₅ | mol.% | 0 | 40 |
| WO₃ | mol.% | 0 | 40 |
| Nb₂O₅ | mol.% | 0 | 40 |
| La₂O₃ | mol.% | 0 | 40 |
| TeO₂ | mol.% | 0 | 15 |
| GeO₂ | mol.% | 0 | 15 |
| Bi₂O₃ | mol.% | 0.05 | 8 |
| PbO | mol.% | 0 | 10 |
| Ga₂O₃ | mol.% | 0 | 5 |
| d_{RT} | g/cm³ | 4.2 | 6 |

The Comparative Glasses of FIG. 6 were selected as having the highest measured values of the refractive index at 587.56 nm n_{d} over the range of measured density at room temperature d_{RT} shown in FIG. 6 among the known glasses that have the mentioned features specified in Table 10.

The line corresponding to the formula y = 1.62 + 0.08 * x shown in FIG. 6 provides a visual representation of the differences between the Comparative Glasses having the features specified in Table 10 and the Exemplary Glasses 10, 33 and 36. As can be seen in FIG. 6, the mentioned Exemplary Glasses (filled circles) and none of the Comparative Glasses (open circles) represented in FIG. 6 fall above the line y = 1.62 + 0.08 * x, where y corresponds to n_{d} and x corresponds to d_{RT}. In other words, some of the Exemplary Glasses and none of the Comparative Glasses represented in FIG. 6 satisfy the following formula (IV)(a):

$${\text{n}}_{\text{d}} \text{-} \left(1.62 + 0.08 \text{*} {\text{d}}_{\text{RT}}\right) > 0.00 \qquad \text{(IV)(a)}$$

As can also be seen in FIG. 6, some of the Exemplary Glasses and none of the Comparative Glasses represented in FIG. 6 fall above the line y = 1.65 + 0.08 * x, where y corresponds to n_{d} and x corresponds to d_{RT}. In other words, some of the Exemplary Glasses and none of the Comparative Glasses represented in FIG. 6 satisfy the following formula (IV)(b):

$${\text{n}}_{\text{d}} \text{-} \left(1.65 + 0.08 \text{*} {\text{d}}_{\text{RT}}\right) > 0.00 \qquad \text{(IV)(b)}$$

The Exemplary Examples represented in FIG. 6 that satisfy the formula (IV)(b) are characterized by the highest values of n_{d} at a given value of d_{RT} among the glasses that have the features specified in Table 10.

This means that, under the conditions specified in Table 10 above, some of the Exemplary Glasses have higher measured values of the refractive index at 587.56 nm n_{d} at comparable measured values of the density at room temperature d_{RT} than the best of the Comparative Glasses satisfying the same conditions. This can be interpreted as these Exemplary Glasses, according to measurements, have higher values of n_{d} at comparable values of d_{RT} among the glasses, i.e. they are, according to measurement, superior in terms of a combination of d_{RT} and n_{d} (i.e. lower d_{RT} for a given n_{d} or higher n_{d} for a given d_{RT}) to the best known Comparative Glasses that have the features specified in Table 10.

The values of all attributes specified in Tables 9 and 10 and Formulas (III)(a), (III)(b), (IV)(a) and (IV)(b) for the Comparative Glasses C1 to C11 plotted in FIGS. 5 and 6 are presented in Table 11 below. Full compositions of the Comparative Glasses are presented in Table 8. Full compositions and attributes of the Exemplary Glasses are presented in Table 6.

TABLE 11

Attributes of Comparative Example Glasses Having the Features Specified in Tables 9 and 10

| Ex. # | | C1 | C2 | C3 | C4 | C5 | C6 | C7 | C8 |
|---|---|---|---|---|---|---|---|---|---|
| Composition | | | | | | | | | |
| TiO₂ | mol.% | 30.55 | 16.98 | 37.00 | 37.00 | 21.08 | 16.97 | 6.90 | 16.09 |
| SiO₂ | mol.% | 26.49 | 3.57 | 22.49 | 22.49 | 18.22 | 8.92 | 0 | 36.62 |
| P₂O₅ | mol.% | 0 | 0 | 0 | 0 | 0 | 0 | 24.80 | 0 |
| WO₃ | mol.% | 0.0458 | 14.76 | 0.0911 | 0.0911 | 0 | 3.44 | 7.80 | 0.0999 |
| Nb₂O₅ | mol.% | 1.40 | 4.43 | 1.59 | 1.59 | 5.76 | 7.19 | 17.90 | 3.92 |
| La₂O₃ | mol.% | 6.84 | 19.97 | 3.89 | 3.89 | 22.74 | 21.67 | 0 | 8.53 |
| TeO₂ | mol.% | 0 | 0 | 0 | 0 | 0 | 0 | 0 | 0 |
| GeO₂ | mol.% | 0 | 0 | 0 | 0 | 0 | 0 | 0 | 0 |
| Bi₂O₃ | mol.% | 0.0911 | 4.68 | 0.18 | 0.18 | 0.54 | 6.01 | 7.90 | 0.20 |
| PbO | mol.% | 0 | 0 | 0 | 0 | 0 | 0 | 0 | 0 |
| Ga₂O₃ | mol.% | 0 | 0 | 0 | 0 | 0 | 0 | 0 | 0 |
| Measured properties | | | | | | | | | |
| d_{RT} | g/cm³ | | | | | 5.050 | | 4.200 | 4.260 |
| n_{d} | | | | | | 2.011 | | 1.9005 | 1.8999 |
| n_{d} - (1.62 + 0.08 * d_{RT}) | | | | | | -0.013 | | -0.0555 | -0.0609 |
| n_{d} - (1.65 + 0.08 * d_{RT}) | | | | | | -0.043 | | -0.0855 | -0.0909 |
| Predicted and calculated properties | | | | | | | | | |
| P_{d} | g/cm³ | 4.2104 | 5.398 | 4.3989 | 4.3989 | 5.2719 | 5.2171 | 3.9754 | 4.2628 |
| Pₙ | | 1.8915 | 2.0165 | 1.9542 | 1.9542 | 2.0246 | 2.0117 | 1.8724 | 1.8365 |
| Pₙ - (1.62 + 0.08 * P_{d}) | | -0.0653 | -0.0354 | -0.0177 | -0.0177 | -0.0172 | -0.0257 | -0.0656 | -0.1245 |
| Pₙ - (1.65 + 0.08 * P_{d}) | | -0.0953 | -0.0654 | -0.0477 | -0.0477 | -0.0472 | -0.0557 | -0.0956 | -0.1545 |

TABLE 11 Continued

| Ex. # | | C9 | C10 | C11 |
|---|---|---|---|---|
| Composition | | | | |
| TiO₂ | mol.% | 16.09 | 7.00 | 6.90 |
| SiO₂ | mol.% | 36.62 | 0 | 0 |
| P₂O₅ | mol.% | 0 | 25.50 | 24.50 |
| WO₃ | mol.% | 0.0999 | 8.00 | 9.50 |
| Nb₂O₅ | mol.% | 3.92 | 18.00 | 16.80 |
| La₂O₃ | mol.% | 8.53 | 0 | 0 |
| TeO₂ | mol.% | 0 | 0 | 0 |
| GeO₂ | mol.% | 0 | 0 | 0 |
| Bi₂O₃ | mol.% | 0.20 | 8.00 | 7.90 |
| PbO | mol.% | 0 | 0 | 0 |
| Ga₂O₃ | mol.% | 0 | 0 | 0 |
| Measured properties | | | | |
| d_{RT} | g/cm³ | 4.260 | 4.220 | 4.240 |
| n_{d} | | 1.8999 | 1.9021 | 1.8991 |
| n_{d} - (1.62 + 0.08 * d_{RT}) | | -0.0609 | -0.0555 | -0.0601 |
| n_{d} - (1.65 + 0.08 * d_{RT}) | | -0.0909 | -0.0855 | -0.0901 |
| Predicted and calculated properties | | | | |
| P_{d} | g/cm³ | 4.2628 | 3.9908 | 4.0275 |
| Pₙ | | 1.8365 | 1.8751 | 1.8708 |
| Pₙ - (1.62 + 0.08 * P_{d}) | | -0.1245 | -0.0642 | -0.0714 |
| Pₙ - (1.65 + 0.08 * P_{d}) | | -0.1545 | -0.0942 | -0.1014 |

As follows from FIGS. 5 and 6, both predicted and measured property data confirms that some of the Exemplary Glasses have better combination of density at room temperature d_{RT} and refractive index at 587.56 nm n_{d} than the best of the Comparative Glasses that have the features specified in Tables 9 and 10 accordingly.

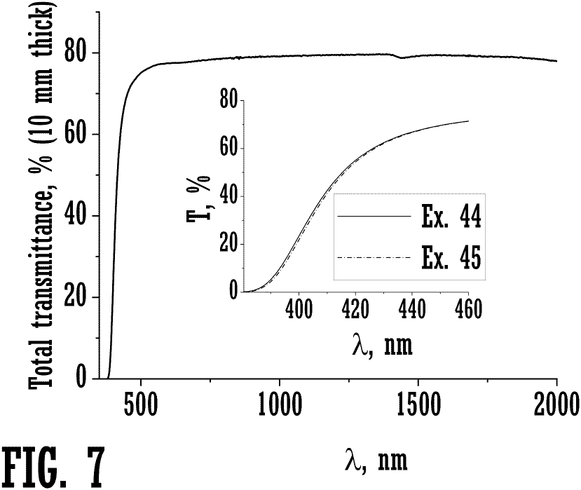

In FIG. 7, total transmittance is presented as a function of the wavelength for the Exemplary Glasses 44 and 45. 2500 grams of each glass were melted in a platinum crucible at a temperature of 1250° C. for 2 hours, further held at 1150° C. for an additional 2 hours, then poured on a steel plate to form samples of 15-20 mm thickness that were then held at 635° C. for 7-12 days. The data presented in the FIG. 7 refer to the total transmittance of the polished samples of 10.0±0.1 mm thickness. As follows from the figure, both samples have high light transmittance in the visible and IR range. In particular, both samples have a total transmittance of about 71.4% at λ=460 nm, which corresponds to an internal transmittance of about 93%.

The following non-limiting aspects are encompassed by the present disclosure. To the extent not already described, any one of the features of the first through the sixty-fourth aspect may be combined in part or in whole with features of any one or more of the other aspects of the present disclosure to form additional aspects, even if such a combination is not explicitly described.

According to a first aspect, the glass comprises a plurality of components, the glass having a composition of the components comprising greater than or equal to 0.0 mol.% and less than or equal to 35.0 mol.% B₂O₃, greater than or equal to 0.0 mol.% and less than or equal to 35.0 mol.% P₂O₅, greater than or equal to 0.0 mol.% and less than or equal to 15.0 mol.% SiO₂, greater than or equal to 0.0 mol.% and less than or equal to 15.0 mol.% GeO₂, greater than or equal to 0.050 mol.% and less than or equal to 4.000 mol.% Bi₂O₃, greater than or equal to 0.0 at.% and less than or equal to 10.0 at.% F, a sum of B₂O₃ + SiO₂ + P₂O₅ greater than or equal to 5.0 mol.% and less than or equal to 35.0 mol.%, a sum of TiO₂ + Nb₂O₅ greater than or equal to 1.0 mol.% and less than or equal to 64.0 mol.% and a sum of R₂O + RO greater than or equal to 0.0 mol.% and less than or equal to 8.0 mol.%, where R₂O is a total sum of monovalent metal oxides, and RO is a total sum of divalent metal oxides.

According to a second aspect, the glass of the first aspect, wherein the composition of the components comprises greater than or equal to 6.1 mol.% and less than or equal to 12.0 mol.% ZrO₂, greater than or equal to 1.0 mol.% and less than or equal to 35.0 mol.% B₂O₃, greater than or equal to 1.0 mol.% and less than or equal to 35.0 mol.% TiO₂, greater than or equal to 0.0 mol.% and less than or equal to 40.0 mol.% WO₃, greater than or equal to 0.0 mol.% and less than or equal to 26.5 mol.% La₂O₃, greater than or equal to 0.0 mol.% and less than or equal to 20.0 mol.% Nb₂O₅, greater than or equal to 0.0 mol.% and less than or equal to 8.5 mol.% SiO₂, greater than or equal to 0.0 mol.% and less than or equal to 5.0 mol.% GeO₂, greater than or equal to 0.0 at.% and less than or equal to 1.0 at.% F, a sum of Gd₂O₃ + Yb₂O₃ greater than or equal to 0.0 mol.% and less than or equal to 2.0 mol.%, wherein the composition of the components satisfies the condition: SiO₂+ B₂O₃ - P₂O₅ [mol.%] ≥ 5.0, and wherein the glass has refractive index at 587.56 nm, n_{d}, that is greater than or equal to 2.05, where chemical formulas mean the content of corresponding components in the glass.

According to a third aspect, the glass of aspect 1, wherein the composition of the components comprises greater than or equal to 20.0 mol.% and less than or equal to 35.0 mol.% TiO₂, greater than or equal to 15.0 mol.% and less than or equal to 30.0 mol.% B₂O₃, greater than or equal to 15.0 mol.% and less than or equal to 27.0 mol.% La₂O₃, greater than or equal to 1.0 mol.% and less than or equal to 9.0 mol.% Nb₂O₅, greater than or equal to 1.0 mol.% and less than or equal to 9.0 mol.% ZrO₂, greater than or equal to 1.0 mol.% and less than or equal to 6.0 mol.% Y₂O₃, greater than or equal to 1.0 mol.% and less than or equal to 5.0 mol.% SiO₂, greater than or equal to 0.050 mol.% and less than or equal to 1.500 mol.% Bi₂O₃ and greater than or equal to 0.0 mol.% and less than or equal to 3.0 mol.% WO₃.

According to a fourth aspect, the glass of any one of aspects 1-3, wherein the composition of the components satisfy one or more of the following conditions: a sum of La₂O₃ + TiO₂ + B₂O₃ + SiO₂ + ZrO₂ + Nb₂O₅ + BaO + Y₂O₃ + CaO + Ga₂O₃ + Gd₂O₃ + ZnO + WO₃ + CeO₂ + SrO + Na₂O + Ta₂O₅ + Al₂O₃ greater than or equal to 99.0 mol.%, a sum of La₂O₃ + Y₂O₃ + Gd₂O₃ + TiO₂ + B₂O₃ + SiO₂ + ZrO₂ + Nb₂O₅ + Bi₂O₃ + Li₂O + CaO + SrO + BaO greater than or equal to 99.0 mol.%, a sum of La₂O₃ + Y₂O₃ + Gd₂O₃ + TiO₂ + B₂O₃ + SiO₂+ ZrO₂ + Nb₂O₅ + CaO + BaO greater than or equal to 99.0 mol.% and a sum of La₂O₃ + TiO₂ + B₂O₃ + SiO₂ + ZrO₂ + Nb₂O₅ + Bi₂O₃ greater than or equal to 97.0 mol.%.

According to a fifth aspect, the glass of any one of aspects 1-2 and 4, wherein the composition of the components comprises greater than or equal to 5.0 mol.% La₂O₃, greater than or equal to 5.0 mol.% Nb₂O₅, greater than or equal to 5.0 mol.% TiO₂, a sum of SiO₂+ B₂O₃ greater than or equal to 10.0 mol.% and a sum of ZrO₂ + HfO₂ greater than or equal to 1.0 mol%.

According to a sixth aspect, the glass of any one of aspects 1-5, wherein the composition of the components comprises a sum of R₂O + RO greater than or equal to 0.0 mol.% and less than or equal to 6.0 mol.%.

According to a seventh aspect, the glass of the sixth aspect, wherein the composition of the components comprises a sum of R₂O + RO greater than or equal to 0.0 mol.% and less than or equal to 1.0 mol.%.

According to an eighth aspect, the glass of any one of aspects 1-7, wherein the composition of the components satisfies the condition: 0.00 ≤ SiO₂/ (SiO₂ + B₂O₃) [mol.%] ≤ 0.40.

According to a ninth aspect, the glass of any one of aspects 1-8, wherein the composition of the components comprises greater than or equal to 0.0 mol.% and less than or equal to 6.5 mol.% CaO and greater than or equal to 0.0 mol.% and less than or equal to 5.5 mol.% BaO and wherein the composition of the components is substantially free of ZnO.

According to a tenth aspect, the glass of any one of aspects 1-9, wherein the composition of the components comprises a sum of WO₃ + Bi₂O₃ greater than or equal to 0.050 mol.% and less than or equal to 3.000 mol.%.

According to an eleventh aspect, the glass of any one of aspects 1-10, wherein the composition of the components comprises greater than or equal to 0.0 mol.% and less than or equal to 5.0 mol.% GeO₂, greater than or equal to 0.0 mol.% and less than or equal to 5.0 mol.% TeO₂, greater than or equal to 0.0 mol.% and less than or equal to 2.0 mol.% PbO, greater than or equal to 0.0 mol.% and less than or equal to 1.0 mol.% V₂O₅ and a sum of TiO₂ + Nb₂O₅ + La₂O₃ less than or equal to 70.0 mol.%.

According to a twelfth aspect, the glass of any one of aspects 1-11, wherein the composition of the components comprises greater than or equal to 0.0 mol.% and less than or equal to 3.0 mol.% Ta₂O₅, greater than or equal to 0.0 mol.% and less than or equal to 2.0 mol.% TeO₂, greater than or equal to 0.0 mol.% and less than or equal to 0.5 mol.% GeO₂, greater than or equal to 0.0 mol.% and less than or equal to 0.5 mol.% PbO, greater than or equal to 0.0 mol.% and less than or equal to 0.2 mol.% As₂O₃ and greater than or equal to 0.0 mol.% and less than or equal to 0.2 mol.% Sb₂O₃, wherein the composition of the components is substantially free of fluorine and substantially free of V₂O₅.

According to a thirteenth aspect, the glass of any one of aspects 1, 4-12, wherein the composition of the components comprises greater than or equal to 22.0 mol.% and less than or equal to 25.0 mol.% TiO₂, greater than or equal to 20.0 mol.% and less than or equal to 30.0 mol.% La₂O₃, greater than or equal to 16.0 mol.% and less than or equal to 20.0 mol.% B₂O₃, greater than or equal to 10.0 mol.% and less than or equal to 15.0 mol.% SiO₂, greater than or equal to 6.5 mol.% and less than or equal to 8.0 mol.% ZrO₂, greater than or equal to 5.0 mol.% and less than or equal to 6.7 mol.% Nb₂O₅, greater than or equal to 0.0 mol.% and less than or equal to 6.0 mol.% Y₂O₃, greater than or equal to 0.050 mol.% and less than or equal to 0.900 mol.% Bi₂O₃, greater than or equal to 0.0 mol.% and less than or equal to 3.0 mol.% BaO and greater than or equal to 0.0 mol.% and less than or equal to 2.0 mol.% Gd₂O₃ and greater than or equal to 0.0 mol.% and less than or equal to 2.0 mol.% of all other components in total.

According to a fourteenth aspect, the glass of any one of aspects 1-13, wherein the glass satisfies the conditions: 4.5 ≤ P_{d} ≤ 5.5 and 2.01 ≤ Pₙ ≤ 2.15, where Pₙ is a parameter predicting a refractive index at 587.56 nm, n_{d}, calculated from the glass composition in terms of mol.% of the components according to the Formula (I):

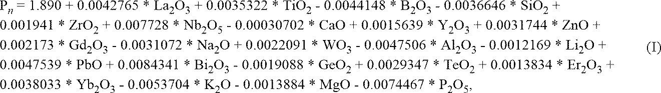

and P_{d} is a parameter predicting a density at room temperature, d_{RT} [g/cm³], calculated from the glass composition in terms of mol.% of the components according to the Formula (II):

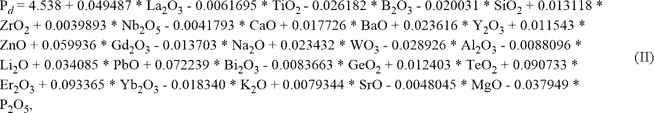

where an asterisk (*) means multiplication.

According to a fifteenth aspect, the glass of any one of aspects 1-14, wherein the glass has a density at room temperature, d_{RT} that is greater than or equal to 4.5 g/cm³ and less than or equal to 5.5 g/cm³ and a refractive index at 587.56 nm, n_{d}, that is greater than or equal to 2.01 and less than or equal to 2.15.

According to a sixteenth aspect, the glass of any one of aspects 1-15, wherein the glass has a liquidus temperature, T_{liq} that is less than or equal to 1260° C.

According to a seventeenth aspect, the glass of any one of aspects 1-16, wherein when cooled in air from 1100° C. to 500° C. in 2.5 minutes, the glass does not crystallize.

According to an eighteenth aspect, the glass of any one of aspects 1-17, wherein the glass has a transmittance at a wavelength of 460 nm, TX_{460 nm}, that is greater than or equal to 70%.

According to a nineteenth aspect, a method for manufacturing an optical element, the method comprising processing a glass, wherein the glass is the glass of any one of aspects 1-18.

According to a twentieth aspect, an optical element comprising a glass, wherein the glass is the glass of any one of aspects 1-19.

According to a twenty-first aspect, the glass comprises a plurality of components, the glass having a composition of the components comprising greater than or equal to 1.0 mol.% and less than or equal to 50.0 mol.% TiO₂, greater than or equal to 1.0 mol.% and less than or equal to 50.0 mol.% Nb₂O₅, greater than or equal to 0.1 mol.% and less than or equal to 10.0 mol.% Bi₂O₃, a sum of B₂O₃ + SiO₂ greater than or equal to 1.0 mol.% and less than or equal to 50.0 mol.% and may optionally contain one or more components selected from P₂O₅, La₂O₃, ZrO₂, CaO, Y₂O₃, ZnO, Gd₂O₃, Na₂O, WO₃, Al₂O₃, Li₂O, PbO, GeO₂, TeO₂, Er₂O₃, Yb₂O₃, K₂O and MgO, wherein the composition of the components satisfies the condition: SiO₂+ B₂O₃ - P₂O₅ [mol.%] ≥ -8.0, and the glass satisfies the condition: Pₙ > 2.05, where Pₙ is a parameter predicting a refractive index at 587.56 nm, n_{d}, calculated from the glass composition in terms of mol.% of the components according to the Formula (I):

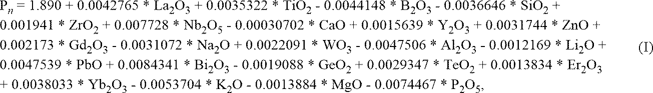

where an asterisk (*) means multiplication.

According to a twenty-second aspect, the glass of the twenty-first aspect, wherein the glass has a refractive index at 587.56 nm, n_{d}, that is greater than or equal to 2.05.

According to a twenty-third aspect, the glass of any one of aspects 21-22, wherein the composition of the components comprises greater than or equal to 6.1 mol.% and less than or equal to 12.0 mol.% ZrO₂, greater than or equal to 1.0 mol.% and less than or equal to 35.0 mol.% B₂O₃, greater than or equal to 1.0 mol.% and less than or equal to 35.0 mol.% TiO₂, greater than or equal to 1.0 mol.% and less than or equal to 20.0 mol.% Nb₂O₅, greater than or equal to 0.0 mol.% and less than or equal to 40.0 mol.% WO₃, greater than or equal to 0.0 mol.% and less than or equal to 26.5 mol.% La₂O₃, greater than or equal to 0.0 mol.% and less than or equal to 8.5 mol.% SiO₂, greater than or equal to 0.0 mol.% and less than or equal to 5.0 mol.% GeO₂, greater than or equal to 0.0 at.% and less than or equal to 1.0 at.% F, a sum of R₂O + RO greater than or equal to 0.0 mol.% and less than or equal to 12.0 mol.% and a sum of Gd₂O₃ + Yb₂O₃ greater than or equal to 0.0 mol.% and less than or equal to 2.0 mol.% and wherein the composition of the components satisfies the condition: SiO₂+ B₂O₃ - P₂O₅ [mol.%] ≥ 5.0, where chemical formulas mean the content of corresponding components in the glass, R₂O is a total sum of monovalent metal oxides, and RO is a total sum of divalent metal oxides.

According to a twenty-fourth aspect, the glass of any one of aspects 21-22, wherein the composition of the components comprises greater than or equal to 20.0 mol.% and less than or equal to 35.0 mol.% TiO₂, greater than or equal to 15.0 mol.% and less than or equal to 30.0 mol.% B₂O₃, greater than or equal to 15.0 mol.% and less than or equal to 27.0 mol.% La₂O₃, greater than or equal to 1.0 mol.% and less than or equal to 9.0 mol.% Nb₂O₅, greater than or equal to 1.0 mol.% and less than or equal to 9.0 mol.% ZrO₂, greater than or equal to 1.0 mol.% and less than or equal to 6.0 mol.% Y₂O₃, greater than or equal to 1.0 mol.% and less than or equal to 5.0 mol.% SiO₂, greater than or equal to 0.1 mol.% and less than or equal to 1.5 mol.% Bi₂O₃ and greater than or equal to 0.0 mol.% and less than or equal to 3.0 mol.% WO₃.

According to a twenty-fifth aspect, the glass of any one of aspects 21-24, wherein the composition of the components satisfy one or more of the following conditions: a sum of La₂O₃ + TiO₂ + B₂O₃ + SiO₂+ ZrO₂ + Nb₂O₅ + BaO + Y₂O₃ + CaO + Ga₂O₃ + Gd₂O₃ + ZnO + WO₃ + CeO₂ + SrO + Na₂O + Ta₂O₅ + Al₂O₃ greater than or equal to 99.0 mol.%, a sum of La₂O₃ + Y₂O₃ + Gd₂O₃ + TiO₂ + B₂O₃ + SiO₂ + ZrO₂ + Nb₂O₅ + Bi₂O₃ + Li₂O + CaO + SrO + BaO greater than or equal to 99.0 mol.%, a sum of La₂O₃ + Y₂O₃ + Gd₂O₃ + TiO₂ + B₂O₃ + SiO₂+ ZrO₂ + Nb₂O₅ + CaO + BaO greater than or equal to 99.0 mol.% and a sum of La₂O₃ + TiO₂ + B₂O₃ + SiO₂ + ZrO₂ + Nb₂O₅ + Bi₂O₃ greater than or equal to 97.0 mol.%.

According to a twenty-sixth aspect, the glass of any one of aspects 21-25, wherein the composition of the components comprises greater than or equal to 5.0 mol.% B₂O₃, greater than or equal to 5.0 mol.% La₂O₃, greater than or equal to 5.0 mol.% Nb₂O₅, greater than or equal to 5.0 mol.% SiO₂, greater than or equal to 5.0 mol.% TiO₂, a sum of SiO₂+ B₂O₃ greater than or equal to 10.0 mol.% and a sum of ZrO₂ + HfO₂ greater than or equal to 1.0 mol.%.

According to a twenty-seventh aspect, the glass of any one of aspects 21-26, wherein the composition of the components comprises a sum of R₂O + RO greater than or equal to 0.0 mol.% and less than or equal to 6.0 mol.%, where R₂O is a total sum of monovalent metal oxides, and RO is a total sum of divalent metal oxides.

According to a twenty-eighth aspect, the glass of the twenty-seventh aspect, wherein the composition of the components comprises a sum of R₂O + RO greater than or equal to 0.0 mol.% and less than or equal to 1.0 mol.%.

According to a twenty-ninth aspect, the glass of any one of aspects 21-28, wherein the composition of the components satisfies the condition: 0.00 ≤ SiO₂/ (SiO₂ + B₂O₃) [mol.%] ≤ 0.40.

According to a thirtieth aspect, the glass of any one of aspects 21-29, wherein the composition of the components comprises greater than or equal to 0.0 mol.% and less than or equal to 6.5 mol.% CaO and greater than or equal to 0.0 mol.% and less than or equal to 5.5 mol.% BaO and wherein the composition of the components is substantially free of ZnO.

According to a thirty-first aspect, the glass of any one of aspects 21-30, wherein the composition of the components comprises a sum of WO₃ + Bi₂O₃ greater than or equal to 0.050 mol.% and less than or equal to 3.000 mol.%.

According to a thirty-second aspect, the glass of any one of aspects 21-31, wherein the composition of the components comprises greater than or equal to 0.0 mol.% and less than or equal to 5.0 mol.% GeO₂, greater than or equal to 0.0 mol.% and less than or equal to 5.0 mol.% TeO₂, greater than or equal to 0.0 mol.% and less than or equal to 2.0 mol.% PbO, greater than or equal to 0.0 mol.% and less than or equal to 1.0 mol.% V₂O₅ and a sum of TiO₂ + Nb₂O₅ + La₂O₃ less than or equal to 70.0 mol.%.

According to a thirty-third aspect, the glass of any one of aspects 21-32, wherein the composition of the components comprises greater than or equal to 0.0 mol.% and less than or equal to 3.0 mol.% Ta₂O₅, greater than or equal to 0.0 mol.% and less than or equal to 2.0 mol.% TeO₂, greater than or equal to 0.0 mol.% and less than or equal to 0.5 mol.% GeO₂, greater than or equal to 0.0 mol.% and less than or equal to 0.5 mol.% PbO, greater than or equal to 0.0 mol.% and less than or equal to 0.2 mol.% As₂O₃ and greater than or equal to 0.0 mol.% and less than or equal to 0.2 mol.% Sb₂O₃, wherein the composition of the components is substantially free of fluorine and substantially free of V₂O₅.

According to a thirty-fourth aspect, the glass of any one of aspects 21-22 and 25-33, wherein the composition of the components comprises greater than or equal to 22.0 mol.% and less than or equal to 25.0 mol.% TiO₂, greater than or equal to 20.0 mol.% and less than or equal to 30.0 mol.% La₂O₃, greater than or equal to 16.0 mol.% and less than or equal to 20.0 mol.% B₂O₃, greater than or equal to 10.0 mol.% and less than or equal to 20.0 mol.% SiO₂, greater than or equal to 6.5 mol.% and less than or equal to 8.0 mol.% ZrO₂, greater than or equal to 5.0 mol.% and less than or equal to 6.7 mol.% Nb₂O₅, greater than or equal to 0.1 mol.% and less than or equal to 0.9 mol.% Bi₂O₃, greater than or equal to 0.0 mol.% and less than or equal to 6.0 mol.% Y₂O₃, greater than or equal to 0.0 mol.% and less than or equal to 3.0 mol.% BaO and greater than or equal to 0.0 mol.% and less than or equal to 2.0 mol.% Gd₂O₃ and greater than or equal to 0.0 mol.% and less than or equal to 2.0 mol.% of all other components in total.

According to a thirty-fifth aspect, the glass of any one of aspects 21-34, wherein the glass satisfies the conditions: 4.5 ≤ P_{d} ≤ 5.5 and 2.05 ≤ Pₙ ≤ 2.15, where P_{d} is a parameter predicting a density at room temperature, d_{RT} [g/cm³], calculated from the glass composition in terms of mol.% of the components according to the Formula (II):

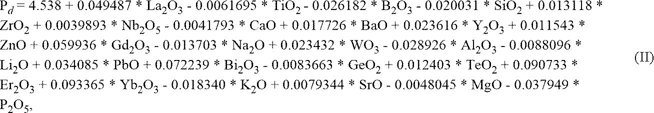

According to a thirty-sixth aspect, the glass of any one of aspects 21-35, wherein the glass has a density at room temperature, d_{RT}, that is greater than or equal to 4.5 g/cm³ and less than or equal to 5.5 g/cm³ and a refractive index at 587.56 nm, n_{d}, that is greater than or equal to 2.05 and less than or equal to 2.15.

According to a thirty-seventh aspect, the glass of any one of aspects 21-36, wherein the glass has a liquidus temperature, T_{liq}, that is less than or equal to 1260° C.

According to a thirty-eighth aspect, the glass of any one of aspects 21-37, wherein when cooled in air from 1100° C. to 500° C. in 2.5 minutes, the glass does not crystallize.

According to a thirty-ninth aspect, the glass of any one of aspects 21-38, wherein the glass has a transmittance at a wavelength of 460 nm, TX_{460 nm}, that is greater than or equal to 70%.

According to a fortieth aspect, a method for manufacturing an optical element, the method comprising processing a glass, wherein the glass is the glass of any one of aspects 21-39.

According to a forty-first aspect, an optical element comprising a glass, wherein the glass is the glass of any one of aspects 21-40.

According to a forty-second aspect, the glass comprises a plurality of components, the glass having a composition of the components comprising greater than or equal to 1.0 mol.% and less than or equal to 40.0 mol.% B₂O₃, greater than or equal to 0.5 mol.% and less than or equal to 45.0 mol.% TiO₂, greater than or equal to 0.0 mol.% and less than or equal to 40.0 mol.% SiO₂, greater than or equal to 0.0 mol.% and less than or equal to 40.0 mol.% P₂O₅, greater than or equal to 0.0 mol.% and less than or equal to 40.0 mol.% WO₃, greater than or equal to 0.0 mol.% and less than or equal to 40.0 mol.% Nb₂O₅, greater than or equal to 0.0 mol.% and less than or equal to 40.0 mol.% La₂O₃, greater than or equal to 0.0 mol.% and less than or equal to 15.0 mol.% TeO₂, greater than or equal to 0.0 mol.% and less than or equal to 15.0 mol.% GeO₂, greater than or equal to 0.050 mol.% and less than or equal to 8.000 mol.% Bi₂O₃, greater than or equal to 0.0 mol.% and less than or equal to 10.0 mol.% PbO, greater than or equal to 0.0 mol.% and less than or equal to 5.0 mol.% Ga₂O₃ and may optionally contain one or more components selected from ZrO₂, CaO, Y₂O₃, ZnO, Gd₂O₃, Na₂O, Al₂O₃, Li₂O, Er₂O₃, Yb₂O_{3,} K₂O, MgO, BaO and SrO, the glass satisfies the conditions: 4.2 ≤ P_{d} ≤ 6.0 and Pₙ - (1.62 + 0.08 * P_{d}) > 0.000, where Pₙ is a parameter predicting a refractive index at 587.56 nm, n_{d}, calculated from the glass composition in terms of mol.% of the components according to the Formula (I):

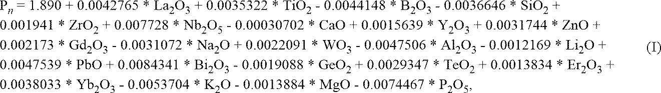

and P_{d} is a parameter predicting a density at room temperature, d_{RT} [g/cm³], calculated from the glass composition in terms of mol.% of the components according to the Formula (II):

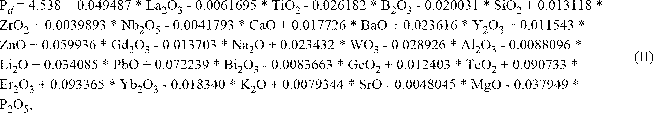

where an asterisk (*) means multiplication.

According to a forty-third aspect, the glass of the forty-second aspect, wherein the glass has a density at room temperature, d_{RT} that is greater than or equal to 4.2 g/cm³ and less than or equal to 6.0 g/cm³ and wherein the glass satisfies the condition: n_{d} - (1.62 + 0.08 * d_{RT}) > 0.000, where n_{d} is a refractive index at 587.56 nm.

According to a forty-fourth aspect, the glass of any one of aspects 42-43, wherein the glass satisfies the condition: n_{d} - (1.65 + 0.08 * d_{RT}) > 0.000, where n_{d} is a refractive index at 587.56 nm and d_{RT} [g/cm³] is a density at room temperature.

According to a forty-fifth aspect, the glass of any one of aspects 42-44, wherein the glass satisfies the condition: Pₙ - (1.65 + 0.08 * P_{d}) > 0.000.

According to a forty-sixth aspect, the glass of any one of aspects 42-45, wherein the composition of the components comprises greater than or equal to 6.1 mol.% and less than or equal to 12.0 mol.% ZrO₂, greater than or equal to 1.0 mol.% and less than or equal to 35.0 mol.% B₂O₃, greater than or equal to 1.0 mol.% and less than or equal to 35.0 mol.% TiO₂, greater than or equal to 0.0 mol.% and less than or equal to 26.5 mol.% La₂O₃, greater than or equal to 0.0 mol.% and less than or equal to 20.0 mol.% Nb₂O₅, greater than or equal to 0.0 mol.% and less than or equal to 8.5 mol.% SiO₂, greater than or equal to 0.0 mol.% and less than or equal to 5.0 mol.% GeO₂, greater than or equal to 0.0 at.% and less than or equal to 1.0 at.% F, a sum of R₂O + RO greater than or equal to 0.0 mol.% and less than or equal to 12.0 mol.% and a sum of Gd₂O₃ + Yb₂O₃ greater than or equal to 0.0 mol.% and less than or equal to 2.0 mol.%, wherein the composition of the components satisfies the condition: SiO₂ + B₂O₃ -P₂O₅ [mol.%] ≥ 5.0, and wherein the glass has refractive index at 587.56 nm, n_{d}, that is greater than or equal to 2.05, where R₂O is a total sum of monovalent metal oxides and RO is a total sum of divalent metal oxides.

According to a forty-seventh aspect, the glass of any one of aspects 42-46, wherein the composition of the components comprises greater than or equal to 20.0 mol.% and less than or equal to 35.0 mol.% TiO₂, greater than or equal to 15.0 mol.% and less than or equal to 30.0 mol.% B₂O₃, greater than or equal to 15.0 mol.% and less than or equal to 26.5 mol.% La₂O₃, greater than or equal to 1.0 mol.% and less than or equal to 9.0 mol.% Nb₂O₅, greater than or equal to 1.0 mol.% and less than or equal to 9.0 mol.% ZrO₂, greater than or equal to 1.0 mol.% and less than or equal to 6.0 mol.% Y₂O₃, greater than or equal to 1.0 mol.% and less than or equal to 5.0 mol.% SiO₂, greater than or equal to 0.050 mol.% and less than or equal to 1.500 mol.% Bi₂O₃ and greater than or equal to 0.0 mol.% and less than or equal to 3.0 mol.% WO₃.

According to a forty-eighth aspect, the glass of any one of aspects 42-47, wherein the composition of the components satisfy one or more of the following conditions: a sum of La₂O₃ + TiO₂ + B₂O₃ + SiO₂ + ZrO₂ + Nb₂O₅ + BaO + Y₂O₃ + CaO + Ga₂O₃ + Gd₂O₃ + ZnO + WO₃ + CeO₂ + SrO + Na₂O + Ta₂O₅ + Al₂O₃ greater than or equal to 99.0 mol.%, a sum of La₂O₃ + Y₂O₃ + Gd₂O₃ + TiO₂ + B₂O₃ + SiO₂ + ZrO₂ + Nb₂O₅ + Bi₂O₃ + Li₂O + CaO + SrO + BaO greater than or equal to 99.0 mol.%, a sum of La₂O₃ + Y₂O₃ + Gd₂O₃ + TiO₂ + B₂O₃ + SiO₂+ ZrO₂ + Nb₂O₅ + CaO + BaO greater than or equal to 99.0 mol.% and a sum of La₂O₃ + TiO₂ + B₂O₃ + SiO₂ + ZrO₂ + Nb₂O₅ + Bi₂O₃ greater than or equal to 97.0 mol.%.

According to a forty-ninth aspect, the glass of any one of aspects 42-48, wherein the composition of the components comprises greater than or equal to 5.0 mol.% B₂O₃, greater than or equal to 5.0 mol.% La₂O₃, greater than or equal to 5.0 mol.% Nb₂O₅, greater than or equal to 5.0 mol.% SiO₂, greater than or equal to 5.0 mol.% TiO₂, a sum of SiO₂+ B₂O₃ greater than or equal to 10.0 mol.% and a sum of ZrO₂ + HfO₂ is greater than or equal to 1.0 mol.%.

According to a fiftieth aspect, the glass of any one of aspects 42-49, wherein the composition of the components comprises a sum of R₂O + RO greater than or equal to 0.0 mol.% and less than or equal to 6.0 mol.%, where R₂O is a total sum of monovalent metal oxides and RO is a total sum of divalent metal oxides.

According to a fifty-first aspect, the glass of the fiftieth aspect, wherein the composition of the components comprises a sum of R₂O + RO greater than or equal to 0.0 mol.% and less than or equal to 1.0 mol.%.

According to a fifty-second aspect, the glass of any one of aspects 42-51, wherein the composition of the components satisfies the condition: 0.00 ≤ SiO₂/ (SiO₂ + B₂O₃) [mol.%] ≤ 0.40, where chemical formulas mean the content of corresponding components in the glass.

According to a fifty-third aspect, the glass of any one of aspects 42-52, wherein the composition of the components comprises greater than or equal to 0.0 mol.% and less than or equal to 6.5 mol.% CaO and greater than or equal to 0.0 mol.% and less than or equal to 5.5 mol.% BaO and wherein the composition of the components is substantially free of ZnO.

According to a fifty-fourth aspect, the glass of any one of aspects 42-53, wherein the composition of the components comprises a sum of WO₃ + Bi₂O₃ greater than or equal to 0.050 mol.% and less than or equal to 3.000 mol.%.

According to a fifty-fifth aspect, the glass of any one of aspects 42-54, wherein the composition of the components comprises greater than or equal to 0.0 mol.% and less than or equal to 5.0 mol.% GeO₂, greater than or equal to 0.0 mol.% and less than or equal to 5.0 mol.% TeO₂, greater than or equal to 0.0 mol.% and less than or equal to 2.0 mol.% PbO, greater than or equal to 0.0 mol.% and less than or equal to 1.0 mol.% V₂O₅ and a sum of TiO₂ + Nb₂O₅ + La₂O₃ less than or equal to 70.0 mol.%.

According to a fifty-sixth aspect, the glass of any one of aspects 42-55, wherein the composition of the components comprises greater than or equal to 0.0 mol.% and less than or equal to 3.0 mol.% Ta₂O₅, greater than or equal to 0.0 mol.% and less than or equal to 2.0 mol.% TeO₂, greater than or equal to 0.0 mol.% and less than or equal to 0.5 mol.% GeO₂, greater than or equal to 0.0 mol.% and less than or equal to 0.5 mol.% PbO, greater than or equal to 0.0 mol.% and less than or equal to 0.2 mol.% As₂O₃ and greater than or equal to 0.0 mol.% and less than or equal to 0.2 mol.% Sb₂O₃, wherein the composition of the components is substantially free of fluorine and substantially free of V₂O₅.

According to a fifty-seventh aspect, the glass of any one of aspects 42-45 and 47-56, wherein the composition of the components comprises greater than or equal to 22.0 mol.% and less than or equal to 25.0 mol.% TiO₂, greater than or equal to 20.0 mol.% and less than or equal to 30.0 mol.% La₂O₃, greater than or equal to 16.0 mol.% and less than or equal to 20.0 mol.% B₂O₃, greater than or equal to 10.0 mol.% and less than or equal to 20.0 mol.% SiO₂, greater than or equal to 6.5 mol.% and less than or equal to 8.0 mol.% ZrO₂, greater than or equal to 5.0 mol.% and less than or equal to 6.7 mol.% Nb₂O₅, greater than or equal to 0.0 mol.% and less than or equal to 6.0 mol.% Y₂O₃, greater than or equal to 0.050 mol.% and less than or equal to 0.900 mol.% Bi₂O₃, greater than or equal to 0.0 mol.% and less than or equal to 3.0 mol.% BaO and greater than or equal to 0.0 mol.% and less than or equal to 2.0 mol.% Gd₂O₃ and greater than or equal to 0.0 mol.% and less than or equal to 2.0 mol.% of all other components in total.

According to a fifty-eighth aspect, the glass of any one of aspects 42-57, wherein the glass satisfies the conditions: 4.5 ≤ P_{d} ≤ 5.5 and 2.01 ≤ Pₙ ≤ 2.15.

According to a fifty-ninth aspect, the glass of any one of aspects 42-58, wherein the glass has a density at room temperature, d_{RT} that is greater than or equal to 4.5 g/cm³ and less than or equal to 5.5 g/cm³ and a refractive index at 587.56 nm, n_{d}, that is greater than or equal to 2.01 and less than or equal to 2.15.

According to a sixtieth aspect, the glass of any one of aspects 42-59, wherein the glass has a liquidus temperature, T_{liq}, that is less than or equal to 1260° C.

According to a sixty-first aspect, the glass of any one of aspects 42-60, wherein when cooled in air from 1100° C. to 500° C. in 2.5 minutes, the glass does not crystallize.

According to a sixty-second aspect, the glass of any one of aspects 42-61, wherein the glass has a transmittance at a wavelength of 460 nm, TX_{460 nm}, that is greater than or equal to 70%.

According to a sixty-third aspect, a method for manufacturing an optical element, the method comprising processing a glass, wherein the glass is the glass of any one of aspects 42-62.

According to a sixty-fourth aspect, an optical element comprising a glass, wherein the glass is the glass of any one of aspects 42-63.

Many variations and modifications may be made to the above-described embodiments of the disclosure without departing substantially from the spirit and various principles of the disclosure. All such modifications and variations are intended to be included herein within the scope of this disclosure and protected by the following claims.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

1. A glass comprising a plurality of components, the glass having a composition of the components comprising:
greater than or equal to 0.0 mol.% and less than or equal to 35.0 mol.% B₂O₃,
greater than or equal to 0.0 mol.% and less than or equal to 35.0 mol.% P₂O₅,
greater than or equal to 0.0 mol.% and less than or equal to 15.0 mol.% SiO₂,
greater than or equal to 0.0 mol.% and less than or equal to 15.0 mol.% GeO₂,
greater than or equal to 0.050 mol.% and less than or equal to 4.000 mol.% Bi₂O₃,
greater than or equal to 0.0 at.% and less than or equal to 10.0 at.% F,
a sum of B₂O₃ + SiO₂ + P₂O₅ greater than or equal to 5.0 mol.% and less than or equal to 35.0 mol.%,
a sum of TiO₂ + Nb₂O₅ greater than or equal to 1.0 mol.% and less than or equal to 64.0 mol.% and
a sum of R₂O + RO greater than or equal to 0.0 mol.% and less than or equal to 8.0 mol.%.
where R₂O is a total sum of monovalent metal oxides, and RO is a total sum of divalent metal oxides.

2. The glass of claim 1, wherein the composition of the components comprises:
greater than or equal to 6.1 mol.% and less than or equal to 12.0 mol.% ZrO₂,
greater than or equal to 1.0 mol.% and less than or equal to 35.0 mol.% B₂O₃,
greater than or equal to 1.0 mol.% and less than or equal to 35.0 mol.% TiO₂,
greater than or equal to 0.0 mol.% and less than or equal to 40.0 mol.% WO₃,
greater than or equal to 0.0 mol.% and less than or equal to 26.5 mol.% La₂O₃,
greater than or equal to 0.0 mol.% and less than or equal to 20.0 mol.% Nb₂O₅,
greater than or equal to 0.0 mol.% and less than or equal to 8.5 mol.% SiO₂,
greater than or equal to 0.0 mol.% and less than or equal to 5.0 mol.% GeO₂,
greater than or equal to 0.0 at.% and less than or equal to 1.0 at.% F,
a sum of Gd₂O₃ + Yb₂O₃ is greater than or equal to 0.0 mol.% and less than or equal to 2.0 mol.%,
wherein the composition of the components satisfies the condition: 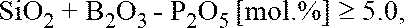
and wherein the glass has
a refractive index at 587.56 nm, n_{d}, that is greater than or equal to 2.05.

3. The glass of claim 1, wherein the composition of the components comprises:
a sum of WO₃ + Bi₂O₃ greater than or equal to 0.050 mol.% and less than or equal to 3.000 mol.%.

4. The glass of claim 1, wherein the composition of the components comprises:
greater than or equal to 0.0 mol.% and less than or equal to 3.0 mol.% Ta₂O₅,
greater than or equal to 0.0 mol.% and less than or equal to 2.0 mol.% TeO₂,
greater than or equal to 0.0 mol.% and less than or equal to 0.5 mol.% GeO₂,
greater than or equal to 0.0 mol.% and less than or equal to 0.5 mol.% PbO,
greater than or equal to 0.0 mol.% and less than or equal to 0.2 mol.% As₂O₃ and
greater than or equal to 0.0 mol.% and less than or equal to 0.2 mol.% Sb₂O₃,
wherein the composition of the components is
substantially free of fluorine and
substantially free of V₂O₅.

5. The glass of claim 1, wherein the composition of the components comprises:
greater than or equal to 22.0 mol.% and less than or equal to 25.0 mol.% TiO₂,
greater than or equal to 20.0 mol.% and less than or equal to 30.0 mol.% La₂O₃,
greater than or equal to 16.0 mol.% and less than or equal to 20.0 mol.% B₂O₃,
greater than or equal to 10.0 mol.% and less than or equal to 15.0 mol.% SiO₂,
greater than or equal to 6.5 mol.% and less than or equal to 8.0 mol.% ZrO₂,
greater than or equal to 5.0 mol.% and less than or equal to 6.7 mol.% Nb₂O₅,
greater than or equal to 0.0 mol.% and less than or equal to 6.0 mol.% Y₂O₃,
greater than or equal to 0.050 mol.% and less than or equal to 0.900 mol.% Bi₂O₃,
greater than or equal to 0.0 mol.% and less than or equal to 3.0 mol.% BaO and
greater than or equal to 0.0 mol.% and less than or equal to 2.0 mol.% Gd₂O₃ and
greater than or equal to 0.0 mol.% and less than or equal to 2.0 mol.% of all other components in total.

6. The glass of claim 1, wherein the glass satisfies the conditions:
$$4.5 \leq {\text{P}}_{\text{d}} \leq 5.5 \text{and}$$
$$2.01 \leq {\text{P}}_{\text{n}} \leq 2.15 ,$$
where
Pₙ is a parameter predicting a refractive index at 587.56 nm, n_{d}, calculated from the glass composition in terms of mol.% of the components according to the Formula (I):
$$\begin{matrix}{\text{P}}_{\text{n}} = 1.890 + 0.0042765 \text{*} {\text{La}}_{2} {\text{O}}_{3} + 0.0035322 \text{*} {\text{TiO}}_{\text{2}} \text{-} 0.0044148 \text{*} \\ {\text{B}}_{\text{2}} {\text{O}}_{\text{3}} \text{-} 0.0036646 \text{*} {\text{SiO}}_{2} + 0.001941 \text{*} {\text{ZrO}}_{2} + 0.007728 \text{*} {\text{Nb}}_{2} {\text{O}}_{5} \text{-} \\ 0.00030702 \text{*} \text{CaO} + 0.0015639 \text{*} {\text{Y}}_{2} {\text{O}}_{3} + 0.00031744 \text{*} \text{ZnO} + \\ 0.002173 \text{*} {\text{Gd}}_{2} {\text{O}}_{3} \text{-} 0.0031072 \text{*} {\text{Na}}_{2} \text{O} + 0.0022091 \text{*} {\text{WO}}_{3} \text{-} \\ 0.0047506 \text{*} {\text{Al}}_{2} {\text{O}}_{3} \text{-} 0.0012169 \text{*} {\text{Li}}_{2} \text{O} + 0.0047539 \text{*} \text{PbO} + \\ 0.0084341 \text{*} {\text{Bi}}_{2} {\text{O}}_{3} \text{-} 0.0019088 \text{*} {\text{GeO}}_{2} + 0.0029347 \text{*} {\text{TeO}}_{2} + \\ 0.0013834 \text{*} {\text{Er}}_{2} {\text{O}}_{3} + 0.0038033 \text{*} {\text{Yb}}_{2} {\text{O}}_{3} \text{-} 0.0053704 \text{*} {\text{K}}_{2} \text{O} \text{-} \\ 0.0013884 \text{*} \text{MgO} \text{-} 0.0074467 \text{*} {\text{P}}_{2} {\text{O}}_{5} ,\end{matrix} \qquad \text{(I)}$$
and P_{d} is a parameter predicting a density at room temperature, dₐᵣ [g/cm³], calculated from the glass composition in terms of mol.% of the components according to the Formula (II):
$$\begin{matrix}{\text{P}}_{\text{d}} = 4.538 + 0.049487 \text{*} {\text{La}}_{2} {\text{O}}_{3} \text{-} 0.0061695 \text{*} {\text{TiO}}_{\text{2}} \text{-} 0.026182 ∗ \\ {\text{B}}_{2} {\text{O}}_{3} \text{-} 0.020031 \text{*} {\text{SiO}}_{2} + 0.013118 \text{*} {\text{ZrO}}_{2} + 0.0039893 \text{*} {\text{Nb}}_{2} {\text{O}}_{5} \text{-} \\ 0.0041793 \text{*} \text{CaO} + 0.017726 \text{*} \text{BaO} + 0.023616 \text{*} {\text{Y}}_{\text{2}} {\text{O}}_{\text{3}} + 0.011543 \text{*} \\ \text{ZnO} + 0.059936 \text{*} {\text{Gd}}_{\text{2}} {\text{O}}_{\text{3}} \text{-} 0.013703 \text{*} {\text{Na}}_{\text{2}} \text{O} + 0.023432 \text{*} {\text{WO}}_{\text{3}} \text{-} \\ 0.028926 \text{*} {\text{Al}}_{\text{2}} {\text{O}}_{\text{3}} \text{-} 0.0088096 \text{*} {\text{Li}}_{\text{2}} \text{O} + 0.034085 \text{*} \text{PbO} + 0.072239 \text{*} \\ {\text{Bi}}_{\text{2}} {\text{O}}_{\text{3}} \text{-} 0.0083663 \text{*} {\text{GeO}}_{\text{2}} + 0.012403 \text{*} {\text{TeO}}_{\text{2}} + 0.090733 \text{*} {\text{Er}}_{\text{2}} {\text{O}}_{\text{3}} + \\ 0.093365 \text{*} {\text{Yb}}_{\text{2}} {\text{O}}_{3} \text{-} 0.018340 \text{*} {\text{K}}_{\text{2}} \text{O} + 0.0079344 \text{*} \text{SrO} \text{-} 0.0048045 \text{*} \\ \text{MgO} \text{-} 0.037949 \text{*} {\text{P}}_{\text{2}} {\text{O}}_{5} ,\end{matrix} \qquad \text{(II)}$$
where an asterisk (*) means multiplication.

7. The glass of claim 1, wherein when cooled in air from 1100° C. to 500° C. in 2.5 minutes, the glass does not crystallize.

8. A glass comprising a plurality of components, the glass having a composition of the components comprising:
greater than or equal to 1.0 mol.% and less than or equal to 50.0 mol.% TiO₂,
greater than or equal to 1.0 mol.% and less than or equal to 50.0 mol.% Nb₂O₅,
greater than or equal to 0.1 mol.% and less than or equal to 10.0 mol.% Bi₂O₃,
a sum of B₂O₃ + SiO₂ greater than or equal to 1.0 mol.% and less than or equal to 50.0 mol.% and
optionally comprising one or more components selected from P₂O₅, La₂O₃, ZrO_{z}, CaO, Y₂O₃, ZnO, Gd₂O₃, Na₂O, WO₃, Al₂O₃, Li₂O, PbO, GeO₂, TeO₂, Er₂O₃, Yb₂O₃, K₂O and MgO,
wherein the composition of the components satisfies the condition: 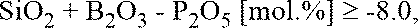
and wherein the glass satisfies the condition:
$${\text{P}}_{\text{n}} > 2.05 ,$$
where
Pₙ is a parameter predicting a refractive index at 587.56 nm, n_{d}, calculated from the glass composition in terms of mol.% of the components according to the Formula (I):
$$\begin{matrix}{\text{P}}_{\text{n}} = 1.890 + 0.0042765 \text{*} {\text{La}}_{2} {\text{O}}_{3} + 0.0035322 \text{*} {\text{TiO}}_{\text{2}} \text{-} 0.0044148 \text{*} \\ {\text{B}}_{\text{2}} {\text{O}}_{\text{3}} \text{-} 0.0036646 \text{*} {\text{SiO}}_{2} + 0.001941 \text{*} {\text{ZrO}}_{2} + 0.007728 \text{*} {\text{Nb}}_{2} {\text{O}}_{5} \text{-} \\ 0.00030702 \text{*} \text{CaO} + 0.0015639 \text{*} {\text{Y}}_{2} {\text{O}}_{3} + 0.00031744 \text{*} \text{ZnO} + \\ 0.002173 \text{*} {\text{Gd}}_{2} {\text{O}}_{3} \text{-} 0.0031072 \text{*} {\text{Na}}_{2} \text{O} + 0.0022091 \text{*} {\text{WO}}_{3} \text{-} \\ 0.0047506 \text{*} {\text{Al}}_{2} {\text{O}}_{3} \text{-} 0.0012169 \text{*} {\text{Li}}_{2} \text{O} + 0.0047539 \text{*} \text{PbO} + \\ 0.0084341 \text{*} {\text{Bi}}_{2} {\text{O}}_{3} \text{-} 0.0019088 \text{*} {\text{GeO}}_{2} + 0.0029347 \text{*} {\text{TeO}}_{2} + \\ 0.0013834 \text{*} {\text{Er}}_{2} {\text{O}}_{3} + 0.0038033 \text{*} {\text{Yb}}_{2} {\text{O}}_{3} \text{-} 0.0053704 \text{*} {\text{K}}_{2} \text{O} \text{-} \\ 0.0013884 \text{*} \text{MgO} \text{-} 0.0074467 \text{*} {\text{P}}_{2} {\text{O}}_{5} ,\end{matrix} \qquad \text{(I)}$$
where an asterisk (*) means multiplication.

9. The glass of claim 8, wherein the glass has
a refractive index at 587.56 nm, n_{d}, that is greater than or equal to 2.05.

10. The glass of claim 8, wherein the composition of the components comprises:
greater than or equal to 6.1 mol.% and less than or equal to 12.0 mol.% ZrO₂,
greater than or equal to 1.0 mol.% and less than or equal to 35.0 mol.% B₂O₃,
greater than or equal to 1.0 mol.% and less than or equal to 35.0 mol.% TiO₂,
greater than or equal to 1.0 mol.% and less than or equal to 20.0 mol.% Nb₂O₅,
greater than or equal to 0.0 mol.% and less than or equal to 40.0 mol.% WO₃,
greater than or equal to 0.0 mol.% and less than or equal to 26.5 mol.% La₂O₃,
greater than or equal to 0.0 mol.% and less than or equal to 8.5 mol.% SiO₂,
greater than or equal to 0.0 mol.% and less than or equal to 5.0 mol.% GeO₂,
greater than or equal to 0.0 at.% and less than or equal to 1.0 at.% F,
a sum of R₂O + RO greater than or equal to 0.0 mol.% and less than or equal to 12.0 mol.% and
a sum of Gd₂O₃ + Yb₂O₃ greater than or equal to 0.0 mol.% and less than or equal to 2.0 mol.% and
wherein the glass satisfies the condition:
$${\text{SiO}}_{2} + {\text{B}}_{2} {\text{O}}_{3} \text{-} {\text{P}}_{2} {\text{O}}_{5} \left[\text{mol} . \%\right] \geq 5.0 ,$$
where R
₂O is a total sum of monovalent metal oxides and RO is a total sum of divalent metal oxides.

11. The glass of claim 8, wherein the composition of the components comprises
greater than or equal to 0.0 mol.% and less than or equal to 3.0 mol.% Ta₂O₅,
greater than or equal to 0.0 mol.% and less than or equal to 2.0 mol.% TeO₂,
greater than or equal to 0.0 mol.% and less than or equal to 0.5 mol.% GeO₂,
greater than or equal to 0.0 mol.% and less than or equal to 0.5 mol.% PbO,
greater than or equal to 0.0 mol.% and less than or equal to 0.2 mol.% As₂O₃ and
greater than or equal to 0.0 mol.% and less than or equal to 0.2 mol.% Sb₂O₃,
wherein the composition of the components is
substantially free of fluorine and
substantially free of V₂O₅.

12. The glass of claim 8, wherein the composition of the components comprises:
greater than or equal to 22.0 mol.% and less than or equal to 25.0 mol.% TiO₂,
greater than or equal to 20.0 mol.% and less than or equal to 30.0 mol.% La₂O₃,
greater than or equal to 16.0 mol.% and less than or equal to 20.0 mol.% B₂O₃,
greater than or equal to 10.0 mol.% and less than or equal to 20.0 mol.% SiO₂,
greater than or equal to 6.5 mol.% and less than or equal to 8.0 mol.% ZrO₂,
greater than or equal to 5.0 mol.% and less than or equal to 6.7 mol.% Nb₂O₅,
greater than or equal to 0.1 mol.% and less than or equal to 0.9 mol.% Bi₂O₃,
greater than or equal to 0.0 mol.% and less than or equal to 6.0 mol.% Y₂O₃,
greater than or equal to 0.0 mol.% and less than or equal to 3.0 mol.% BaO and
greater than or equal to 0.0 mol.% and less than or equal to 2.0 mol.% Gd₂O₃ and
greater than or equal to 0.0 mol.% and less than or equal to 2.0 mol.% of all other components in total.

13. The glass of claim 8, wherein the glass satisfies the conditions:
$$4.5 \leq {\text{P}}_{\text{d}} \leq 5.5 \text{and}$$
$$2.01 \leq {\text{P}}_{\text{n}} \leq 2.15 ,$$
where
P_{d} is a parameter predicting a density at room temperature, d_{RT} [g/cm³], calculated from the glass composition in terms of mol.% of the components according to the Formula (ll):
$$\begin{matrix}{\text{P}}_{\text{d}} = 4.538 + 0.049487 \text{*} {\text{La}}_{2} {\text{O}}_{3} \text{-} 0.0061695 \text{*} {\text{TiO}}_{\text{2}} \text{-} 0.026182 \text{*} \\ {\text{B}}_{2} {\text{O}}_{3} \text{-} 0.020031 \text{*} {\text{SiO}}_{2} + 0.013118 \text{*} {\text{ZrO}}_{2} + 0.0039893 \text{*} {\text{Nb}}_{2} {\text{O}}_{5} \text{-} \\ 0.0041793 \text{*} \text{CaO} + 0.017726 \text{*} \text{BaO} + 0.023616 \text{*} {\text{Y}}_{\text{2}} {\text{O}}_{\text{3}} + 0.011543 \text{*} \\ \text{ZnO} + 0.059936 \text{*} {\text{Gd}}_{\text{2}} {\text{O}}_{\text{3}} \text{-} 0.013703 \text{*} {\text{Na}}_{\text{2}} \text{O} + 0.023432 \text{*} {\text{WO}}_{\text{3}} \text{-} \\ 0.028926 \text{*} {\text{Al}}_{\text{2}} {\text{O}}_{\text{3}} \text{-} 0.0088096 \text{*} {\text{Li}}_{\text{2}} \text{O} + 0.034085 \text{*} \text{PbO} + 0.072239 \text{*} \\ {\text{Bi}}_{\text{2}} {\text{O}}_{\text{3}} \text{-} 0.0083663 \text{*} {\text{GeO}}_{\text{2}} + 0.012403 \text{*} {\text{TeO}}_{\text{2}} + 0.090733 \text{*} {\text{Er}}_{\text{2}} {\text{O}}_{\text{3}} + \\ 0.093365 \text{*} {\text{Yb}}_{\text{2}} {\text{O}}_{3} \text{-} 0.018340 \text{*} {\text{K}}_{\text{2}} \text{O} + 0.0079344 \text{*} \text{SrO} \text{-} 0.0048045 \text{*} \\ \text{MgO} \text{-} 0.037949 \text{*} {\text{P}}_{\text{2}} {\text{O}}_{5} ,\end{matrix} \qquad \text{(ll)}$$
.

14. The glass of claim 8, wherein when cooled in air from 1100° C. to 500° C. in 2.5 minutes, the glass does not crystallize.

15. A glass comprising a plurality of components, the glass having a composition of the components comprising:
greater than or equal to 1.0 mol.% and less than or equal to 40.0 mol.% B₂O₃,
greater than or equal to 0.5 mol.% and less than or equal to 45.0 mol.% TiO₂,
greater than or equal to 0.0 mol.% and less than or equal to 40.0 mol.% SiO₂,
greater than or equal to 0.0 mol.% and less than or equal to 40.0 mol.% P₂O₅,
greater than or equal to 0.0 mol.% and less than or equal to 40.0 mol.% WO₃,
greater than or equal to 0.0 mol.% and less than or equal to 40.0 mol.% Nb₂O₅,
greater than or equal to 0.0 mol.% and less than or equal to 40.0 mol.% La₂O₃,
greater than or equal to 0.0 mol.% and less than or equal to 15.0 mol.% TeO₂,
greater than or equal to 0.0 mol.% and less than or equal to 15.0 mol.% GeO₂,
greater than or equal to 0.050 mol.% and less than or equal to 8.000 mol.% Bi₂O₃,
greater than or equal to 0.0 mol.% and less than or equal to 10.0 mol.% PbO,
greater than or equal to 0.0 mol.% and less than or equal to 5.0 mol.% Ga₂O₃ and
optionally comprising one or more components selected from ZrO₂, CaO, Y₂O₃, ZnO, Gd₂O₃, Na₂O, Al₂O₃, Li₂O, Er₂O₃, Yb₂O₃, K₂O, MgO, BaO and SrO,
wherein the glass satisfies the conditions:
$$4.2 \leq {\text{P}}_{\text{d}} \leq 6.0 \text{and}$$
$${\text{P}}_{\text{n}} \text{-} \left(1.62 + 0.08 \text{*} {\text{P}}_{\text{d}}\right) > 0.000 ,$$
where
Pₙ is a parameter predicting a refractive index at 587.56 nm, n_{d}, calculated from the glass composition in terms of mol.% of the components according to the Formula (l):
$$\begin{matrix}{\text{P}}_{\text{n}} = 1.890 + 0.0042765 \text{*} {\text{La}}_{2} {\text{O}}_{3} + 0.0035322 \text{*} {\text{TiO}}_{\text{2}} \text{-} 0.0044148 \text{*} \\ {\text{B}}_{\text{2}} {\text{O}}_{\text{3}} \text{-} 0.0036646 \text{*} {\text{SiO}}_{2} + 0.001941 \text{*} {\text{ZrO}}_{2} + 0.007728 \text{*} {\text{Nb}}_{2} {\text{O}}_{5} \text{-} \\ 0.00030702 \text{*} \text{CaO} + 0.0015639 \text{*} {\text{Y}}_{2} {\text{O}}_{3} + 0.00031744 \text{*} \text{ZnO} + \\ 0.002173 \text{*} {\text{Gd}}_{2} {\text{O}}_{3} \text{-} 0.0031072 \text{*} {\text{Na}}_{2} \text{O} + 0.0022091 \text{*} {\text{WO}}_{3} \text{-} \\ 0.0047506 \text{*} {\text{Al}}_{2} {\text{O}}_{3} \text{-} 0.0012169 \text{*} {\text{Li}}_{2} \text{O} + 0.0047539 \text{*} \text{PbO} + \\ 0.0084341 \text{*} {\text{Bi}}_{2} {\text{O}}_{3} \text{-} 0.0019088 \text{*} {\text{GeO}}_{2} + 0.0029347 \text{*} {\text{TeO}}_{2} + \\ 0.0013834 \text{*} {\text{Er}}_{2} {\text{O}}_{3} + 0.0038033 \text{*} {\text{Yb}}_{2} {\text{O}}_{3} \text{-} 0.0053704 \text{*} {\text{K}}_{2} \text{O} \text{-} \\ 0.0013884 \text{*} \text{MgO} \text{-} 0.0074467 \text{*} {\text{P}}_{2} {\text{O}}_{5} ,\end{matrix} \qquad \text{(I)}$$
and P_{d} is a parameter predicting a density at room temperature, d_{RT} [g/cm³], calculated from the glass composition in terms of mol.% of the components according to the Formula (ll):
$$\begin{matrix}{\text{P}}_{\text{d}} = 4.538 + 0.049487 \text{*} {\text{La}}_{2} {\text{O}}_{3} \text{-} 0.0061695 \text{*} {\text{TiO}}_{\text{2}} \text{-} 0.026182 \text{*} \\ {\text{B}}_{2} {\text{O}}_{3} \text{-} 0.020031 \text{*} {\text{SiO}}_{2} + 0.013118 \text{*} {\text{ZrO}}_{2} + 0.0039893 \text{*} {\text{Nb}}_{2} {\text{O}}_{5} \text{-} \\ 0.0041793 \text{*} \text{CaO} + 0.017726 \text{*} \text{BaO} + 0.023616 \text{*} {\text{Y}}_{\text{2}} {\text{O}}_{\text{3}} + 0.011543 \text{*} \\ \text{ZnO} + 0.059936 \text{*} {\text{Gd}}_{\text{2}} {\text{O}}_{\text{3}} \text{-} 0.013703 \text{*} {\text{Na}}_{\text{2}} \text{O} + 0.023432 \text{*} {\text{WO}}_{\text{3}} \text{-} \\ 0.028926 \text{*} {\text{Al}}_{\text{2}} {\text{O}}_{\text{3}} \text{-} 0.0088096 \text{*} {\text{Li}}_{\text{2}} \text{O} + 0.034085 \text{*} \text{PbO} + 0.072239 \text{*} \\ {\text{Bi}}_{\text{2}} {\text{O}}_{\text{3}} \text{-} 0.0083663 \text{*} {\text{GeO}}_{\text{2}} + 0.012403 \text{*} {\text{TeO}}_{\text{2}} + 0.090733 \text{*} {\text{Er}}_{\text{2}} {\text{O}}_{\text{3}} + \\ 0.093365 \text{*} {\text{Yb}}_{\text{2}} {\text{O}}_{3} \text{-} 0.018340 \text{*} {\text{K}}_{\text{2}} \text{O} + 0.0079344 \text{*} \text{SrO} \text{-} 0.0048045 \text{*} \\ \text{MgO} \text{-} 0.037949 \text{*} {\text{P}}_{\text{2}} {\text{O}}_{5} ,\end{matrix} \qquad \text{(ll)}$$
where an asterisk (*) means multiplication.

16. The glass of claim 15, wherein the glass has
a density at room temperature, d_{RT} that is greater than or equal to 4.2 g/cm³ and less than or equal to 6.0 g/cm³ and
wherein the glass satisfies the condition:
$${\text{n}}_{\text{d}} \text{-} \left(1.62 + 0.08 \text{*} {\text{d}}_{\text{RT}}\right) > 0.000 ,$$
where n
_{d} is a refractive index at 587.56 nm.

17. The glass of claim 15, wherein the composition of the components comprises:
greater than or equal to 6.1 mol.% and less than or equal to 12.0 mol.% ZrO₂,
greater than or equal to 1.0 mol.% and less than or equal to 35.0 mol.% B₂O₃,
greater than or equal to 1.0 mol.% and less than or equal to 35.0 mol.% TiO₂,
greater than or equal to 0.0 mol.% and less than or equal to 26.5 mol.% La₂O₃,
greater than or equal to 0.0 mol.% and less than or equal to 20.0 mol.% Nb₂O₅,
greater than or equal to 0.0 mol.% and less than or equal to 8.5 mol.% SiO₂,
greater than or equal to 0.0 mol.% and less than or equal to 5.0 mol.% GeO₂,
greater than or equal to 0.0 at.% and less than or equal to 1.0 at.% F,
a sum of R₂O + RO greater than or equal to 0.0 mol.% and less than or equal to 12.0 mol.% and
a sum of Gd₂O₃ + Yb₂O₃ greater than or equal to 0.0 mol.% and less than or equal to 2.0 mol.%,
wherein the composition of the components satisfies the condition: 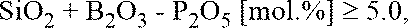
and wherein the glass has
a refractive index at 587.56 nm, n_{d}, that is greater than or equal to 2.05,
where R₂O is a total sum of monovalent metal oxides and RO is a total sum of divalent metal oxides.

18. The glass of claim 15, wherein the composition of the components comprises:
greater than or equal to 0.0 mol.% and less than or equal to 3.0 mol.% Ta₂O₅,
greater than or equal to 0.0 mol.% and less than or equal to 2.0 mol.% TeO₂,
greater than or equal to 0.0 mol.% and less than or equal to 0.5 mol.% GeO₂,
greater than or equal to 0.0 mol.% and less than or equal to 0.5 mol.% PbO,
greater than or equal to 0.0 mol.% and less than or equal to 0.2 mol.% As₂O₃ and
greater than or equal to 0.0 mol.% and less than or equal to 0.2 mol.% Sb₂O₃,
wherein the composition of the components is
substantially free of fluorine and
substantially free of V₂O₅.

19. The glass of claim 15, wherein the composition of the components comprises:
greater than or equal to 22.0 mol.% and less than or equal to 25.0 mol.% TiO₂,
greater than or equal to 20.0 mol.% and less than or equal to 30.0 mol.% La₂O₃,
greater than or equal to 16.0 mol.% and less than or equal to 20.0 mol.% B₂O₃,
greater than or equal to 10.0 mol.% and less than or equal to 20.0 mol.% SiO₂,
greater than or equal to 6.5 mol.% and less than or equal to 8.0 mol.% ZrO₂,
greater than or equal to 5.0 mol.% and less than or equal to 6.7 mol.% Nb₂O₅,
greater than or equal to 0.0 mol.% and less than or equal to 6.0 mol.% Y₂O₃,
greater than or equal to 0.050 mol.% and less than or equal to 0.900 mol.% Bi₂O₃,
greater than or equal to 0.0 mol.% and less than or equal to 3.0 mol.% BaO and
greater than or equal to 0.0 mol.% and less than or equal to 2.0 mol.% Gd₂O₃ and
greater than or equal to 0.0 mol.% and less than or equal to 2.0 mol.% of all other components in total.

20. The glass of claim 15, wherein when cooled in air from 1100° C. to 500° C. in 2.5 minutes, the glass does not crystallize.
